(19) United States
(12) Patent Application Publication
(10) Pub. No.: US 2026/0253010 A1
(43) Pub. Date: Aug. 27, 2026

(54) STRATEGY FOCUSING SYSTEM AND METHOD

(71) Applicant: VISIONCRAFT INC., CARMEL, IN (US)

(72) Inventor: Thaddeus HOLMES, Carmel, IN (US)

(73) Assignee: VISIONCRAFT INC., CARMEL, IN (US)

(21) Appl. No.: 19/651,235

(22) Filed: Apr. 17, 2026

Related U.S. Application Data
(63) Continuation-in-part of application No. 18/687,418, filed on Aug. 31, 2022, now abandoned.
(60) Provisional application No. 63/239,012, filed on Aug. 31, 2021.

(51) Int. Cl. G06Q 10/0637

(52) U.S. Cl. CPC G06Q 10/0637

(57) ABSTRACT

The present invention involves an executive decision support system and method which in a first step, the components of each category of resource are identified and listed/commented upon by one or more individuals in the company, in this exemplary embodiment a collection of the top company executives such as Chief Executive Officer, Chief Operating Officer, Chief Technology Officer, Chief Financial Officer, etc. (the “Executive Team”). Second, each resource is rated for its competitive importance by the members of the Executive Team. Third, the resources with ratings and comments are located on markers and arranged in a hierarchy to provide a graphical display of markers to facilitate executive focus on key resources. Fourth, the members of the Executive may review and revise each marker to more closely reflect the consensus view, occasionally altering the hierarchy.

### CROSS-REFERENCE TO RELATED APPLICATIONS

The present application is a nonprovisional application which claims priority under 35 U.S.C. §119(e) of U.S. Patent Provisional Application Serial Number 63/239,012, filed August 31, 2021, the disclosures of which are incorporated by reference herein.

### BACKGROUND OF THE INVENTION

### Field of the Invention.

The invention relates to decision support methods and software. More specifically, but not exclusively, the field of the invention is that of executive strategic focus decision support methods and software for businesses.

### Description of the Related Art.

The scarcest resource of new and emerging companies is that of its executive leadership. The time and efforts of those critical individuals in smaller organizations are often the key to success or failure.

Often consultants offer heuristic, process-based, and prescriptive solutions to executive time management, and various types of software provide discrete analytical analyses of how such executives should concentrate their time. However, these prior art methods are prone to personal biases and/or data flaws that interfere with appropriate resource allocation. Also, such methods lack data categorization and classification. Companies would benefit from a holistic and data driven approach, and process improvements are continually desired.

### SUMMARY OF THE INVENTION

The present invention is an executive focusing system and method which allows individuals to concentrate their time on company related activities designed to best enhance the value of the company. The system and method defines a discrete number of properties of the company, helps the executives evaluate the relative importance of each and develop a matrix that optimizes an executive’s focus on the core problems and resources of a company to make the company more successful.

The goal is to help a company’s chief executive officers and leadership teams (“CEOs”) better understand the company’s core Strategy, based on the company’s Competitive Edge. This process not only clarifies the company’s Competitive Edge, but also the resources most critical to supporting it.

CEOs face a constant barrage of requests, opportunities to consider, and hurdles to overcome. It requires the ability to constantly make good decisions that benefit the company’s stakeholders. Embodiments of the invention provide a process for executives to clarify the company’s competitive edge, while also helping them understand which resources they may use, which they need to beef up, and which are least relevant.

After coaching and consulting many CEOs, the inventor has realized it’s quite easy for them to be distracted by Shiny Object Syndrome. This means they may easily get enamored with new potential opportunities, which may lead to distractions, which may harm the core competencies and Competitive Edge of the company.

When a potentially large opportunity presents itself to a CEO, there is a tendency to begin making decisions based on the merits of the opportunity. This is a mistake as the CEO should make all decisions based on the merits of their core business’s Competitive Edge. Does the new opportunity sharpen their Edge? Does it risk blunting the Edge? Or does it replace the Edge altogether with something better?

Additionally, this process forces CEOs to better prioritize their management of resources. For instance, renting a new office space may feel emotionally very important – and therefore may easily become a distraction. Evaluating every option, however, is very fulfilling to a CEOs ego, but often very unimportant to their company’s Competitive Edge. This process helps the CEO visualize their priorities. The process helps the company allocate resources more appropriately. For instance, the CEO and leadership team might choose to skip potential office tours in order to have more time for meeting with their VC funders, or perhaps join a sales channel conversation that has the potential to open up new markets.

CEOs may not only more clearly see, but may better communicate why and how they are prioritizing their time and asset allocations. The present invention, in one form, relates to gathering information about the resources of the company, categorizing the various resources, ranking the importance of each resource in the competitive marketplace, grading each resource internally to project how well the resource can continue supporting the rest of the company as the company grows, and creating a graphic roadmap of the resources deserving the most focus and projections as to how well those resources will or won’t support the Company’s needs in the future. Software may be used in the gathering, categorizing, ranking, grading, and graphic roadmap creation, and may monitor data inputs to update the graphic roadmap as incoming data suggests. In another aspect of the present invention, a method of evaluating company resources involves determining, for each resource, three characteristics: the resource’s ability to generate value for the Company; the scarcity of the resource, that is that others would be unable to match it; and the resource’s repeatability, whether it is extensively usable.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a flow chart diagram of the operation of the present invention relating to one embodiment of the general method of the invention.

FIGS. 4A and 4B are depictions of an executive focus roadmap of one embodiment of the invention.

FIGS. 5A-5C are depictions of an executive focus roadmap of another embodiment of the invention.

FIG. 6 is a data network diagram illustrating the data dependencies utilized in embodiments of the invention.

FIG. 7 is a flowchart of a method for arranging a plurality of resources.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings. While technology should continue to develop and many of the elements of the embodiments disclosed may be replaced by improved and enhanced items, the teaching of the present invention are inherent in the disclosure of the elements used in embodiments using technology available at the time of this disclosure.

The detailed descriptions which follow are presented in part in terms of algorithms and symbolic representations of operations on data bits both within a computer memory representing alphanumeric characters or other information, and on physical items to express the executive focus roadmap. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art. The display of the executive focus roadmap may thus be achieved on a display screen, a projection, a printing of a physical object, or the expression of audio signals or other media to convey the underlying information in one of several possible tangible forms.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical resources of related items, and provide increased efficiency in computer operation. By changing the organization and operation of data structures and the algorithms for manipulating data in such structures, the fundamental operation of the computing system may be changed and improved.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. The operations of these algorithms are deterministic with the accuracy and complexity management that are not obtainable by human mental steps even though the language used to describe them in the detailed description below at some time references a mental step. This requirement for machine implementation for the practical application of the algorithms is understood by those persons of skill in this art as not a duplication of human thought, rather as significantly more than such duplication. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

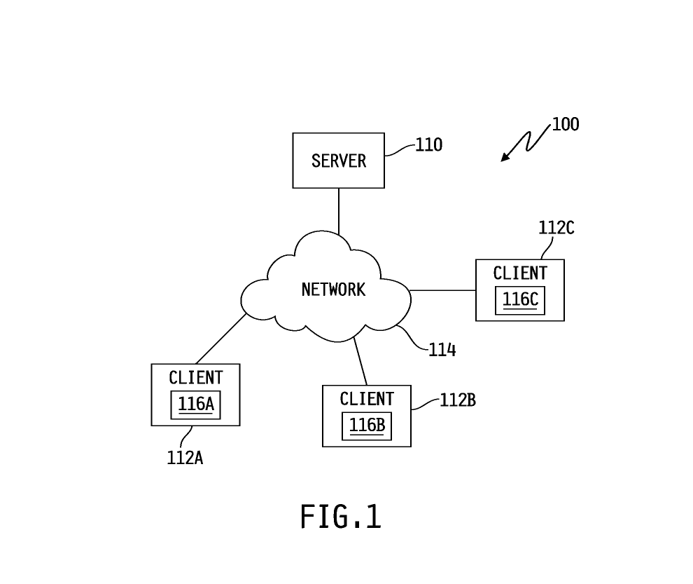

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

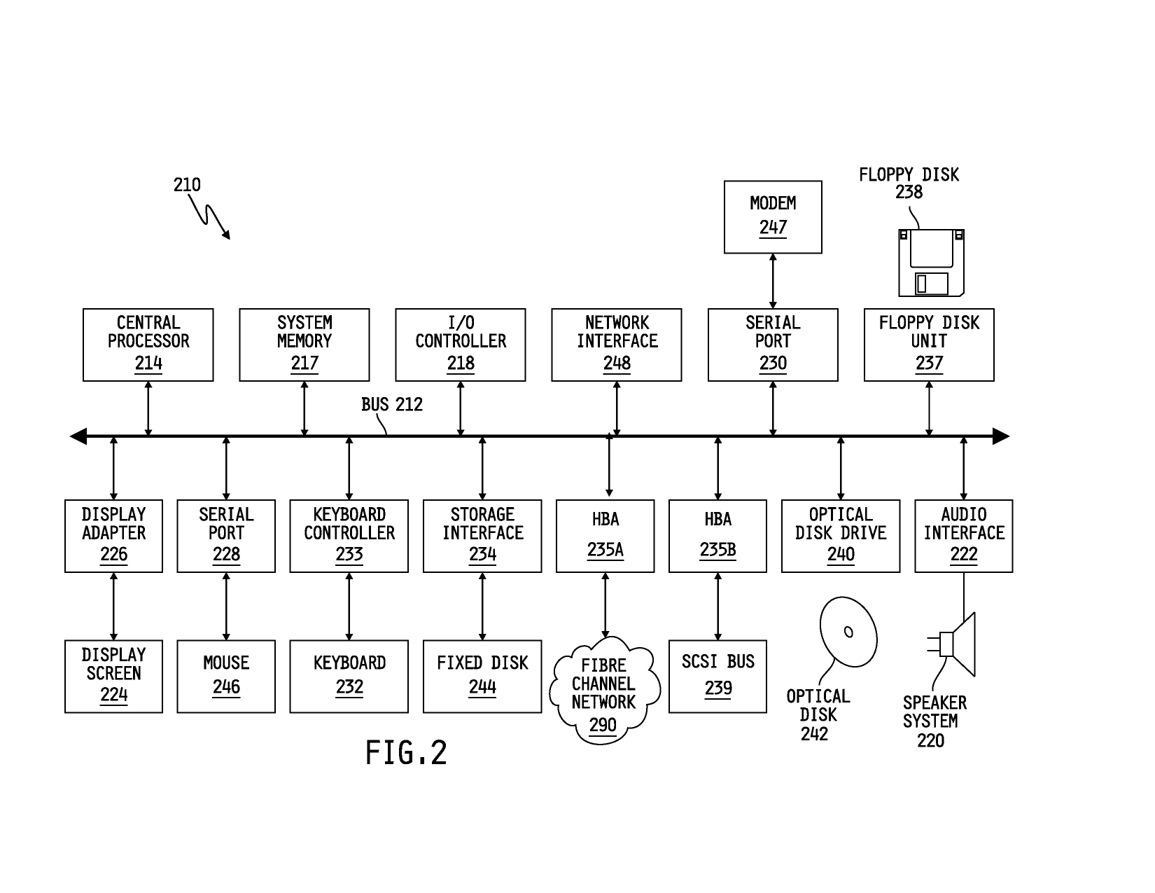

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238 (disk drive 237 is used to represent various type of removable memory such as flash drives, memory sticks and the like), host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Washington), WINDOWS® (WINDOWS is a registered trademark of Microsoft Corporation of Redmond, Washington), OS/2® (OS/2 is a registered trademark of International Business Machines Corporation of Armonk, New York), UNIX® (UNIX is a registered trademark of X/Open Company Limited of Reading, United Kingdom), Linux® (Linux is a registered trademark of Linus Torvalds of Portland, Oregon), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, California, used under license by Apple Corporation of Cupertino, California), Android® (Android is a trademark of Google Inc. of Mountain View, California), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

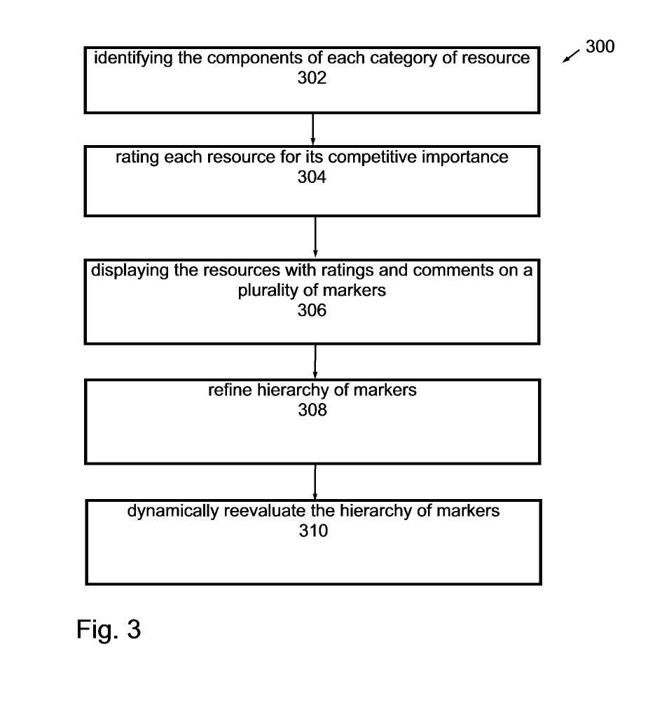

FIG. 3 depicts a high level flow chart 300 according to one embodiment of the invention. In a first step 302, the components of each category of resource are identified and listed/commented upon by personnel in the company, in this exemplary embodiment a company executive, or a collection of the top company executives such as Chief Executive Officer, Chief Operating Officer, Chief Technology Officer, Chief Financial Officer, etc. (the “Executive Team” will be used below to refer to the one or several individuals of the company). Second, each resource is rated for its competitive importance by the members of the Executive Team in step 304. Third, the resources with ratings and comments are located on markers and arranged in a hierarchy to provide a graphical display of markers to facilitate executive focus on key resources in step 306. Fourth, the hierarchy is further refined and clarified in such a way that the members of the executive must choose which resource (and resource category) serves as the most important resource when it comes to beating the competition.

Data sets and automated feedback loops are a key component of this rating process. In rating any single resource, the tool collates data from multiple sources to enable an automated rating of the competitive importance of each resource. For instance, the efficacy of a Company’s Customer Service when considered as a resource for the company to manage, is enabled to incorporate a company’s Net Promoter Score, Call Center Wait Times, error rate tracking, and other data points, which the tool incorporates into the rating of the Company’s Customer Service and then rates it for competitive importance by identifying other online sources of typical Net Promoter Scores, Call Center Wait Times, error rates, etc., for the Company’s industry. For example, if the Company’s Call Center Wait Times are lower than the industry average, then the Customer Service rating goes up. If the Net Promoter Score is lower than industry average, the Customer Service rating goes down. The weighting of these criteria is customizable by the Executive Team so the tool can automate the process. For a particular Company, the Executive Team might rate ‘Call Center Wait Times’ as 5% of the overall value of their Customer Resource as a process and might rate ‘Error Rates’ as 75% of the overall value of their Customer Resource as a process and might rate the ‘Net Promoter Score’ as 20% of the overall value of their Customer Resource as a process. The tool then automatically utilizes the available data to create an overall rating of the Company’s Customer Service rating for competitive importance.

Step 308, involves the members of the Executive subordinating the value of all other resources into a hierarchy pattern that looks like a spear tip and/or pyramid, with one resource category elevated above all others, and each resource placed into the hierarchy according to importance. Optionally, in step 310 the members of the Executive may review and revise each marker to more closely reflect the consensus view, occasionally altering the hierarchy – and even more importantly, the hierarchy becomes a tool for making faster, higher quality strategic decisions, as the members of the Executive utilize the hierarchy in order to determine which resources they should and will intentionally build stronger. In building a consensus view, we can observe Brand Equity for example. To rate the competitive importance of a company’s Brand Equity, the software collects and collates data from several sources, including input from Customers, prospects, Team Members, potential job candidates, suppliers, investors, and other potential and actual stakeholders. The tool incorporates these data points to build a ‘consensus view’ of Brand Equity and rates its competitive importance. If for instance, the company has a round of bad press in the news, perhaps due to an accident involving it’s products and/or services, the tool is gathering data from the Company’s stakeholders to understand the event’s impact on its Brand Equity. Perhaps 2 customers and 1 potential investor report they’re no longer currently interested in doing business with the company, that data is incorporated by the tool to reduce the rating of the competitive value of its Brand Equity. Because only 3 data points changed (2 customers and 1 potential investor), the impact to its rating is minimal. However, if 200 customers and 100 potential investors became uninterested, the tool would gather that data in it’s data sampling to create a more significant reduction to the rating. At the same time, the tool will be collecting data from the Company’s Sales Channel Partners, and realizes there is no reduction in the ratings of the company’s products/services by those Channel Partners. So, the tool in real time is able to advise the leadership team to increase capital allocation toward monetizing the Company’s Sales Channel Partners, and simultaneously the leadership team is aware their Brand Equity has lost some competitive rating and can then choose to allocate capital to mitigate the loss in the short term and rebuild its Brand Equity in the long term. Having this data automated in a regular cadence is hugely invaluable for the Executive team in making its capital allocation decisions.

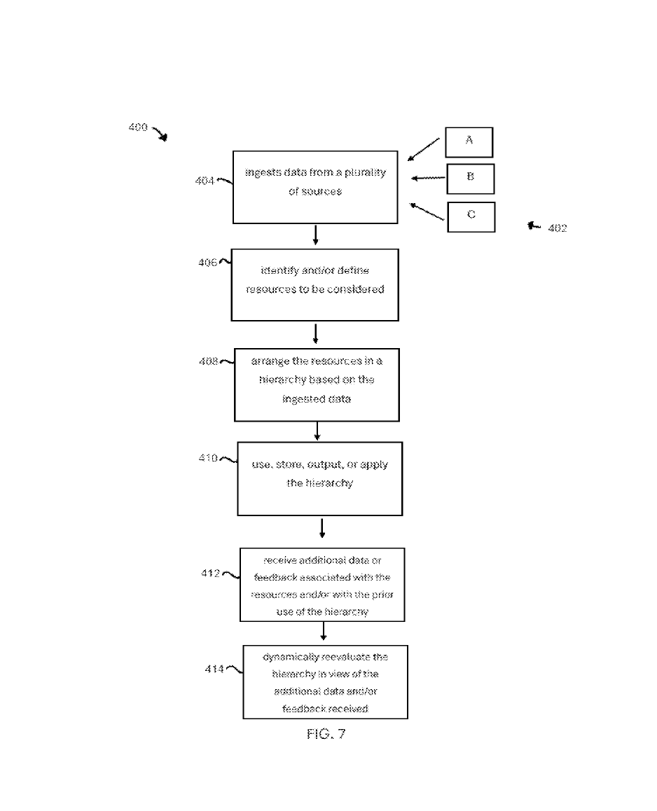

FIG. 7 illustrates a flowchart 400 of an example method for arranging a plurality of resources 402 in a hierarchy and dynamically reevaluating the hierarchy over time. As further apparent from the forthcoming description, flowchart 400 illustrates a system in which a plurality of sources feeds data into an ingest process, the ingested data is used to arrange resources, and later data and outcomes are used to reevaluate that hierarchy over time. Thus, the process may function as a feedback loop in which prior outputs and later-observed developments become part of a continuing evaluative cycle, thereby permitting the system to maintain a current and adaptive hierarchical arrangement of the resources.

For descriptive purposes, the plurality of resources 402 are illustrated as resources A, B, and C. By way of example, resource A, resource B, and resource C may correspond to respective categories of information or opportunity, such as property-related information, relationship-based information, and process-based information. In other embodiments, resources 402 may include but are not limited to, real estate opportunities, access to investors or capital, business relationships, operational workflows, or other categories further discussed herein. The use of three resources, namely, A, B, and C, are for illustrative purposes, and in other embodiments, a greater number or a lesser number than three resources may be utilized.

As shown, flowchart 400 may begin at block 404, where the system ingests data from a plurality of sources 402. For example, the system may receive data from market feeds, historical performance records, transaction data, valuation data, economic indicators, geographic data, property records, tenant data, operating metrics, user inputs, external platforms, internal databases, and other available sources. In this manner, the ingested data may reflect present conditions, historical trends, contextual considerations, and later-occurring developments associated with the resources. The plurality of sources may provide a broader informational basis from which the system may assess resources as further discussed subsequently.

Next, flowchart 400 advances from block 404 to block 406 to identify and/or define the resources to be considered. For instance, where the system is applied to an economic portfolio, the resources may include individual holdings, sectors, instruments, or candidate investments. Where the system is applied to real estate, the resources may include individual properties, property types, locations, development opportunities, or asset groups. In some embodiments, the resources may be pre-determined. In other embodiments, one or more of the resources may be identified from the ingested data. Once identified, the resources may be designated as the units to be comparatively evaluated within the process.

Next, flowchart 400 advances from block 406 to block 408 to arrange the resources in a hierarchy based on the ingested data. The hierarchy may reflect an ordering, ranking, prioritization, or tiered arrangement of the resources according to one or more determined considerations. By way of example, assets within an economic portfolio may be arranged according to current attractiveness, expected performance, risk-adjusted suitability, or strategic importance. Likewise, real estate assets may be arranged according to opportunity level, projected return, stability, location-based desirability, or portfolio fit. The hierarchy established at block 408 may represent a current evaluative state derived from the information then available to the system.

Next, flowchart 400 advances from block 408 to block 410 to use, store, output, or otherwise apply the hierarchy. For example, the hierarchy may be used to support portfolio management decisions, asset review, watchlist generation, property selection, opportunity surfacing, display functions, or other downstream operations. In this regard, the hierarchy may serve as an operative output that influences how the system presents or acts upon the economic portfolio, the real estate assets, or other resources under consideration.

Next, flowchart 400 advances from block 410 to block 412 to receive additional data and/or feedback associated with the resources and/or with the prior use of the hierarchy. In an economic portfolio context, such later-received information may include updated market activity, performance changes, economic developments, trading outcomes, or other evolving conditions. In a real estate context, the later-received information may include revised valuations, occupancy changes, operating performance, local market movement, property events, or other subsequent developments. The feedback may further indicate whether prior hierarchical determinations aligned with actual results, changing conditions, or user objectives.

Next, flowchart 400 advances from block 412 to block 414 to dynamically reevaluate the hierarchy in view of the additional data and/or feedback received at block 412. Accordingly, the hierarchy may be revised, reordered, or otherwise adjusted over time rather than remaining fixed. For example, a holding previously positioned higher within an economic portfolio hierarchy may move lower based on later developments, and a real estate asset previously given lower priority may move upward in response to changed market conditions or improved performance indicators. In this manner, the flowchart 400 may define an iterative feedback-driven process through which the relative hierarchical arrangement of the resources remains responsive to newly ingested information.

For example without limitation, the Executive Team may choose to devote more focus to the top category in view of current operational conditions, or alternatively decide that future opportunities dictates a different focus and subsequent rearrangement of the hierarchy to focus on the future position of the Company.

In one embodiment, the process is started with 14 Categories of Resources, 12 of which are classified into 3 broad Types, as follows:

### PROPERTY:

Intellectual Property

Real Estate

Brand Equity

Equipment

### RELATIONSHIPS:

Access to Investors and/or Capital

Sales Channel Relationships (Customers/Distributors, etc.)

Supplier Relationships

Team Members

### PROCESSES:

Sales and Marketing Processes

Customer Service Processes

Production Processes

Vision & Leadership Processes

### 2 ADDITIONAL CATEGORIES OF RESOURCES:

Core Values

Regulations and/or Gov Policies

In one embodiment, markers comprise physical tile starting with 14 Tiles, one for each of the Resource Categories. The tiles, which in this exemplary embodiment are square, are tilted 45 degrees so the corners point UP, Down, Left, and Right. The Tiles are called ‘Diamonds’ and may be of any shape or color or combinations thereof. The particular shapes and colors and physical embodiment described below provides one exemplary way of utilizing the teachings of the present invention, and as such are not required for successful implementation of the systems and methods of the present invention.

Each of the 14 Diamonds has the name of one of the 14 Resource Categories written on the top half of the Diamond. The Diamonds, in this exemplary embodiment, are color coded in the following way:

Resource Categories diamonds that are PROPERTY are Green (because they usually have the greatest strategic value)

Resource Categories Diamonds that are RELATIONSHIPS are Yellow (because they tend to have a mid-level strategic value)

Resource Categories Diamonds that are PROCESSES are Red (because while valuable, Processes tend to be the most difficult to protect over time)

The Diamond for the Resource Categories ‘Core Values’ is Blue (because blue psychologically is often considered in Western culture to stand for trust)

The Diamond for the Resource Category ‘Gov Policies and/or Regulations is Purple (because purple is the color of royalty)

To facilitate identification, a line may be drawn horizontally through each diamond, so the top half lists the ‘Category of Resource’ (ie, Real Estate, or ‘Production Processes’)

### COMPANY SPECIFIC RESOURCES

A Series of Questions creates some data for each of the above Categories (Diamonds)

In the Bottom half of each diamond, the Executive Team lists specifically what they have resource-wise in this Resource Category.

This is derived thru a series of questions that accomplish the following:

#1 - Each Resource Category has some questions and/or commentary to help remind the Executive Team of the scope of their in this Category available to the company. These questions attempt to focus the Executive and/or Executive Team of the nature of this Resource Category, that is what should and should not be considered to be part of this Category. Simultaneously, the questions are designed to trigger memories and insights in the participant(s) so they are most likely to recall the most valuable resources their company has available in each of these Resources categories #2 – The Executive Team is reminded to utilize a Filter on their Resources that we call the VUE filter: V – Valuable (is the specific Resource Valuable?); U – Unmatchable (is the specific resources difficult for competitors to find, acquire, or copy?); and E – Extensively Leverageable (Are the specific resources able to be leveraged over and over for the company’s benefit and/or profitability?).

#3 – The Executive Team is then asked to “Score” the value of the specific resource – and are asked to look at the resource from their competitors’ point of view – and are asked to consider not only their primary competitors, but a broad spectrum of both direct and indirect competitors, even those who vary dramatically in size or abilities (ie – “Would your competitors be jealous of, or want to obtain, this resource?”).

Some exemplary questions that may be used to gather the above noted information are as follows, and may be addressed using the VRIO framework, a four question framework asked about a resource or capability to determine its competitive potential. VRIO represents: the question of Value, the question of Rarity, the question of Imitability (Ease/Difficulty to Imitate), and the question of Organization (ability to exploit the resource or capability). This is similar to the VRIN framework (valuable, rare, inimitable, and non-substitutable) that was first introduced in Barney, J. (1991) Firm resources and sustained competitive advantage in the Journal of Management, and subsequently a slight modification called VRIO (valuable, rare, inimitable, and organization) was first introduced in Barney, J. (1997) “Gaining and Sustaining Competitive Advantage”. (NJ: Pearson).

Embodiments of the invention may further improve upon information gathering by use of an enhanced VUE framework, where VUE represents Valuable (able to generate value), Unmatchable (Rare and difficult to duplicate at same quality), and Extensively usable (the Company is able to leverage this resource over and over again).

The Executive Team reviews each of those 14 categories listed below. These are the categories which are analyzed in order to better understand the resources the company may leverage in order to wield a sharper competitive Edge.

In addition, the Executive Team is asked to list any specific resources for each category that you feel are valuable and important to the viability of your company, keeping in mind that there may be some categories in which the company has no resources worth mentioning. Each category may be scored, for example without limitation on a numerical scale, such as values from one to seven. Other scales and non-numerical evaluation scoring may also be used within the spirit of this disclosure.

In one embodiment, the tool may use external data as evaluative input that is processed before being relied upon for hierarchical assessment of the resources. For example, where the resources correspond to components of an economic portfolio, the external data may include market feeds, analyst information, macroeconomic indicators, comparable asset information, news-derived signals, or third-party performance metrics. Where the resources correspond to real estate assets, the external data may include comparable sales data, lease-rate information, zoning information, demographic information, geographic information, tax records, market reports, occupancy data, lending conditions, or other third-party property-related information. The system may therefore use external data to supplement internal records and prior system-generated information when evaluating the resources.

In other embodiments, flowchart 400 may further support reduced decision-making time by permitting the system to receive, process, and use incoming data in real time or near real time. For example, as external data associated with an economic portfolio, real estate asset set, or other group of resources are received, the system may update the corresponding evaluations and hierarchical positions without requiring a user to manually review each incoming item of information. In this manner, the system may provide a real-time or substantially real-time view of changing character conditions, thereby allowing a user to observe updated rankings, priorities, or relative positions as the underlying data changes. This may reduce lag between data receipt and decision support output, and may further reduce the time otherwise required for human collection, comparison, and synthesis of information across multiple sources.

In some embodiments, the system may first validate the external data before using the external data for evaluation. Validation may include determining whether the data is complete, timely, source-appropriate, format-compliant, internally consistent, and/or sufficiently associated with a corresponding resource. The system may also determine whether a given item of external data satisfies one or more threshold conditions for use within the evaluative process. If the external data fails validation, the system may reject the data, flag the data for exclusion, quarantine the data for later review, or otherwise prevent the data from affecting the hierarchy. Thus, the system need not treat all external data as equally suitable for use.

The system may further determine whether multiple items of external data are duplicative, overlapping, redundant, or otherwise partially reflective of the same underlying condition. For example, two or more external sources may report substantially the same market movement, property characteristics, valuation event, neighborhood trend, or performance indicator. In such circumstances, the system may identify the overlap and prevent the duplicative or overlapping external inputs from disproportionately influencing evaluation of the corresponding resource. In some embodiments, the system may compare metadata, timestamps, source relationships, content similarity, subject matter correspondence, or one or more other attributes to determine whether separate external inputs are in fact duplicative or overlapping.

Once duplicative or overlapping external data is identified, the system may differentially weigh the external inputs. For instance, the system may assign a greater weight to one source and a lesser weight to another source based on source reliability, source recency, source specificity, source independence, historical predictive value, consistency with other accepted data, or other evaluative factors. In some embodiments, one external input may be selected as a primary input while one or more other overlapping inputs are discounted. In other embodiments, the system may partially reduce the influence of each overlapping input rather than wholly favoring one. Thus, differential weighting may permit the system to account for overlapping data while reducing distortion of substantially similar information.

In some embodiments, the system may reject certain external data altogether. By way of example, external data may be rejected if it is stale, unverifiable, improperly matched to a resource, inconsistent beyond an allowable threshold, duplicative to a degree that renders it unnecessary, or otherwise determined to be unsuitable for evaluative use. In this regard, rejection may serve to improve the integrity of the hierarchical process by excluding external inputs that would otherwise introduce noise, inflation, or inaccuracy into the evaluation. The system may therefore distinguish between accepted external data, discounted external data, and rejected external data as part of the evaluative framework.

The system may further aggregate accepted external data for use in evaluating the resources. Aggregation may include combining a plurality of validated external inputs into one or more composite evaluative signals, derived values, or resource-associated profiles. For example, in an economic portfolio context, the system may aggregate accepted external inputs associated with market behavior, economic conditions, and asset-specific developments to derive an overall external-data-informed assessment of a holding or group of holdings. In a real estate context, the system may aggregate accepted external inputs associated with valuation conditions, local market activity, property operations, and geographic trends to derive an externally informed assessment of a property or portfolio segment. Such aggregation may occur after validation, overlap identification, rejection, and/or weighting, so that the aggregated result reflects a controlled and screened use of the external data rather than a raw accumulation of all incoming information.

The aggregated external data may then be used together with internal data and/or prior system data to evaluate the resources and to arrange or reevaluate the hierarchy. For example, external data may confirm, modify, strengthen, weaken, or otherwise affect an assessment previously based on internal information alone. A resource that appears favorable based on internal information may be lowered in the hierarchy if accepted external data indicates elevated risk, deteriorating market conditions, or other adverse developments. Conversely, a resource that appears neutral or lower-ranked based on internal information may be elevated where accepted and appropriately weighted external data indicates improved opportunity, stronger outlook, or favorable comparative performance.

The system may also maintain a feedback loop with respect to external data usage. For example, after external data has been validated, weighted, aggregated, and used to influence the hierarchy, the system may later observe outcomes associated with the affected hierarchical determinations. Those outcomes may then inform future treatment of external data from the same or similar sources. In some embodiments, if a particular external source repeatedly corresponds with accurate or useful evaluative outcomes, the system may increase the relative influence assigned to that source in later cycles. If another external source repeatedly corresponds with poor, noisy, untimely, or misleading outcomes, the system may reduce its influence, subject it to additional validation, or reject it more readily in subsequent evaluations.

Accordingly, in this further aspect, the system may ingest external data from a plurality of sources, validate the external data, identify duplicative or overlapping external inputs, differentially weigh such inputs, reject one or more unsuitable external inputs, aggregate accepted external inputs, and use the resulting information to evaluate the resources and dynamically reevaluate their hierarchy. This may permit a more controlled and adaptive use of external data in contexts such as economic portfolio management and real estate asset assessment, particularly where multiple outside sources provide partially overlapping or unevenly reliable information.

For instance, to score the value of a Company’s ‘Real Estate’ as a resource, the tool can be set to collect data from customers/clients creating a rating of the importance of the company’s specific Real Estate location to their decision to purchase. A sampling of customer data is collected by the tool by texting and/or emailing recent customers to understand how important the Real Estate location is to customer decisions. For instance, a large state University might only have 2 hotels within walking distance of campus, and several more which are outside of walking distance. The tool collects customer feedback to create a rating of that hotel’s ‘Location’ vs that hotel’s ‘Brand Equity’ and can now rate the competitive importance of each resource. The tool then is able in real time to change its graphic representation of the hotel’s Strategic Edge and Strategic priorities. The hotel’s executive leadership can then make capital allocation decisions to deprioritize the hotel’s brand and prioritize it’s location in the next round of advertisements, or vice versa. Additionally, if the ‘Location’ rating is significantly high, leadership may decide to reduce expenditures geared toward increasing that location’s Brand Equity, and instead expand the number of rooms at that location. Additionally, Leadership can use the tool to not only take advantage of strong resources, but to intervene to improve weak resources. The tool will show in real time if the reduced expenditures on Brand Equity building marketing is impacting its standing in the competitive environment. If the deprioritization of Brand Equity growth results in decreased sales, leadership can now reverse its allocation of capital decisions, can reprioritize investment in the building of its Brand Equity, and can thru the tool then see if that decision is indeed improving sales. As the tool compates this particular hotel’s sales to the MSA’s hotel sales data in aggregate, the tool can inform leadership of each resources competitive rating.

### PROPERTY::

Resource Category #1 - Intellectual Property

Trade Secrets

A trade secret is NOT institutional Knowledge – nor is it Industry Know-how – a Trade Secret is stronger – it is, by definition, a secret that is critical to the Company’s success and continued development The Company only shares these on a ‘need to know’ basis. Every individual who knows the ‘Trade Secret’ is held to a higher than normal standard of non-disclosure + non-compete. Include any internally used processes that competitors generally shouldn’t know about, and highlight any trade secrets that the Company actively protects (i.e., strategy outlined by Board of Directors that is shared with leadership, but not the rank and file, process developed by internal engineering that is not generally known in the industry, etc…). Trademarks: The company’s name should be included with any branded or proprietary sounding processes that are used in commerce and which are named in a way that is unique to the Company – must be trademarkable to be included. Patents, or alternatively those inventions chosen not to patent – because the patent disclosure may make it easier for black market to steal and build product. Copyrights: all the written materials, computer code, drawings and charts may be so protected (and the website may be protected). A further aspect to consider is how jealous would competitors be if they understood the true scope of the Company resources in this category?

Resource Category #2 – Real Estate

Owned property including Leases, which are also a form of Real Estate (a 5 year lease in a high traffic location has value, for instance). The Executive Team is prompted to identify and score resources your company has in this category, including an evaluation and scoring of how jealous would competitors be if they understood the true scope of the Company’s resources in this category.

Resource Category #3 – Brand Equity: Brand equity is different than intellectual property – as intellectual property tends to be a legal designation – whereas Brand Equity exists in the minds of your customers, team members, candidates, investors, and shareholders. The Company’s Brand Equity may have value to several different types of stakeholders, consider each: Customers and/or clients; Team members and/or candidates; Investors and/or shareholders; Suppliers, The Regulatory Community, your geographic community; Etc…

Additional food for thought – as you think through your brand’s reputation among each of the stakeholders mentioned above, is there anything about your brand that creates a particularly … •Strong first impression? •An exemplary Experience? •A Lasting Impression? •An especially strong reputation? Lastly, how well does your Brand Equity create: Consistency, Value, Memorability? The Executive Team is further prompted to evaluate how jealous would competitors be if they understood the Company’s brand equity in the market?

Category #4. Typically, Equipment is best used as a ‘Competitive Edge’ when the Equipment is owned in such quantity that it becomes extremely difficult to duplicate – thereby creating a ‘Barrier to Entry’ that limits competition Or if you own equipment that is particularly unique and/or difficult to copy, it could create a strong Competitive Edge, for instance, a software company might own source code that is technically not patentable, but is still very difficult and expensive to copy.

For example without limitation, Excavators have bulldozers. Offices have data analysis and ERP systems. SaaS companies have source code. Delivery Services own fleets of vans, trucks, and planes. While perhaps easier to replace than real-estate, equipment is still expensive and difficult to acquire – sometimes a company may own so much it becomes a major competitive edge (ie, a manufacturer’s investment in assembly line robots may be very difficult to duplicate). The Executive Team is prompted to list any equipment that makes the company not only competent, but competitive, particularly identifying important resources (equipment) the company has in this category. The Executive Team would also be prompted to evaluate how jealous would competitors be if they understood the true scope of the Company resources in this category?

### RELATIONSHIPS::

Category #5 – Access to Investors and/or Capital. This includes Bankers who recognize your collateral, go to bat for you, and are able to help you get loans when needed. It also includes Investors who have the capital you need, when you need it, and are willing to invest it in you; or who are willing to introduce you to those who do; Brokers who go to bat and actively help you secure the funding you need; A network that helps you get in front of the investors you need, when you need them. Don’t forget to include any family, friends, work colleagues, even your own business partners, or anyone else willing to invest in you. The Executive Team is further prompted to list any resources the Company has in this category (list any investors and/or capital access points of significance) and evaluate how jealous would competitors be if they understood the true scope of the Company’s resources in this category?

Category #6 – Team: Evaluating the Company’s team may be difficult to do internally. There is a natural tendency to believe in one’s own team. However, when evaluating the Company’s team, ask yourself the question – is the Company’s top competitor also proud of their own team? Or are they jealous of the Company’s? Is the Company’s team particularly strong in a way all competitors simply can’t duplicate, and that is especially beneficial to the company?

Does the company have a strong culture? A strong culture is one that creates one of more of following: Lower than average turnover; Lower than average hiring and/or onboarding costs; A particularly unique work experience that makes work more fun and/or productive. Or perhaps the company culture is just known for being unique in a way that makes it easier for the company to recruit and retain team members – examples include: A particularly Diverse culture; Shared hobbies; Star Wars fans; Gamers; Sports enthusiasts; Particularly creative people; Particularly ambitious, etc. NOTE: NONE OF THE ABOVE-MENTIONED ASPECTS OF COMPANY CULTURE MERIT A PARTICULARLY HIGH SCORE UNLESS THE CULTURE IS UNIQUE IN A WAY YOUR COMPETITORS ENVY AND STRUGGLE TO DUPLICATE. ESSENTIALLY, COMPANY CULTURE HAS TO BE NOT ONLY VALUABLE AND EXTENSIVELY LEVERAGEABLE, BUT ALSO UNMATCHABLE, MEANING DIFFICULT TO ACQUIRE AND/OR MIMIC.

Particularly capable people who are better than the company’s competitors’ people in at least one of the following ways: Cheaper, Faster, Better Quality. The Executive Team is also prompted to evaluate whether the company’s team is significantly more agile, creative, or innovative than your competitors and how the Company’s top competitors rate the quality of the Company’s team and whether those competitors would be jealous, and how the Company’s top competitors rate the quality of their own team.

CATEGORY #7 – Sales Channel Access includes a unique relationship with: Customers, Distributors, Sales Channel Partners, Referral Partners, Market Influencers. Factors to be considered by the Executive Team in this evaluation include: Do customers tend to skip the RFP process to come to the company? Do customers and/or distributors give the company ‘First Look’ at new opportunities? Do customers buy from the company without even considering competitors? Do customers tend to believe in the company and dismiss competitors? Do customers tend to become evangelists for the company, proactively working to send other potential customers to the company? When Distributors pitch to new clients, does the company tend to be one of the products they feature in their discussion? Does the distributor pick up the phone and take orders for the company products/services – do distributors offer the company ‘exclusive representation’ where they’re unwilling to carry the company’s competitors’ products because they carry the company’s? Does the company have a particularly strong market share in a specific type of customer – examples include: the company selling primarily to single parents; the company consulting only with publicly traded companies; the company only serving attorneys (or barbers, or Army vets, etc…)? Does the company have strong personal relationships with any key clients/customers? Do Clients who choose the company do so because of personal relationships with company members? Or choose the company for political favor or because of mutual business interests? The Executive Team is prompted to consider whether and if top competitors truly understood the Company’s sales channel access, how jealous would they be of it and vice versa.

CATEGORY #8 – Suppliers: Does the company have any unique supplier relationships that give your company a competitive advantage? Does the company have suppliers Who: Most competitors can’t get access to? Have been curated to be particularly valuable or efficient to the company? Go the extra mile in a way that’s particularly valuable and just for the company? Have special modifications to their product, service, or delivery method for the company? Does a supplier allow the company to white-label their products? Do supplier relationships tend to be transactional or are your suppliers invested in the company’s success? The Executive Team would be further prompted to consider if top competitors were to understand the Company’s relationships with suppliers, how jealous would they be and vice versa.

CATEGORY #9 – Production Processes. The Executive Team is prompted to address whether the Company has any production processes that help the company perform particularly: Fast and efficient, High on quality marks, Cheaper than competitors. Further aspects to consider are whether the Company: Has any production processes that competitors are unable to emulate? Has your company been an early adopter in new technologies? Or has the Company simply been better at enabling efficiencies thru technology? NOTE: If the company processes are patented or protected as a trade secret, they should be moved to the ‘Intellectual Property’ category.

HINT: Processes are easy to copy, but when combined with other Diamonds (Resource Categories), may become quite formidable. For instance, if the Company is consistently known to be implementing improvement processes faster than competitors, the Company will over time build better brand equity. Or perhaps the Company has processes that are only implementable because of your strong and unique culture. Alternatively, the Company may have incredible processes that are enabled by unique equipment. In this way, Processes may become much more difficult to copy (Unmatchable) and may become a quite formidable component of the Company’s Competitive Edge. The Executive Team is further prompted to consider if competitors were to understand the efficiency and quality of the Company’s production processes, how concerned would they be?

CATEGORY #10 – Customer Service: The Executive Team is prompted to consider questions including: Does the Company have any customer service capabilities or processes in place that set the Company apart from its competition? Is there anything about the Company’s customer service that makes the customer experience dramatically better than what competitors provide? If top competitors were aware of the quality of the Company’s customer service, how envious would they be?

CATEGORY #11 – Sales & Marketing: The Executive Team is prompted to consider questions including: Does the Company have processes in place that make the Company particularly strong at any (or all) of the following: Prospecting – finding qualified leads and/or potential customers/clients; Outreach – making initial contact with these leads; Credibility – crafting trust and/or credibility with these leads; Interest – Making these leads interested in seriously considering the Company’s products/services; Signing – Is there anything in the Company process that ‘greases the skids’ when it comes to the final stages of conversion and contract signing. Further aspects include: When it comes to marketing, does the Company have any better processes for: Planning and executing tradeshows? Utilizing digital marketing? Leveraging social media? Benefiting from print, radio, or other traditional media? Driving word of mouth referrals? Finally, the Executive Team is prompted to consider if the Company is able to leverage some new way of reaching target markets that competitors haven’t thought of yet – or haven’t been able to emulate and the question of whether the Company’s sales and marketing processes vs. those of top competitors consistently outpace theirs, building sales and market share while increasing margin faster than any others are capable of?

CATEGORY #12 – Vision/Leadership. A company’s Vision/Leadership processes are primarily focused around 3 aspects: Clarity of Vision; Is the company’s Vision clearly written down on paper; and Is it Clearly Communicated to the relevant company personnel. Vision/Leadership should be simple enough that Team Members remember and are able to repeat it, and Leadership’s actions should be reflective of the Vision. Therefore, a company should have a process in place for ensuring leadership’s decisions and actions are always aligned with the Vision, so that the actions leadership take increase the Team’s feelings of personal ownership of the Vision. Questions asked include: Do you have a feedback loop in place to make sure Team Members believe in and feel ownership of the vision? Do your feedback loops have a method of alerting Leadership when and if they accidentally make a decision that does NOT align with the Vision?

Managing conflict is also a key step in aligning Everybody’s actions to the Vision. Company leadership should have a process for managing conflict and using it to create better understanding and camaraderie among the Team and should both ensure that the process is working and that there is a cadence of communication within the Company. Questions addressing these issues include: Do you have a process in place to continually re-instill the Vision among Team Members at every level of the organization? Is Leadership disciplined in keeping up with the cadence?

The Executive Team is prompted to write the briefest possible synopsis of company Vision and score the level of simplicity and clarity in your Vision on a scale, for example without limitation a numerical scale such as from 1-7, for example by prompting scaling evaluation of the following: Score the level of alignment the team sees between the company’s Vision and the Actions they see the company taking; Score the consistency of communication of the Vision; Score leadership’s processes (and abilities) for resolving conflict and using it to drive camaraderie and productivity toward the vision. The scores may be combined, for example without limitation, by an average of the scores from the questions above for use in this process.

CATEGORY #13 – REGULATIONS. This section evaluates factors that are often outside of the control of the company, and as such a negative score is possible. The questions posed include: Are there any regulations and/or public policy initiatives that tend to favor your company over competitors? Are there any regulations in place that create barriers to entry in your market (thereby limiting the competitive pool)? Are there any Special government funding or grants available which give you an edge over competitors (or which reduce the number of competitors)? The Executive Team is prompted to indicate any regulations and/or policies (at Local, State, Federal, or some other level) that impact business (positive or negative) and whether other executives would be positive or negative about the business if they understood the true scope of the regulations and/or policies benefiting the company business. A positive indication might be scored as a positive number (wherein these regulations virtually guarantee business survival and growth), while a negative indication might be scored as a negative number (with the lowest score indicating the regulatory environment could destroy the business). If the company’s applicable regulations and policies so benefit the company that they have the potential to make other executives not only jealous, but angry, increase the score.

CATEGORY #14 – VALUES. To assess a Company’s Core Values, at least 4 aspects are evaluated: Authenticity, Articulation, Distinction, and Direction. While a company need not have any or all of these characteristics, identifying any that have significance to the company helps the Executive Team focus on core items.

AUTHENTICITY: Values are considered Authentic when stakeholders perceive a consistent and reliable set of Core Values being reflected in every decision and/or action taken by leadership (Regardless of leadership’s ability to actually put those values into words, in other words does leadership ‘Walk the Walk’?). It’s acceptable to not yet have a clear set of Company Values, however a problem may arise when a Company claims to have one set of values but makes decisions that don’t match.

Authenticity may be evaluated and scored by one or more of the following questions: Has the company had to take time to think through the potential conflicts that arise when 2 or more of your core values conflict with each other? Does the company have a standard system for resolving the issue when 2 or more of your core values conflict, or do you tend to manage them on a case by case basis? Or is it the case that the company has never had any issues with a conflict between your Core Values?

ARTICULATION: Values are considered to have strong Articulation when the Company’s Core Values have not only been clearly put into writing, but are also memorable to such an extent they may easily be repeated by both Leadership and the various Stakeholders (shareholders, customers, team members, and the surrounding community, in other words does the company ‘Talk the Talk’?). It’s acceptable to not yet know how to state the Company’s core Values, however such communication may enhance the operation of the company. If company personnel are capable of reciting the Company’s core values from memory, those Values likely deserve a higher Articulation score. If most team members could do the same, the Company likely has a quite strong Articulation score. Conversely, the fewer who are able to remember the Company’s core values, the lower the score.

DISTINCTION: Values are considered to have Distinction when they help a company stand apart from its competitors – for instance ‘Integrity and Excellence’ are crucial core values we hope every company holds dear, but they are not Distinctive in the sense that those values are common with a multitude of companies (that is to say Distinctive values are by definition not commonly held and are ‘Above and Beyond Par for the Course’). Questions that are helpful in identifying points of distinction include: Would competitors be required to take on new risks (typically firing clients, eliminating product lines, or passing up new opportunities) if they were to emulate the Company’s core Values? If the company’s competitors would be unable to copy the Company’s Values without facing significant risks or losses of revenue, then those Company Values likely have a strong Distinction score. If competitors could imitate the Company’s Values with zero risk, then those Company Values will tend to have a very low Distinction score.

DIRECTION: Values are considered to provide strong Direction when they help guide and inspire a stakeholder how to manage unexpected conflicts and/or to innovate new ways to increase the impact of those same core values (that is to say values that may guide company personnel ‘So we know how to help’). Questions that provide input and scoring for this aspect of values include: Do the Company’s Values include a clarifying clause that helps stakeholders better understand which types of innovations they should be pushing for in order to improve and amplify the Company’s expression of those Values? Scoring should be higher for values that are exemplified by tangible, measurable achievements, for example having customers is one metric, having ‘happy customers’ is another metric (although less tangible and measurable than the number of customers), and having ‘customers receiving deliveries within 2 hours of ordering’ is another metric (more tangible and measurable, meriting a higher scoring). While all customers desire Faster, Cheaper, and Better – most companies must choose 2 of those 3. Where the Company’s Values makes it clear to Team Members which of these is most important, a higher scoring is indicated. Whereas if Team Members are not encouraged to innovate new expressions of the Company’s Values, the Direction score of the Company’s Values may be evaluated lower.

These various aspects of Values may be summarized and scored. The Company’s Brand and its Values are different :: Company values are a decision – the Company’s brand is the result. Various methods of scoring may be used, either individually on each aspect or collectively averaging all aspects. Where certain aspects have high scoring while other aspects may have lower scoring, this may indicate that the deficient aspects may need further attention.

For each of the categories listed above, the Executive Team may add a brief summary of their resources in that Category, and places that summary on the bottom of that Category’s Diamond. The final product might look like this

Each Diamond will now have a brief description of the company’s most important Resource(s) in that Category, and also a Score.

The Scores are on a 7 point scale, with 7 being Incredibly strong and competitive – almost unbeatable, and 1 being a very weak, almost insignificant resource in the company’s strategy. In alternative embodiments of the invention, other numerical point scales may be used.

Now the Executive Team is required to begin subordinating the Diamonds into a hierarchy. First, the Diamonds are placed into horizontal rows, according to their scores, and the rows are placed one above the other, with the highest scoring Diamonds at the top and the lowest scoring diamonds at the bottom. So in this form the top row would be for any Diamonds scored ‘7’. The next row down would be for any Diamonds scored ‘6’, and so on and so forth down to any Diamonds scored ‘1’ would be in a row at the bottom. Any Diamonds scored less than ‘1’ would appear even further down, etc. etc… Slight variations will exist in other forms of the invention. For instance, half scores could be included, so there might also be a row of Diamonds scoring 6.5 or 5.5. Theoretically, any fractional score could be allowed, so there could be a row of 6.7883 or 2.3009. Additionally, the same process could exist in a similar form, where Diamonds are scored on a 1-10 point scale. Or a 1-5 point scale.

In a still further embodiments, the system may implement a feedback-driven refinement process by which the results of prior evaluations are used to influence later evaluations of the resources. In this regard, the system may not simply ingest data, generate a hierarchy, and stop. Rather, the system may monitor later-occurring information associated with the resources and with actions, recommendations, or outputs produced from the hierarchy, and may use that later-occurring information as feedback for subsequent evaluative cycles.

For example, where the resources correspond to components of an economic portfolio, the system may observe later performance of assets, shifts in volatility, transaction outcomes, realized gains or losses, changes in correlation, sector movement, or other downstream results associated with prior rankings. Where the resources correspond to real estate assets, the system may observe later changes in valuation, occupancy, lease-up performance, tenant stability, operating margin, maintenance burden, neighborhood movement, financing conditions, or asset-level returns associated with previously generated hierarchical positions. Such later-observed conditions may be treated as feedback indicative of whether the earlier evaluation appropriately captured actual opportunity, risk, or relative priority.

In some embodiments, the system may compare the earlier hierarchical arrangement with later-observed outcomes to determine whether the prior arrangement was supported, contradicted, or partially confirmed by subsequent developments. For instance, if a resource was elevated within the hierarchy and later performs in a manner consistent with that elevated position, the system may determine that one or more portions of the underlying evaluative logic were reinforced. If, however, the resource underperforms, deteriorates, or otherwise behaves inconsistently with the prior hierarchical determination, the system may determine that one or more aspects of the earlier evaluation should be adjusted in future cycles. Thus, the system may learn not merely from incoming data, but from the relationship between prior evaluative outputs and later-realized results.

In some embodiments, the system may also be used in a teaching, training, simulation, or demonstration context to illustrate how changes in data associated with one or more characters affect hierarchical arrangement within a computer-implemented environment. For example, in a closed instructional system, a resource representing an asset, property, or other evaluative unit may experience a reduction in value, performance, or another parameter, and the computer system may responsively recalculate the hierarchy and rearrange the displayed positions of tiles, indicators, or other graphical representations associated with the characters. Thus, erosion in the value or condition of one resource may be visually reflected through computer-driven rearrangement relative to other characters whose associated data remains stable or changes differently.

The feedback may be used in a variety of ways. In some embodiments, the feedback may cause the system to alter the significance assigned to certain categories of information in later evaluations. In other embodiments, the feedback may cause the system to alter thresholds, trigger conditions, decision logic, or reevaluation frequency. In still other embodiments, the feedback may affect how the system interprets particular resource states, market conditions, property conditions, or combinations of factors.

The system may further associate feedback with particular resources, groups of resources, asset classes, property types, geographic regions, sectors, or other subsets. For example, feedback relating to one category of real estate assets may inform future treatment of similar real estate assets without necessarily affecting unrelated asset categories. Likewise, feedback associated with one segment of an economic portfolio may be applied more strongly to comparable holdings than to dissimilar holdings. In this regard, the feedback process may be localized, generalized, or selectively applied depending on the implementation.

In some embodiments, the feedback loop may include user-driven feedback in addition to or instead of performance-based feedback. For example, a user may confirm that a ranked result was useful, reject a suggested prioritization, select one resource over another, override a system-produced hierarchy, or otherwise interact with the hierarchical output in a manner that provides additional evaluative meaning. Such user interactions may be captured as feedback and used in later reevaluation of the resources.

The system may perform reevaluation periodically, continuously, upon occurrence of a trigger event, after receipt of a threshold amount of new information, or in response to one or more detected feedback conditions. As a result, the hierarchy may evolve over time to reflect not only newly ingested data, but also the demonstrated effectiveness or ineffectiveness of prior hierarchical determinations. This may be particularly useful in dynamic environments, such as investment environments and real estate markets, where conditions change over time and static rankings may quickly become less informative.

Accordingly, this further aspect may provide a feedback loop in which later-observed outcomes, subsequent asset behavior, property-level developments, user interactions, and other post-evaluation information are fed back into the system for use in later evaluative cycles. In this way, the system may iteratively refine how resources are assessed and hierarchically arranged, thereby permitting the hierarchy to remain adaptive, responsive, and increasingly informed over time.

This would be a matter of the tool extrapolating from the sample data collected to translate the value of a resource’s competitive rating against its competitors. Where 72 out of 100 stakeholders rate the company’s ‘Brand Equity’ as stronger, we can give this resource a ‘Competitive Rating’ of 72%, which could be translated as ‘7 out of 10’ on a 10 point scale, or as ‘3.5’ on a 5 point scale. Or according to Grade levels (F thru A) Or any other designation of scoring the diamonds into a hierarchy, so long as the same point system is applied to all the Diamonds. In some embodiments, particularly those implemented with a software program, the Diamond scoring may be linked to real time events to update Diamond values. These links may be automatic, such as linked to an ERP system or the like, or may be manual, that is members of the Executive Team may reevaluate scores given and the software correlates and updates the total Executive Team score.

This step often causes participants to reevaluate their scores – for instance here, the participant might realize that their Intellectual Property is far more valuable to their competitive Edge, than the Regulations and Public Policies that indirectly benefit their oligarchy. So, at this point, the participant may change the score of the Regulations Diamond down to 4.5, which may then cascade with updates from other participants from the Executive Team to alter scores of Diamonds.

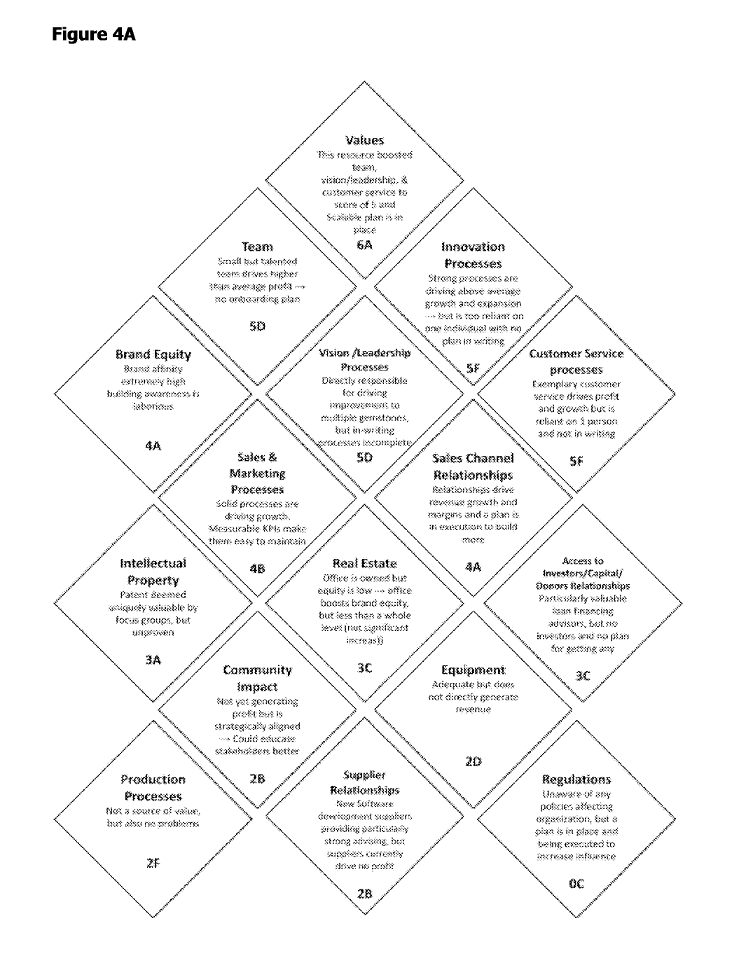

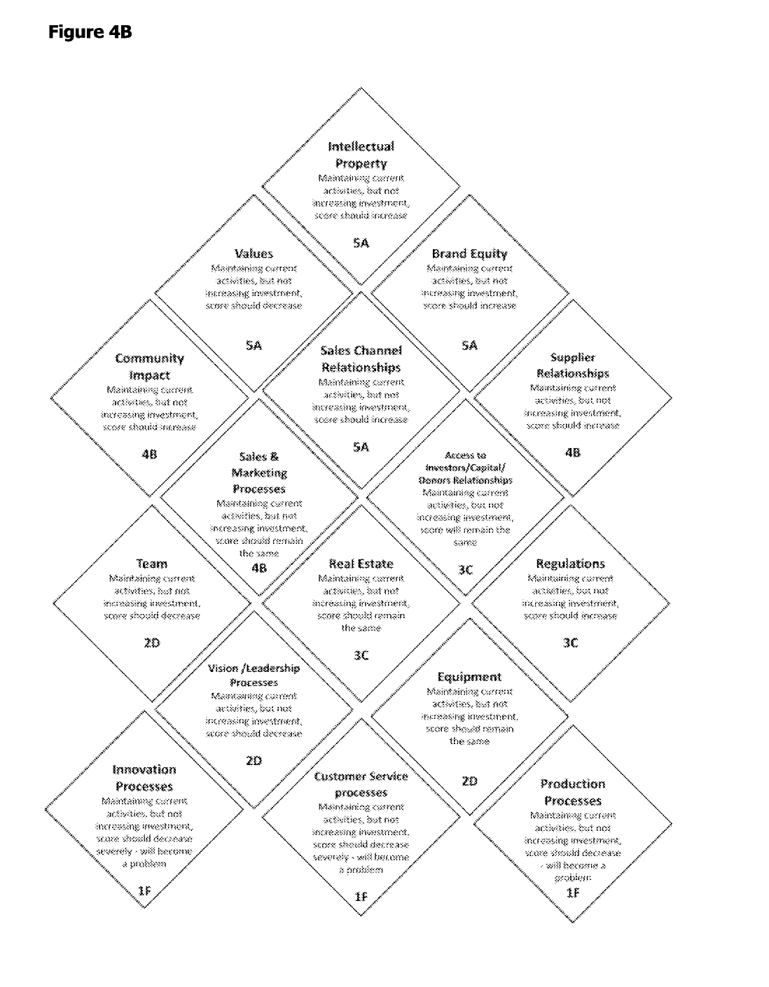

Now the Company’s Strategic priorities may become quite clear. The Company may determine its success through its ability to build new Intellectual Property (primarily patents). FIGS. 4A and 4B show a hierarchy of Tiles, representing one embodiment of the invention’s executive focus roadmap. Although shown as Tiles in this exemplary embodiment, other physical or electronically created display elements may be used to provide the same information and executive roadmap. FIG. 4A shows an initial arrangement of Tiles, after a first evaluation by the Executive Team.

After the FIG. 4A arrangement is determined from evaluating, scoring, and discussing the current state of the Company, the Executive Team is prompted to address the future of the company. As is typically the case, the Executive Team is likely to have a vision of the future of the company, but without having fully thought through how that vision impacts the items of the Diamonds—with the Tiles providing a tangible object upon which the Executive Team may better express that desired future of the Company. By identifying the changes to the Company’s competitive edge the Executive Team desires to build, the Executive Team may assemble a picture the Company’s ‘ideal future state’, involving identifying which Diamonds they expect to invest in for the future, improving those scores so they may build a better Competitive Edge in the business’s future. Using the observations of the Executive Team on the various Diamond factors, the model may be rebuilt so they may see what the competitive edge will look like in that future state. Such a rebuilt model is shown in FIG. 4B, which allows the Executive Team to strategically prioritize resource allocation, and investment so they may improve the company’s competitive edge strategy in the future.

In the exemplary arrangement of FIG. 4B, the development of patents is identified and this goal may then be accomplished by having the best possible team. The team is attracted by the Brand Equity of the company, and the Vision & Leadership. Meanwhile, on the right side of the pyramid, we see the IP development is also supported by massive access to investment capital, which is supported by a fantastic sales channel network and sales and marketing processes.

Down at the bottom, the Real Estate and Equipment holdings of the company are relatively unimportant for this particular Company.

The Core Values have been scored extremely low, largely because they’re kind of pedantic and very run of the mill – Integrity and Excellence are very par for the course values. But it might drive a conversation about the core values of the company – and if the Team is so important to their Edge, perhaps they should re-evaluate their core values, to make them more compelling and relevant, so they may be used to motivate the team, create camaraderie, etc… For instance, to increase team motivation and camaraderie, the core values could be modifed to sound more fun, while still emphasizing honesty, excellence, and even maybe including community or camaraderie. Perhaps something more similar to: “Outlandish integrity, Devotion to excellence, and committed camaraderie with those elite few who understand both” could be a version of the core values that implies we’re not only honest and devoted to excellence, but we do both at elite levels and have some fun along the way.

But the Executive Team may now clearly see they need to allocate lots of resources to keeping their team happy and their access to capital (shareholders) happy, because that is the key to continuing to invest in new IP, which is the company’s Edge in the market. That edge is how the Company gains and protects its market share. The Executive Team also may see they should be delegating decisions related to suppliers, Real Estate, and Equipment, as they’re really not critical decisions.

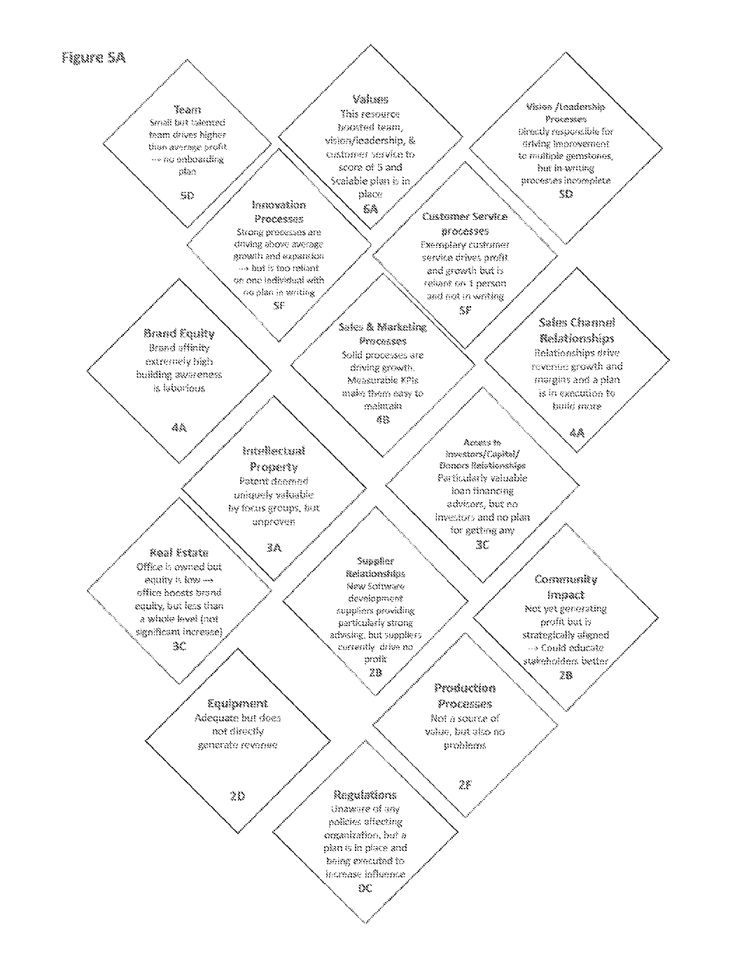

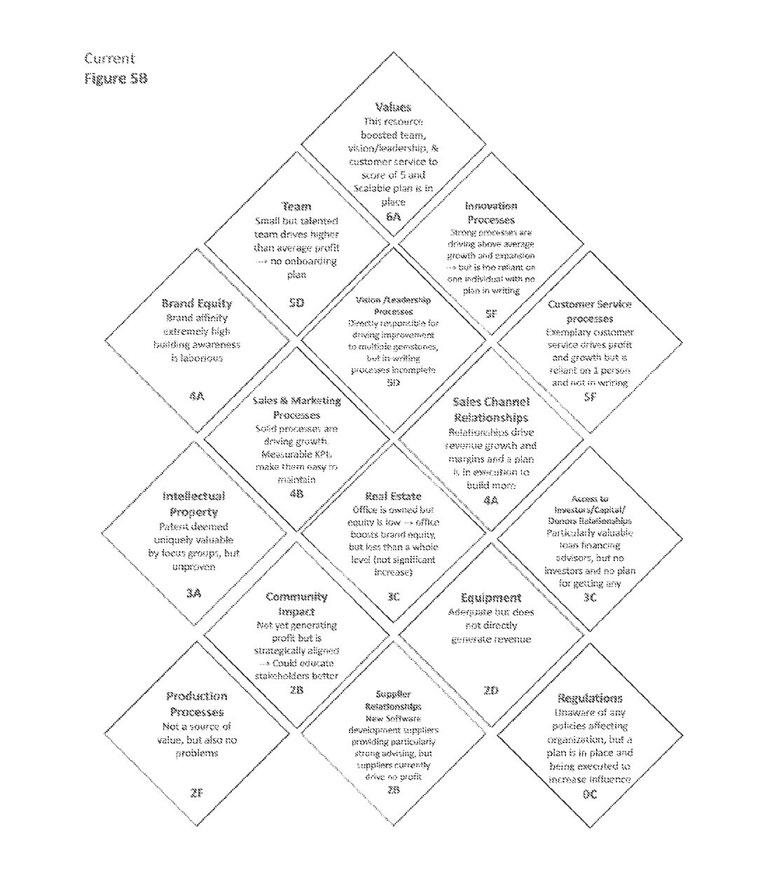

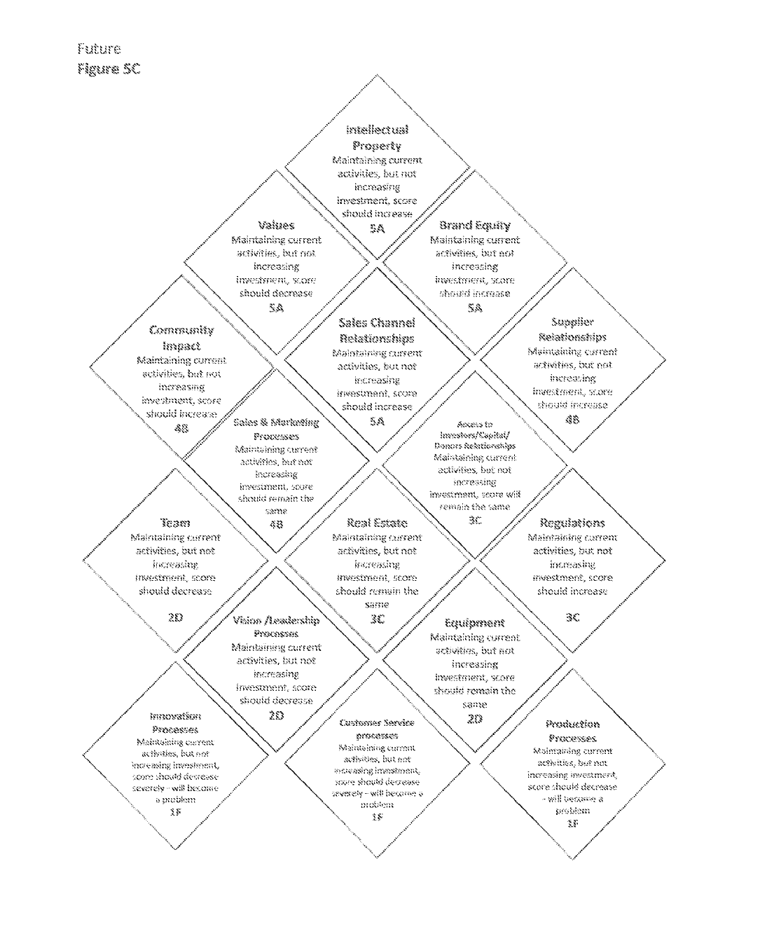

In another embodiment of the invention, gemstones rather than diamonds are used for the physical visualization of the processes. In this embodiment, depicted in FIGS. 5A-5C, the purpose is to identify the competitive edge that will drive the company’s greatest growth, while aligning it with its vision/values. This is accomplished by identifying the company’s most valuable key resources in each of 16 resource categories. In the following disclosure, titled VisionCraft, the value for each of 16 different Resources Categories is explored and clarified. In this embodiment, these Resource Categories are called GemStones.

Each GemStone, similar to the previous embodiment (the previous embodiment characterized by the term “Diamond” whereas the following embodiment being characterized by the term “VisionCraft”), is scored on a 1 - 7 scale via specific codings. Each GemStone receives a detailed yet brief synopsis, so we may see which Resources are most important to the company (sometimes referred to as “you” or the company’s as “your:) in a visual and physical image for executive focus. Some of the terms used in this embodiment have the following meanings.

Leading Edge means The Leading Edge of your VisionCraft. Your Leading Edge is made for cutting through the marketplace - it’s key to moving forward and driving growth. It’s something you also must lead the team to get behind, using your Vision/Leadership process.

GemStone means one or more of the 1 of 16 different Resource Categories, one of which will serve as your Leading Edge.

THE ‘VUE’ FILTER means Filtering Your list of Resources in each GemStone to identify the most competitive.

VUE means Valuable –Unmatchable – Extensively Leverageable, wherein Valuable means able to generate value, Unmatchable means Rare and difficult to duplicate at same quality, and Extensively Leverageable means You may leverage this resource over and over again.

The GEMSTONE SCORING SYSTEM involves all but one of the 16 Resource Categories, called ‘Gemstones’ will be scored on a 1 - 7 scale), wherein Regulations are scored on a (negative 7 - positive 7) scale that includes Zero. The Scores tend to correspond with the following broad categories of Competitive Edge:

7 = Directly or indirectly driving exponential growth of the organization, an exponential increase in profit margin, and/or ability to dominate a market - and doing one of the above in a way in which no competitor may match: driving exponential growth of the organization with profit margin 50% higher and/or growth rate 50% faster than any direct competitors may match; creating or accessing a new market with no competitors where the business may grow either their gross revenue by 100% or more each year and/or valuation by 3X or more each year (and if valuation growth is the metric, the organizations access to capital is strong enough to convert that increased valuation into cash on hand for sufficient working capital required to meet projected expenses for maintaining that growth next year. This includes maintaining the organization’s dominance in a market that creates profit for the organization and where the organization is more than twice the size of its largest direct competitor and where its marketshare is not shrinking and the market itself is also not shrinking for any reason.

6 = Directly or indirectly driving Profits and/or growth rates that are in the top decile when compared against direct competitors (top 10%), while both Profit and Growth Rates are above average, and where the GemStone is projected to continue driving Profit and growth rates at these levels for the next 12 months or more with at least a 95% confidence level.

5 = Directly or indirectly driving your profit and/or growth rate into the top 33% of direct competitors while both profit and growth rate remain above average.

4 = Directly or indirectly driving your profit margin and/or growth rate near average against your direct competitors (higher than the lowest 33% of performers but below the top 33% of performers ). If either of those metrics is below average, this is the highest score you may attain.

3 = <This Gemstone provides moderate value to the organization but is not key to driving any above average financial performance> and/or <this gemstone is projected to have potential to help drive above average financial performance, but other Gemstone(s) must be improved before that value may be realized>.

2 = This Gemstone is not a source of value for the organization but also generates very minimal problems.

1 = This Gemstone either <is generating no direct or indirect impact on profit and/or growth at all> or <is actually reducing financial performance - typically by increasing costs or failing to maintain revenue>.

Defining Direct Competitors involves evaluating several factors. As your business grows, your competitors will change, and even more so as you add new product lines or launch new divisions. The goal is primarily to score yourself against Direct Competitors. NOTE: For MOST Companies, When you go after sales, revenue, and/or profit, your direct competitors are those you compete with to acquire and retain those clients and customers.

For Pre-profit Startups: However, startups may often burn cash for years (even decades) without generating any profit, supported by investors and/or shareholders. If your business is pre-profit and is relying on investors’ cash to pay operating, sales, marketing and other expenses, your ‘Competitors’, are those you compete with to acquire new customers, even if they are not profitable

For Pre-revenue Startups: Your ‘competitors’ are those you compete with to get interest with and money from investors.

To define your Direct Competitors, the following process helps you gauge it properly. #1 - Set aside 10 minutes at a time when you won’t be interrupted. Clear your desk of everything but paper and pencil. Turn off your devices. Set a timer. Go. #2 - Consider your clients and customers. Write down every business, company, and/or freelancer you may think of that you have competed with to acquire your clients/customers. #3 - When your 10 minutes are up, if you find your head still filled with multiple names and you can’t write fast enough, you may continue writing them down. But you’re done. No need to continue brainstorming. #4 - Go through your list and eliminate any that you no longer compete with because you scaled back or better focused your business. (ie, if you used to have 10 product lines but now only have 8, remove competitors who only competed with you in those 2 now non-existent product lines, or if you’re a landscaper in Orange County who once took one job in San Diego but decided not to do it again - then remove any competitors who only do San Diego from your list, etc…).

Next, the company defines the average of its direct competitors profit margins and/or growth rates, as appropriate. NOTE: The Competitive Edge Score for each Resource is compared against the Profit Margin and/or Growth Rate of the above Direct Competitors. NOT against their overall Profit. It’s near impossible for a small team of 10 consultants to beat the year over year profit of a global consulting firm with 10,000 employees. But it is very possible for that small 10 consultant team to hit a faster growth rate and/or profit margin.

The 16 GemStones include the following items (RESOURCES CATEGORIES):

### PROPERTY GemStones:

GemStone 1 :: Intellectual Property (Trade Secrets, Trademarks, Copyrights, Patents, and Customer Data [if it’s in your possession, and you’re keeping it from competitors]).

GemStone 2 :: Real Estate (Land, Buildings, Leases, Digital Real Estate [Domain names, domain authority, etc.]).

GemStone 3 :: Brand Equity

GemStone 4 :: Equipment

### RELATIONSHIPS GemStones:

GemStone 5 :: Access to Investors and/or Capital

GemStone 6 :: Team

GemStone 7 :: Sales Channel Relationships

GemStone 8 :: Suppliers

GemStone 9 :: Community

### PROCESSES GemStones:

GemStone 10 :: Production Processes

GemStone 11 :: Customer Service

GemStone 12 :: Sales and Marketing

Gemstone 13 :: Innovation

GemStone 14 :: Vision/Leadership

MISC GemStones:

GemStone 15 :: Regulations

GemStone 16 :: Core Values

To improve efficacy of the process, the following guidelines are helpful:

SPECIFICITY + CLARITY: When writing a synopsis of your GemStones, do it WITH SPECIFICITY + CLARITY - be as brief as possible while capturing key details. For instance “Significant Real Estate Holdings” is neither specific nor clear, but “We own our office building, tenants cover debt so office is free” is much better. Or another for instance: Customer Service, instead of ‘great at creating raving fans’ write down specifically what it is makes customers so excited, for instance ‘customers rave about the simplicity of working with us”. There’s a HUGE difference when you add the specificity. If I work for you and you tell me “Customers rave because they LOVE us!” – That’s great, but gives me zero clue as to what I should do to help you keep it going. But if you say “Customers rave about the simplicity of working with us” – now I know ‘Simplicity’ is a HUGE priority and I may make adjustments to almost every action I take, to make sure I’m always helping keep things simple for the customer.

CULTURE: There is no Culture GemStone because Culture is actually a combination of your Team, Brand Equity, Vision, and Values. In the sample VisionCraft embodiment of the invention, culture is considered too complicated to be captured in a single Gemstone. It requires a combination of strategically coordinated GemStones to create great culture: TEAM: Culture is created by every decision + every action made by each individual on your team - having the right team, skills, and training are key; VISION/LEADERSHIP: Culture requires a focused direction if it’s to stay cohesive, and this is a function of your Vision/Leadership Process; Core VALUES: The TRUE Core Values of your organization live in a symbiotic relationship with your Culture, both creating and being created by your Culture; BRAND EQUITY: Your Brand establishes all expectations internally and externally. It’s how people become aware of your Culture and helps them understand how they should (or even could) interact with it.

The process involves the following steps: #1 – Please review each of the GemStones listed below; #2 – List any specifically invaluable resources for each GemStone that you feel are valuable and important to the viability of your Company; Keep in mind, there may be some GemStones for which you have no noteworthy resources;

#3A – For each Resource, ask yourself the following: VUE>>Is it Valuable? >>Is it Unmatchable? (hard to find or copy) >>Is it Extensively Leverageable (Are you able to use it over and over)

#3B – For the GemStones – scan down for a Synopsis of the Scoring Rules for each. The rules articulate exactly what your score should be.

#4 - Additional Options:

IF AN INTERNATIONAL COMPANY: If you’re an International Company, you may run the Visioncraft separately for each country/territory in which you operate - to the extent that you consider them separate. You might have a single division for US/Canada or for China/Hong Kong, and these instances of countries that are typically grouped together may be run under a single VisionCraft analysis. Because the strength of any one GemStone may vary wildly from one country to the next, it may be helpful to run the strategy separately for each country/territory.

FOR COMPANIES WITH MULTIPLE DIVISIONS: You may run the VisionCraft separately for each Division of the company, or you may run it for the entire company (or both). You may also use the VisionCraft to identify strategic direction for an entity in charge of running a portfolio of companies (for instance, a private equity firm).

TRENDS AND FORECASTING: To create strategic forecasts and planning, it may be helpful to run the VisionCraft based on your current data. Then modify each GemStone based on your best projections on what that GemStone’s score is likely to be next year, and in each following year for at least 5 years out. You may additionally score and track each GemStone over previous years to see trends over your past few years.

IMPROVING STRATEGY: Lastly, as you consider strategic direction, you should evaluate which GemStones you would like to invest in. Which scores would you like to focus on increasing fastest? And what is realistically possible? What are the GemStones for each successive year after this year?

The VisionCraft then may then be rearranged for a 3 year goal. Any GemStones you project will naturally move up or down without your intervention, should be included and rearranged. But you should also include changed scores for GemStones you proactively plan to invest into for strategic improvements, and also any changed scores for GemStones you plan to proactively deprioritise in your strategic improvements.

HOW TO SCORE YOUR GEMSTONES: While there are multiple methods you may use to score the GemStones - Below are a set of rules we’ve found helpful for many CEOs as one way to streamline the process. Additionally, in the following GemStone Scoring rules, the term Profit and/or Profits is used as a shorthand when actually meaning Profit Margin and/or Profit Margins. Also, the term ‘growth rate’ is used as an abbreviated version of ‘revenue growth rate’, which is the true intent.

PROPERTIES: GemStone #1 - Intellectual Property : Trade Secrets, Trademarks, Patents, Copyrights, Publishing Rights, Customer Data, Source Code, etc… A trade secret is NOT institutional Knowledge – nor is it Industry Know-how – a Trade Secret is stronger – it is, by definition, a secret that is critical to your Company’s success and continued development, wherein You only share these on a ‘need to know’ basis. Every individual who knows the ‘Trade Secret’ is held to a higher than normal standard of non-disclosure + non-compete. It is not only expected, but contractually binding that employees cannot share the trade secret, even after leaving your company. Include any internally used processes that you plan to keep secret from competitors. Include any trade secrets that your firm actively protects (i.e,…strategy outlined by the Board of Directors that is shared with leadership, but not the rank and file, etc…).

Trademarks, Your company’s name should be included (if it is trademarkable), as well as Any branded or proprietary sounding processes that are used in commerce and which are named in a way that is unique to your firm – must be trademarkable to be included. Keep in mind, your trademark might be more valuable in some locals than in others. For instance, Ralph’s Grocery might have strong brand equity in Los Angeles, but if you opened a Ralph’s in Chicago, few would even know what it was.

Patents, Include secrets you have developed for which you are planning to file a provisional patent. Include all patent pending and actual patents you own in whole or part, or have an exclusive licensing right.

Copyrights (website is protected), According to the US Copyright Office, any of the following may be Copyrighted: literary, dramatic, musical, and artistic works, such as poetry, novels, movies, songs, computer software, and architecture. This would include books, sculptures, paintings, photographs, screenplays, Theater scripts, etc… If a work is Copyrighted, no one is allowed to reproduce nor to perform (for an audience) the Copyrighted work without permission from the author.

Publishing Rights, Not to be confused with ‘Copyrights’, Publishing rights are specific rights and/or licenses that an entity receives which gives that entity the right to reproduce a copyright or an item not subject to copyright. A copyright is created when a ‘work’ is created. Then the ‘Author/Creator’ of that ‘work’ may assign and/or sell the ‘Publishing Rights’ to anyone of their choosing. A Publisher may own extremely valuable Publishing Rights (typically exclusive publishing rights) without ever owning any Copyrights. The Publisher then is allowed to print and sell the book. Or prints and sells the photos. Or in some other way publishes a Copyrighted work of art that is then sold.

Customer Data - any customer data you possess and may use that your competitors do not (and cannot) easily get access to.

Source Code - Technically, source code is copyrighted, but may still also be protected by trade secret as much as possible, since it may be hard to detect infringement if it’s copied. Also, while it might only be used internally, it also could be licensed and/or sold to customers all over the world.

Licensing Rights are specifically allowed by the owner of a Trademark, Copyright, or Patent. They are allowed with specific criteria and are often negotiated on a case by case basis. Exclusive licensing rights are much more valuable than non-exclusive. (NOTE: for legal licensing, for instance a license that allows you to practice law in NY or practice psychology in CA, these types of licenses should be accounted for in ‘Regulations’).

Distribution Rights - Obviously, exclusive distribution rights are much more valuable than non-exclusive distribution rights. Provided these rights were acquired in the marketplace, they are considered IP (NOTE: if those distribution rights were mandated by regulators - like the right to distribute alcohol in Alabama - then these rights should be accounted for under ‘Regulations’).

To complete this part of the analysis, write a brief list of your intellectual property (all owned properties). Use the VUE filter to determine which of those properties are most Valuable, Unmatchable, and Extensively Leverageable, the write a brief synopsis of the most important Properties. Be sure to include what it is, why it’s important, and how it helps the company, and edit the synopsis to make it as brief as possible. Intellectual Property GemStone scoring on a scale of 1 to 7, 7 being the highest and 1 being the lowest.

For example, an IP Score of 7 may be summarized as follows: This IP not only protects your revenue by creating insurmountable barriers to entry for competitors, it virtually guarantees higher than industry average profits. With a score of ‘7’, your IP likely dominates the market, or has created a new market (which you now own and/or dominate). This IP quite likely also is able to be awesomely leverageable, you’re not only able to use it to launch new divisions, new companies, new markets, and/or even new business models, but it could even allow you create a new market. All the above, of course, is dependent on your organization maintaining all the other Gemstones upon which the exploitation of this IP relies.

EXAMPLES INCLUDE: Creating and owning a key certification considered extremely valuable in the field (ie, owning the rights to certify individuals in Six Sigma, or EOS, etc…), The songwriter with multiple songs that have become classics, Owning a household facial tissue brand, owning the name of the world’s most used search engine, the Customer Data collected by the world’s largest social media company, exclusive product licensing and merchandising rights to the biggest movie series of the decade, the secret recipe for the world’s most popular soda, a blockbuster drug patent (so long as the patent is still active), etc…

THE CRITERIA for such a rating is that it must satisfy all the Filters seen below:

Filter #1: Your IP satisfies all the requirements of a score of ‘6’ below

Filter #2: Your IP satisfies One or more of the following criteria: (A) Your IP is utilized by your organization and is directly responsible for driving (a positive profit margin or a fast rise in valuation that you’re using to fundraise operating capital) that is increasing every year and that is also above the average profit margin of other organizations your size that are in your industry AND faster than average revenue growth than your average direct competitors; (B) Your IP is directly responsible for driving a valuation to a higher multiplier against revenue than any other direct competitor is able to manage, where you’re also using that higher valuation to fundraise and/or able to use to finance operating capital as required by projections to continue growing at the same rate: (C) Your IP is utilized by your organization and enables the organization to increase one or more of your other Gemstones to the level of a ‘7’(ie, your patent might dramatically increase your access to capital, A Trademark could increase the value of your Brand, a Trade Secret could dramatically improve your Production Processes, etc…); (D) Your IP enables the organization to increase 2 or more Gemstones to the level of a ‘6’; and/or (E) Your IP enables the organization to increase 4 or more Gemstones to the level of a ‘5’.

Filter #3: Your IP must satisfy one or more of the following criteria: (NOTE: Additionally, to score a ‘7’, your IP must be responsible for the exponential growth of your organization, defined as satisfying one or more of the following criteria - whether directly as in A above, or indirectly, as in B, C, and D above, your IP must be driving) (A) 50% higher profits than any direct competitor may manage while maintaining barriers to entry so indirect competitors are unable to reduce the size of your market nor the size of your marketshare in that market; (B) 50% faster growth rate than any direct competitor may manage (while maintaining an above average profit margin when compared against your direct competitors); (C) Owning at least twice the marketshare of any competitor and that marketshare is not decreasing; (D) Your IP is being leveraged to diversify by launching new divisions, business models, companies and/or markets that are (when averaged and considered on the whole) helping your company and/or portfolio of companies grow in revenue or in valuation at least 50% faster than your top direct competitor while maintaining an above average margin and marketshare in your core business; (E) <Your IP is (directly or indirectly) enabling you to launch divisions, business models, companies and/or enter or create new markets> and <At least 1 or more of these new launches also satisfies all of the following>: (1) Entered the market at a cost (after accounting for R&D, development, marketing, and sales) that is 50% lower than the average cost direct competitors would spend to enter that market; (2) Is profitable within the first 12 months, with 1st year profit margins in the top 25% of all direct competitors in that new market; (3) <Is gaining marketshare at a rate equal to or faster than the top 25% of direct competitors> or <is building a new market where the company is profitable, has at most 3 competitors, and is projected to have a 75% chance or higher of growing the market by 25% or more next year>; and/or (4) Is driving 10% or more of the overall profit growth of the parent company and/or conglomerate, while maintaining the above criteria while absorbing the cost of any unsuccessful launch attempts into the successful launch’s financials.

If the new launch(s) are new economy company(ies) (where in lieu of profit, budget comes from investors and growth goals are tracked in terms of usage rates), at least 1 or more of new launches satisfies all of the following: The new launches are gaining marketshare (as scored by number of users in the market where the users are projected to have a profitable lifetime value) either <at a rate equal to or faster than all but 2 competitors> or <at a rate equal to or faster than the top 10% of direct competitors>; The new launch(s) is projected to generate profit for the company before the company loses its ability to continue investing in the new launch; The new launches are generating either profit and/or an increased valuation for the parent organization that is at least equal to 10% of the parent organization’s total valuation; The parent organization’s valuation is projected to continue increasing next year because of the new launch(s); The parent organization is able to remain profitable at a rate that still puts it in the top 10% of profit margins as compared to its direct competitors - even while using its own profit and/or resources to fund the new launch(s); and/or the new launch is allowing you to increase the company’s valuation by 1,000% or more AND you’re successfully onboarding investment capital at a level necessary to meet the projected funding targets necessary to meet the company’s operations and growth goals.

FILTER #4: Your IP satisfies all the following: You project with a 98% confidence level that your IP will be able to continue to drive these competitive edge benefits at a similar or higher level for at least the next 12 months.

IP Score of 6 - SUMMARY: Your IP almost guarantees your profit margin, growth rate, and participation as a market leader among your direct competitors. The IP drives a growth rate and profit margin that are significantly above average. But the IP is not valuable enough to allow you to surpass all competitors. While it may be valuable enough to help you launch new products or product lines, it’s unlikely the IP may help you create a new market that drives significant profit. You might be able to launch new businesses and/or business divisions, but would enter those markets at or below average profit margin and/or growth rate. EXAMPLES INCLUDE: The songwriter whose hit song has become a classic, A popular Ridesharing app trademark, a luxury German automobile Trademark, A global staffing firm’s Customer Data, A global farm and chemical company’s corn and soybean Seed Patents, the publishing rights and/or licensing rights to one of the world’s most famous author’s books, etc…

Large international companies that score a ‘6’ may often become part of an oligarchy. Local SMBs may become a ‘6’ if their IP provides a strong and steady profit that enables them to outpace competitors - for instance, a small local HVAC firm could develop new software to better manage their calendars, communications, and other office management tasks >> then begin licensing the software to other HVAC companies, driving much stronger profits than most other HVAC companies in town. THE CRITERIA: you must satisfy all the Filters seen below:

Filter #1: Your IP satisfies the criteria required to score a ‘5’

Filter #2: Your IP satisfies at least one of the following criteria: IP is responsible for boosting your organization’s profit margin and/or Growth Rate into the top 10% of direct competitors, while neither profit margin nor growth rate dip into the lowest 33% of your direct competitors, and where you project either the Growth Rate or Profit Margin would dip below the top 10% if your IP was only driving results comparable to your direct competitors’ average IP performance. Also, the portion of profit generated by your IP is considered stable, safe, and the risk of losing this IP advantage at any point in the next 12 months projected at less than 2%; Your IP is directly responsible for driving your company’s valuation to a higher multiplier against revenue, placing your multiplier in the top 10% of all competitors, and where you’re also using that higher valuation to fundraise and/or able to use it to finance sufficient operating capital as required by projections to continue growing at the same rate; Your IP is utilized by your organization and enables the organization to increase one or more of your other Gemstones to the level of a ‘6’ (ie, your patent might dramatically increase your access to capital, A Trademark could increase the value of your Brand, a Trade Secret could dramatically improve your Production Processes, etc…); Your IP enables your organization to increase 2 or more Gemstones to the level of a ‘5’; or Your IP enables your organization to increase 4 or more Gemstones to the level of a ‘4’.

Filter #3: Your IP must satisfy 1 or more of the following criteria: (NOTE: Additionally, to score a ‘6’, whether directly as in A above, or indirectly, as in B, C, and D above, your IP must be responsible for providing strong, steady, and secure profitability to your organization, defined as satisfying one or more of the following criteria) RULE: Once again, please consider Direct Competitors when considering these criteria for giving your organization an IP score of ‘6’: Your IP is directly or indirectly enabling a profit margin at least 50% higher than your average direct competitors may manage while maintaining barriers to entry so indirect competitors are projected to be unable to reduce the profit enabled by your IP’s contribution.100% faster revenue growth rate than your average direct competitors are managing, while maintaining an above average profit margin when compared against your direct competitors; Your IP is being leveraged to launch new product lines, divisions, and/or companies that are successfully driving the growth of your overall net profit margin to a level more than twice the average profit margin of your direct competitors; Your IP is directly enabling you to launch new products, new product lines, and/or new divisions that are: At least 1 or more of these new launches also satisfies all of the following: Entering the market at a cost (after accounting for R&D, development, marketing, and sales) that is 25% lower than the average cost direct competitors would spend to enter that market; Is profitable and has profit margins that are in the top 49% of all direct competitors in that new market; Is driving 25% or more of the overall profit growth of the parent company wherein (1) The parent company has above average profit margin against its own direct competitors - the new launches’ profits may be included, (2) The parent company is growing revenue at an above average rate against its direct competitors - the new launches’ revenue may be included, (3) And may maintain the above criteria while absorbing the cost of any unsuccessful launches utilizing this IP into its own financials, OR (4) If the new launch(s) are new economy company(ies) (where in lieu of profit, budget comes from investors and growth goals are tracked in terms of usage rates), at least 1 or more of these new launches also satisfies all of the following: (a) The new launches are increasing the valuation of the parent company at a rate that is at least as fast as the new launch’s top 20% of direct competitors are capable of at least one of The new launch(s) is projected to generate profit for the company before the company loses its ability to continue investing in the new launch, The new launches are generating either profit and/or an increased valuation for the parent organization that is at least equal to 5% of the parent organization’s total valuation, The parent organization’s valuation is projected to continue increasing next year because of the new launch(s), The parent organization is able to remain profitable at a rate that still puts it in the top 25% of profit margins as compared to its direct competitors - even while using its own profit and/or resources to fund the new launch(s), OR if the new launch satisfies all the following: Is allowing you to increase the parent company’s valuation by 3X or more (at least 3 times the former valuation) and you’re successfully able to use this higher valuation to increase your access to capital at a level necessary to meet your funding targets projected as necessary to meet the company’s operations and growth goals.

Filter #4: You satisfy all the following: You project with a 98% confidence level that your IP will continue to drive these competitive edge benefits at a similar or higher benefit to the firm’s profit margin and/or growth rate for the next 12 months or longer.

IP Score of 5 - Your IP sets you apart from most direct competitors. You are well above average as most competitors struggle to keep up and your IP provides a nice and steady tailwind. While this tailwind is not guaranteed, the benefits to your competitive edge provided by your IP is, with continued managerial and operational support, very likely to remain in place for the next 12 months or more.

EXAMPLES INCLUDE: The artist with a current hit song (unlikely to become a classic - requires tour support and interviews to keep the profit rolling), a big pharma company with a series of moderately in demand pharmaceutical patents, a tech company with source code that makes its operations more efficient and increases net profit margin to the top 25% of direct competitors, an accounting firm with irreplaceable customer data that has been optimized to increase customer loyalty to the top quartile against industry averages., etc… THE CRITERIA: you must satisfy all the Filters seen below:

Filter #1: Your IP satisfies all of the requirements for a Score of ‘4’ below

Filter #2: Your IP satisfies at least one of the following: (A) IP is responsible for boosting your organization’s profit margin and/or Growth Rate into the top 33% of direct competitors, while neither profit margin nor growth rate dip into the lowest 33% of your direct competitors, and where you project either the Growth Rate or Profit Margin would dip below the top 33% if your IP was only driving results comparable to your direct competitors’ average IP performance. Also, the portion of profit generated by your IP is considered stable, safe, and the risk of losing this IP advantage at any point in the next 12 months projected at less than 2%; (B) Your IP is directly responsible for driving your company’s valuation to a higher multiplier against revenue, placing your multiplier in the top 33% of all competitors, and where you’re also using that higher valuation to fundraise and/or able to use it to finance sufficient operating capital which projections require to continue growing at the same rate; (C) Your IP is utilized by your organization and enables the organization to increase one or more of your other Gemstones to the level of a ‘5’ (ie, your patent might dramatically increase your access to capital, A Trademark could increase the value of your Brand, a Trade Secret could dramatically improve your Production Processes, etc…); or (D) Your IP enables the organization to increase 2 or more Gemstones to the level of a ‘4’.

If A above, then these profits also match at least one of the following criteria: (RULE: Once again, please consider Direct Competitors when considering these criteria for giving your organization an IP score of ‘5’.) They directly drive a 10% higher profit margin than your average direct competitor may manage; The IP directly drives 50% faster gross revenue growth than your average direct competitors may manage (while maintaining an above average profit margin when compared against your direct competitors); Your IP is directly enabling you to launch new products, which boosts your entire organization's bottom line profit margin to at least 10% above the average profit margin of your direct competitors

FILTER #3: Your IP satisfies all the following: You project with a 95% confidence level that your IP will continue to drive these competitive edge benefits at a similar or higher level of contribution to the firm’s profit margin and/or growth rate for the next 12 months or longer.

IP Score of 4 - IP drives profits and revenue growth that place you near the average rate of growth that most of your direct competitors are managing with their IP (against direct competitors). This means most competitors likely have IP of similar value or better, or perhaps you have higher costs or operational inefficiencies which your IP is helping you overcome. Additionally, those who don’t yet have IP of this quality could easily acquire IP of similar value.

EXAMPLES INCLUDE: Your IP is actively protected (ie, secrets are actively kept secret, filings and licenses are kept up to date, you have a legal process in place to protect the IP’s value) below For Traditional Companies and nonprofits: The profit your IP generates is positive and boosts your organization’s profit margin to Average, your IP is better than the lowest 33% of IP scores when compared against your direct competitors, but not as well as the top 33%. THE CRITERIA: You must satisfy all the Filters seen below:

Filter #1 (and only): Your IP also meets one or more of the following criteria: Protected IP is critical for directly and/or indirectly enabling your profit margin and growth rate to be higher than the lowest 33% of your direct competitors is managing, but not as good as your best 33% of competitors is doing (you’re in the middle 3rd - if there’s a bell curve, you’re near the middle of it); Your IP is directly responsible for driving your company’s valuation to a higher multiple against revenue, placing your multiple above the lowest 33% of direct competitors, but below the highest 33% of all competitors, where you’re also using that higher valuation to fundraise and/or able to use it to finance sufficient operating capital which projections require to continue growing at the same rate; Your IP is utilized by your organization and enables the organization to increase one or more of your other Gemstones to the level of a ‘4’ (ie, your patent might dramatically increase your access to capital, A Trademark could increase the value of your Brand, a Trade Secret could dramatically improve your Production Processes, etc…). RULE: Once again, please consider Direct Competitors when considering these criteria for giving your organization an IP score of ‘5’.

Filter #2: Your IP satisfies all the following: You project with a 95% confidence level that your IP will continue to drive these competitive edge benefits at a similar or higher level of contribution to the firm’s profit margin and/or growth rate for the next 12 months or longer.

IP Score of 3 - SUMMARY: <Protected IP, value appears high but is unproven. It hasn’t yet been able to boost your revenue above average and has not been able to increase your valuation > or <it is also possible your profit is above average, but the IP you own is considered valuable by the company, but has not yet been able to contribute to the company’s profit.> Specifically, you believe in the potential of your IP, but it is not currently driving profit margin and/or revenue growth - or if it is driving some profit margin and/or growth rate, your average direct competitors have IP that is driving more. Even if it was once highly valuable, but is no longer performing at the average rate of your competitors’ IP, you’re a 3.

EXAMPLES INCLUDE: Owning a patent (or patent application) that is still in development. Your leadership team believes in its value and ability to drive profit in the future, but it is not yet able to do so., A Trademark with lots of opportunity in a field where most competitors have Trademarks as well and yours is performing below average, having a trade secret developed which has allowed you to launch a new division where you think you may drive profitable growth but its not yet proven, a copyright for curriculum you recently began offering and your sales/marketing efforts have not yet had time to pay off, being a songwriter who’s written 200 songs and won some awards but your publisher has not yet gotten you any cuts, etc…). THE CRITERIA: you must satisfy all the Filters seen below:

Filter #1 (and only): Your IP satisfies one of the following criteria: Your leadership team believes the IP has profitable value, but it’s unproven and not yet generating profit, nor driving company growth, nor is it significantly increasing the company’s valuation; Additionally, the IP may require investment, in legal, marketing, sales, operations, or any number of other areas, before you may drive it to help contribute to profit and/or growth; Your IP is helping contribute to profit and/or growth, but at a below average level when compared to your direct competitors - specifically, your IP is in the lowest 33% when compared against the value to profit and/or growth rate your direct competitors are enabling with their IP.

IP Score of 2 - SUMMARY: You have IP. You are expending time, effort, and/or money to legally maintain and protect it. But the IP is not currently driving any increase in your profit and/or growth rate. Additionally, you have no detailed plan (that is realistic and worth investing in) to turn the IP into profit and/or growth. EXAMPLES: A songwriter who has copyrighted their songs but no realistic plan of action for sharing them with any industry professionals, a company name that is trademarked but the Trademark does not drive profit margin and/or growth, customer data that is not used or can’t be used to increase profit and/or growth, etc…). GUT CHECK: ie - if your competitors know about your IP but don’t wish they had it, you are probably a 2). CRITERIA: you must satisfy all the Filters seen below:

Filter #1: Your IP must satisfy one or more of the following criteria: FOR TRADEMARKS, PATENTS AND COPYRIGHTS you must satisfy all the following: You’ve filed your legal documents and are proactively protecting your rights (ie, you are monitoring for infringement, and send cease and desist letters when they are infringed as obviously, you don’t want anyone to steal your organization’s name. But beyond this, the IP isn’t driving any measurable value for your organization. CUSTOMER DATA AND/OR TRADE SECRETS: You proactively keep trade secrets secret and keep your customer data secret. Employees have signed documents confirming confidentiality of these secrets and know they can’t take the info with them - and you proactively proactively have processes in place to enforce this.

FILTER #2: Satisfies all the following: You haven’t figured out how to leverage the data to generate any increase in profit and/or growth rate; You have no plan of action in place yet to begin doing so.

IP Score of 1 - CRITERIA: you must satisfy all the following: So far as you know, you have no IP, You have explored no Trademark, Copyright, nor Patent filings; You have no processes in place to keep trade secrets and/or customer data secret; You have no trade secrets, no customer data, and no legally filed IP (HINT: A small business may not need as much IP to get a higher score. For instance, a small biotech with a single hugely valuable patent could turn a $50M company into a Billion dollar acquisition, rocketing it into massive growth - giving the small company a ‘7’ on IP. But a Billion Dollar patent for a large pharmaceutical company might only enable it to reach a score of ‘6’, or even ‘5’). Conversely, a public speaker may build a very small $800k business with a book that becomes successful (the Copyright IP >> Brand Equity). While that is an extremely small business compared to most, this would be considered a pretty strong success in the highly competitive professional speakers market - most likely a score of ‘5’ or ‘6’, depending on who this SMB considers its Direct Competitors.

GemStone #2 – Real Estate: Owned property; Land, offices, manufacturing facilities, etc…; Leases are also a form of Real Estate (a 5 year lease in a high traffic location has value, for instance). Delta’s leasing of gates at Hartsfield-Jackson Airport has immense value as it keeps competitors locked out. Further consider Digital Real Estate such as Domain names and Domain authority - because domain authority tends to be tied to a specific digital property (ie, owning facebook.com/disney, @elonmusk, or sony.com), it is a form of Real Estate. Because of the relatively unstable nature of domain authority, it’s important to temper the value of this. (HINT: The key to ‘Real Estate’ – these are properties that may only be owned by 1 entity or group at a time, are impossible to duplicate, and are currently owned at least partially by you. For instance, 575 N 5th Ave, New York, NY is a specific address and if you own it, your competitors can’t and vice versa. Or if you own www.domain.com then it’s yours. Your competitors can’t have it.) Consider briefly jotting down any real estate your company owns: Any leases that are particularly valuable to your company; Office, labs, manufacturing facilities or other building leases; Residential properties your company might own (whether used to provide affordable housing to employees, or a cash flow buffer during a recession); Naming rights leases (your name on the side of a building, a stadium, on a basketball court, etc…); Other types of property leases – for instance, a large airline able to lease 80% of the gates at Atlanta’s only airport creates a strong competitive edge and higher profit margin for the airline; Any digital real estate you own; Domain Name may drive direct traffic, may impact domain authority, and may impact strength of Trademark, impact brand equity; Digital Authority such as Google domain authority – giving you better SEO than competitors, Social Media algorithms preferencing you – giving you better visibility than competitors (CAUTION: Digital Authority may be transitory and typically requires regular maintenance [either by continuing to publish content, managing keywords and other tags, or both] - if your strength lies here, map out whether the effort to maintain digital authority is a cost or a source of revenue - a marketing company that owns their clients’ domains would find that effort a source of revenue but most organizations would find that maintenance a cost).

To develop the synopsis, Evaluate, which of the above are MOST valuable to your Company? Base your scoring (below) and your synopsis (below) by considering Real Estate Holdings that are Most Valuable to your company’s VisionCraft and Write an extremely brief synopsis of your strongest resource(s) in this GemStone. The following is an example of a REAL ESTATE GEMSTONE SCORING:

Real Estate Score of 7 - SUMMARY: Your Real Estate virtually guarantees you higher profit margin and faster growth than all direct competitors. Your Company’s ‘Real Estate’ not only protects your revenue by creating insurmountable barriers to entry for competitors, it virtually guarantees higher profits than industry average. With a score of ‘7’, your Real Estate is not only leveraged for strong profit, but is also irreplaceable. Perhaps your real estate has been leveraged to create a new market (which you now own and/or dominate). This Real Estate quite likely also is able to be awesomely leverageable, you’re not only able to use it to launch new divisions, new companies, new markets, and/or even new business models, but it could even allow you to create a new market. All the above, of course, is dependent on your organization maintaining all the other Gemstones upon which the exploitation of your Real Estate relies.

EXAMPLES INCLUDE: (ie. owning a bitcoin mining facility in Iceland, a toll bridge with no alternate routes, owning a movie studio in LA, a large conglomerate owning the Panama Canal, a small business owning several theaters on Broadway or a series of storefronts on Rodeo Drive, a mid market company owning a busy seaport, oil field, diamond mine, Owning 10s of thousands of acres with several amusement parks in a city known for amusement parks, a small business that owns the only harbor on a luxury resort island, etc. NOTE: It’s rare for a set of leases to reach a level of ‘7’, but may reach a level of 7 when those leases create a geographic monopoly, for instance an airline owning exclusive long term leases for the majority of gates at a major airport. THE CRITERIA: you must satisfy all the Filters seen below:

Filter #1: Your Real Estate satisfies the criteria required to attain a Real Estate score of ‘6’

Filter #2: Your Real Estate must satisfy at least one of the following: (A) Real Estate is responsible for boosting your organization’s profit margin and/or Growth Rate higher than any other direct competitor, while both profit margin and growth rate remain above average performance against your direct competitors, and where you project either the Growth Rate or Profit Margin would dip below the performance of at least one competitor if your Real Estate was no longer driving better results than any other competitor. Also, the portion of profit generated by your Real Estate is considered stable, safe, and the risk of losing this Real Estate advantage at any point in the next 12 months is projected at less than 2%; (B) Your Real Estate is directly responsible for driving a valuation to a higher multiplier against revenue than any other direct competitor may manage, where you’re also using that higher valuation to fundraise sufficient operating capital as required by projections to continue growing at the same rate; (C) Your Real Estate enables the organization to increase one or more of your other Gemstones to the level of a ‘7’, something that couldn’t be accomplished without this Real Estate (ie, your real estate might boost your Brand Equity, Production Processes, Access to Suppliers, Access to Capital, Team Member retention and recruiting, etc…); (D) Your Real Estate enables the organization to increase 2 or more Gemstones to the level of a ‘6’; (E) Your Real Estate enables the organization to increase 4 or more Gemstones to the level of a ‘5’.

Filter #3: Additionally, to score a ‘7’, your Real Estate must be directly or indirectly responsible for the exponential growth of your organization, defined as satisfying one or more of the following criteria: (A) 25% higher profits than any direct competitor may manage while maintaining barriers to entry so indirect competitors are unable to reduce the size of your market nor the size of your marketshare in that market; (B) 25% faster growth rate than any direct competitor may manage (while maintaining an above average profit margin when compared against your direct competitors); (C) Owning at least twice the marketshare of any competitor where that marketshare is not decreasing; (E) Your Real Estate is being leveraged to diversify by launching new divisions, business models, companies and/or markets that are (when averaged and considered on the whole) helping your company and/or portfolio of companies grow in revenue or in valuation at least 50% faster than any direct competitor while maintaining an above average margin and marketshare in your core business; (F) Your Real Estate is (directly or indirectly) enabling you to launch divisions, business models, companies and/or enter or create new markets where At least 1 or more of these new launches also satisfies all of the following: (1) Entered the market at a cost (after accounting for R&D, development, marketing, and sales) that is 50% lower than the average cost direct competitors would spend to enter that market; (2) Is profitable within the first 12 months, with 1st year profit margins in the top 25% of all direct competitors in that new market <Is gaining marketshare at a rate equal to or faster than the top 25% of direct competitors> or <is building a new market where the company is profitable, has at most 3 competitors, and is projected to have a 75% chance or higher of growing the market by 25% or more next year>; (3) Is driving 10% or more of the overall profit growth of the parent company and/or conglomerate; AND may maintain the above criteria while absorbing the cost of any unsuccessful launch attempts into the successful launch’s financials OR - if the new launch(s) are new economy company(ies) (where in lieu of profit, budget comes from investors and growth goals are tracked in terms of usage rates), at least 1 or more of new launches satisfies all of the following: (a) The new launches are gaining marketshare (as scored by number of users in the market where the users are projected to have a profitable lifetime value) either <at a rate equal to or faster than all but 2 competitors> or <at a rate equal to or faster than the top 10% of direct competitors>; (b) The new launch(s) is projected to generate profit for the company before the company loses its ability to continue investing in the new launch (c) The new launches are generating either profit and/or an increased valuation for the parent organization that is at least equal to 10% of the parent organization’s total valuation; (d) The parent organization’s valuation is projected to continue increasing next year because of the new launch(s); (e) The parent organization is able to remain profitable at a rate that still puts it in the top 10% of profit margins as compared to its direct competitors - even while using its own profit and/or resources to fund the new launch(s) OR - the new launch is allowing you to increase the company’s valuation by 1,000% or more AND you’re successfully onboarding investment capital at a level necessary to meet the projected funding targets necessary to meet the company’s operations and growth goals.

FILTER #4: Your real Estate Satisfies all the following: (A) You have projected with a 95% or higher confidence level that your Real Estate Score will retain this same level of edge over direct competitors’ real estate - for at least the next 12 months; (B)

Real Estate Score of 6 - SUMMARY: At this level your Real Estate is strategically increasing the value and/or profits of your company in ways the great majority of direct competitors cannot emulate. Or if you’re primarily a property holding company, you could reach a score of ‘6’ by driving steady, safe, predictable profits and a valuation that’s not only extensively leverageable, but projected to continue increasing each year. The property is valuable, and difficult to attain, but may not be unmatchable by your competitors. The profits, however, are still strong enough to enable investments into diversification, growth, and/or further Real Estate acquisitions.

EXAMPLES INCLUDE: A scuba company that owns its own docks in the harbor, A property management company that earns at least 50% of its profit from properties it owns, an art gallery that owns its gallery space in Manhattan, a small business owning 10 apartment buildings in one of the country’s largest cities, a mid-market company owning a portfolio of shopping malls, a company owning valuable digital properties with high traffic and a way to monetize that traffic, a fast food chain that owns the property underneath all its franchises and leases that property back to the franchisee, a Public Park that owns and contains a world famous amphitheater that drives tourism, tax revenue, and brand equity for its city, a marketing firm that owns all the digital domains critical to its clients’ success, etc..). THE CRITERIA: you must satisfy all the Filters seen below:

Filter #1: Your Real Estate satisfies all the criteria required to attain a Real Estate score of ‘5’

Filter #2: Your Real Estate Accomplishes at least one of the following: (A) Real Estate is directly responsible for boosting your organization’s profit margin and/or Growth Rate into the top 10% of direct competitors, while neither profit margin nor growth rate dip below average of your direct competitors, and where you project either the Growth Rate or Profit Margin would dip below the top 10% if your Real Estate was only driving results comparable it to your direct competitors’ average Real Estate performance. Also, the portion of profit generated by your Real Estate is considered stable, safe, and the risk of losing this Real Estate advantage at any point in the next 12 months is projected at less than 2%; (B) Your Real Estate is directly responsible for driving your company’s valuation to a higher multiplier against revenue, placing your multiplier in the top 10% of all competitors, and where you’re also using that higher valuation to fundraise and/or able to use it to finance sufficient operating capital which projections require to continue growing at the same rate; (C) Your Real Estate is utilized by your organization and enables the organization to increase one or more of your other Gemstones to the level of a ‘6’ (ie, Real Estate could boost Brand Equity, Production Processes, Access to Suppliers, Access to Capital, Team member retention and recruiting, etc…); (D) Your Real Estate enables your organization to increase 2 or more Gemstones to the level of a ‘5’; (E) Your Real Estate enables your organization to increase 4 or more Gemstones to the level of a ‘4’.

Filter #2: Additionally, to score a ‘6’, whether directly as in A above, or indirectly, as in B, C, and D above, your Real Estate must be responsible for the strong, steady, and secure profits for your organization, defined as satisfying one or more of the following criteria – (RULE: Once again, please consider Direct Competitors when considering these criteria for giving your organization an IP score of ‘6’) (A) Real Estate is directly or indirectly enabling at least a 50% higher profit margin than your average direct competitor may manage while maintaining barriers to entry so that indirect competitors are unable to reduce the profit enabled by your Real Estate’s direct or indirect contribution to the organization’s strategy, execution, and profit; (B) 100% faster revenue growth than your average direct competitors may manage while maintaining an above average profit margin (when compared against your direct competitors); (C) Your Real Estate is being leveraged to launch new product lines, divisions, and/or companies that are successfully driving the growth of your overall profit and/or valuation by more than twice the average rate of your direct competition’s profit and/or valuation growth; (D) Your Real Estate is directly enabling you to launch new products, new product lines, and/or new divisions and At least 1 or more of these new launches also satisfies all of the following: (1) Entering the market at a cost (after accounting for R&D, development, marketing, and sales) that is 25% lower than the average cost direct competitors would spend to enter that market; (2) Is profitable and has profit margins that are in the top 49% of all direct competitors in that new market; (3) Is driving 25% or more of the overall profit growth of the parent company; (4) The parent company has above average profit margin against its own direct competitors - the new launches’ profits may be included; (5) The parent company is growing revenue at an above average rate against its direct competitors - the new launches’ revenue may be included; and (6) The above criteria are accomplished while absorbing the cost of any unsuccessful launches utilizing this Real Estate into its own financials; OR - if the new launch(s) are new economy company(ies) (where in lieu of profit, budget comes from investors and growth goals are tracked in terms of usage rates), at least 1 or more of these new launches also satisfies all of the following: (a) The new launches are increasing the valuation of the parent company at a rate that is at least as fast as the new launch’s top 20% of direct competitors are capable of; (b) The new launch(s) projected to generate profit for the company before the company loses its ability to continue investing in the new launch; (c) The new launches are generating either profit and/or an increased valuation for the parent organization that is at least equal to 5% of the parent organization’s total valuation; (d) The parent organization’s valuation is projected to continue increasing next year because of the new launch(s); (e) The parent organization is able to remain profitable at a rate that still puts it in the top 10% of profit margins as compared to its direct competitors - even while using its own profit and/or resources to fund the new launch(s) OR - the new launch satisfies all the following: Is allowing you to increase the parent company’s valuation by 3X or more (at least 3 times the former valuation) and You’re successfully able to use this higher valuation to increase your access to capital at a level necessary to meet your funding targets projected as necessary to meet the company’s operations and growth goals.

FILTER #3: Your real Estate Satisfies all the following: You have projected with a 95% or higher confidence level that your Real Estate Score will retain this same level of edge over direct competitors’ real estate - for at least the next 12 months.

Real Estate score of 5 - SUMMARY: Strategically acquired Real Estate drives your business’s growth. The majority of direct competitors cannot emulate the value you’re driving - you’re in the top 33%. This could be very profitable digital real estate, or actual tangible property that drives your Competitive Edge, but as you continue growing, it might be difficult for your Real Estate to maintain itself as a significant competitive advantage. EXAMPLES INCLUDE: A small property management company that earns the bulk of its profit from properties it owns, a VC firm owning office space in San Francisco, an Art Gallery that has paid off its owned gallery space in Manhattan, etc… THE CRITERIA: you must satisfy all the Filters seen below:

Filter #1: Your Real Estate satisfies at least one of the following: (A) Real Estate is responsible for boosting your organization’s profit margin and/or Growth Rate into the top 33% of direct competitors, while neither profit margin nor growth rate dip into the lowest 33% of your direct competitors, and where you project either the Growth Rate or Profit Margin would dip below the top 33% if your Real Estate was only driving results comparable to your direct competitors’ average Real Estate performance. Also, the portion of profit generated by your Real Estate is considered stable, safe, and the risk of losing this Real Estate advantage at any point in the next 12 months is projected at less than 2%; (B) Your Real Estate is directly responsible for driving your company’s valuation to a higher multiplier against revenue, placing your multiplier in the top 33% of all competitors, and where you’re also using that higher valuation to fundraise and/or able to use it to finance sufficient operating capital which projections require to continue growing at the same rate; (C) Your Real Estate is utilized by your organization to enable the organization to increase one or more of your other Gemstones to the level of a ‘5’; (D) Your Real Estate enables your organization to increase 2 or more other Gemstones to the level of a ‘4’.

FILTER #3: Your real Estate Satisfies all the following: You have projected with a 95% or higher confidence level that your Real Estate Score will retain this same level of edge over direct competitors’ real estate - for at least the next 12 months.

Real Estate Score of 4 - SUMMARY: Your Real Estate is strategically aligned with driving profit margin and revenue growth, is also likely Owned and providing some small profit and or equity to the company, and is commensurate with being at an average level of value when compared to your direct competitors - Your Real Estate (whether tangible or digital) is strategically valuable and is typically owned. While only moderately leverageable, it is projected to continue increasing in value over the next 5 years - providing a steady tailwind of relatively small profit and/or free rent, though you still have many competitors with similar assets. EXAMPLES: A manufacturer that owns its factory and the property it sits upon, A tech firm that owns a large office in San Francisco or Manhattan, a home services company who’s digital domain is driving significant revenue and profit for the company (but at levels that help it keep up with average direct competitors), etc…). THE CRITERIA: you must satisfy all the Filters seen below:

Filter #1: Your Real Estate satisfies at least one of the following criteria: (A) Your Real Estate is critical for directly and/or indirectly enabling your profit margin and growth rate to be higher than the lowest 33% of your direct competitors is managing, but not as good as your best 33% of competitors is doing (you’re in the middle 3rd - if there’s a bell curve, you’re near the middle of it); (B) Your Real Estate is utilized by your organization and enables the organization to increase one or more of your other Gemstones to the level of a ‘4’; (C) RULE: Once again, please consider Direct Competitors when considering these criteria for giving your organization a Real Estate score of ‘4’.

Filter #2: Your Real Estate Satisfies all the following: You have projected with a 95% or higher confidence level that your Real Estate Score will retain this same level of edge over direct competitors’ real estate - for at least the next 12 months.

Real Estate Score of 3 - SUMMARY: Most direct competitors have Real Estate that is better strategically aligned with their growth and/or profitability than you, and you’re working harder to catch up. EXAMPLES: (ie, leasing space for an art gallery in Manhattan when most competitors own theirs, leasing a nice office when most competitors own theirs, keeping your remote team working at home when most competitors have an office, renting boardroom space for your consulting business, you’ve leased an office that’s a bit too large and overpaying as a result, you own an office but have invested more into it than its currently worth, etc…). CRITERIA: you must satisfy all the Filters seen below:

Filter #1: Your leadership believes one of the following: (A) Your leadership team believes your leased Real Estate provides moderate strategic value - which could be demonstrated if your Real Estate helps raise one or more of your other Gemstone Scores to a 3; (B) You own property that does very little to increase the value of the organization. Debt is large. Your equity in the property is less than what it would cost to sell it; (C) You own a property which your leadership team believes is strategically valuable, but doesn’t yet deliver any increase in profits nor enough equity to increase your access to capital; (D) Your Real Estate is utilized by your organization and enables the organization to increase one or more of your other Gemstones to a level of ‘3’

Real Estate Score of 2 - SUMMARY: Real Estate does little to impact profitability or brand. CRITERIA: Whether owned or leased, beyond its basic function, your real estate does not drive the organization’s profitability, growth rate, or valuation. Nor does it do any harm. It simply functions as an operational expense at a normal level that most competitors also have. Or perhaps you have no Real Estate whatsoever. Everyone works from home. And that is working.

Real Estate Score of 1 - SUMMARY: You have the wrong Real Estate - it’s damaging or is likely to damage the Company’s other Gemstone scores and is something the organization must overcome. EXAMPLES: A consultant working out of their home could create Brand Debt if potential clients think that means they’re too small, a VC firm might lose team members if they moved their offices from San Francisco to N. Dakota, A movie theater might lose customers and revenue if the plumbing starts leaking in the apartments above and the landlord doesn’t fix it, etc… CRITERIA: You have reason to believe your Real Estate is hampering your profit and/or ability is decreasing your scores in one or more of the other Gemstones.

GemStone #3 – ‘Brand Equity’ is built upon three primary factors: AWARENESS, AFFINITY, AND AUDIENCE. AWARENESS involvers How much Awareness does your Audience have for your brand, and how easily may you build more: Attention Grab (Exemplary marketing - does it stand out from the crowd); First Impression (what 1st impression judgements does it create); Memorability (how long do they remember you?). AFFINITY involves For those already aware of your brand, how much do they like/love it: Exemplary experience & Strong reputation; Loyalty and consistency high; Do stakeholders feel ownership for your brand, proactively avoiding your competitors and subconsciously rooting for your success? Do stakeholders evangelize for your brand? AUDIENCE involves When considering your Audience, how well does it connect with various stakeholders - and how large is your potential customer base? Including considering Stakeholders, Shareholders (also investors, bankers, and other capital), Customers, How large is potential customer base, How lucrative is potential customer base, How much does potential Customer base want what your brand has to offer, Team Members (also potential candidates), Suppliers, Community (HINT: Brand Equity is different from intellectual property – as intellectual property tends to be a legal designation or a secret –– whereas Brand Equity exists in the minds of your customers, team members, candidates, investors, and shareholders). Strong Brand Equity will often increase the value of your Trademark, but they are separate resources, influencing each other. Consider WHO it is that has AWARENESS and AFFINITY for your brand? Your Brand Equity may have value to several different types of stakeholders: Customers and/or clients; Team members and/or candidates; Investors and/or shareholders; Suppliers; The Regulatory Community; Your Community; Etc… Consider, what does your brand stand for – when people think about your brand, WHAT is it they’re thinking? Additional food for thought – as you think through your brand’s reputation among each of the stakeholders mentioned above, is there anything about your brand that creates a particularly … Strong first impression? An exemplary Experience? A Lasting Impression? An especially strong reputation? Lastly, how well does your Brand Equity create: Consistency; Value; Memorability.

In evaluating this Brand Equity Gemstone, briefly write, WHY do your constituents care? Jot a brief synopsis of: What your brand means; To whom it is meaningful; Why do they care? Then use the rules below to determine your Gemstone Score.

Brand Equity Score of 7 - SUMMARY: Your Brand Equity not only protects your revenue by creating insurmountable barriers to competitors, it virtually guarantees higher profit margin. With a score of ‘7’, your Brand Equity likely dominates the market, or has created new markets where you dominate competitors. This Brand Equity quite likely also is able to be awesomely leverageable, you’re likely able to use it to launch new divisions, new companies, new markets, and/or even new business models, and it could even allow you to create a new market. All the above, of course, is dependent on your organization maintaining all the other Gemstones upon which the exploitation of this Brand Equity rely. Additionally: Affinity is incredibly high; Awareness is High and Easy to build; Audiences are expansive and extremely valuable. EXAMPLES INCLUDE: A movie studio owning a film franchise so strong it may be used to launch multiple films, TV shows, amusement park rides and more, an internet search engine with such a strong band it may launch an office management software suite and much more, a steakhouse so famous its name may be used to launch colas and bourbon in big box stores, a single popular restaurant with such a strong and unique brand investors begin selling franchises at scale, a global corporation whose brand has allowed it to grow and maintain more than twice the marketshare of its top direct competitor, a small business with such a strong brand reputation its growing twice as fast as its top competitor with no marketing budget, a small NYC pizza joint who’s revenue jumps to 1000% or more over any other pizza joint in the neighborhood after being featured on a famous cooking TV show, etc… THE CRITERIA: you must satisfy all the Filters seen below:

Filter #1: Your Brand Equity meets the requirements for a Brand Equity score of ‘6’ below.

Filter #2: Your Brand Equity satisfies one or more of the following criteria: (A) Your Brand Equity is driving better results than any other competitor and is responsible for boosting your organization’s profit margin and/or Growth Rate higher than any other direct competitor while both profit margin and growth rate remain above average performance against your direct competitors, and where you project either the Growth Rate or Profit Margin would dip below the performance of at least one competitor if your Brand Equity was no longer driving better results than any other competitor. Also, the portion of profit generated by your Brand Equity is considered stable, safe, and the risk of losing this Brand Equity advantage at any point in the next 12 months is projected at less than 2% ; (B) Your Brand Equity is directly responsible for driving your company’s valuation to a higher multiplier against revenue, placing your multiplier higher than any direct competitor, and where you’re also using that higher valuation to fundraise and/or able to use it to finance sufficient operating capital as required by projections to continue growing at the same rate; (C) Your Brand Equity is utilized by your organization and enables the organization to increase one or more of your other Gemstones to the level of a ‘7’ (ie, your Brand Equity might make it easier to attract and retain a top Team, could improve your Sales & Marketing process, access to capital, sales Channel Relationships, or your Vision/Leadership Process); (D) Your Brand Equity enables the organization to increase 2 or more Gemstones to the level of a ‘6’: (E) Your Brand Equity enables the organization to increase 4 or more Gemstones to the level of a ‘5’.

Filter #3: Additionally, to score a ‘7’, your Brand Equity must be driving or enabling the driving of exponential growth of your organization. Exponential growth is defined as satisfying one or more of the following criteria - whether directly as in A above, or indirectly, as in B, C, and D above, your Brand Equity must be driving: (RULE: The following criteria are considered against Direct Competitors: (A) 50% higher profits than any of last year’s direct competitors may manage while maintaining barriers to entry so that indirect competitors are unable to reduce the size of your market nor the size of your marketshare of that market; (B) 50% faster growth than any direct competitor may manage (while maintaining an above average profit margin when compared against your industry average); (C) Having at least twice the marketshare of any competitor where both the market and your marketshare are not decreasing; (D) Your Brand Equity is being leveraged to diversify by launching new divisions, business models, companies and/or markets that are (when averaged and considered on the whole) helping your company and/or portfolio of companies grow in revenue or in valuation at least 50% faster than your top direct competitor while maintaining above average margin and marketshare in your core business; (E) Your Brand Equity is (directly or indirectly) enabling you to launch divisions, business models, companies and/or enter or create new markets where At least 1 or more of these new launches also satisfies all of the following: (1) Entered the market at a cost (after accounting for R&D, development, marketing, and sales) that is 50% lower than the average cost direct competitors would spend to enter that market; (2) Is profitable and has profit margins that are in the top 25% of all direct competitors in that new market; and (3) <Is gaining marketshare at a rate equal to or more than the top 25% of other marketshare gaining competitors, either by gaining customers new to the market and/or taking marketshare from established competitors> or <is building a new market where the company is profitable, currently has no competitors or is in competition with only 2 or 3 others, and is capable of growing the market by 25% or more next year> AND may maintain the above criteria while absorbing the cost of any unsuccessful launch attempts into the successful launch’s profit and loss (“PNL”) OR you may satisfy Filter #3 by doing all the following: The new launch is allowing you to increase the company’s valuation by 1,000% or more in the last 36 months, and you’re successfully onboarding investment capital at a level necessary to meet your funding targets projected as necessary to meet the company’s operations and growth goals.

Filter #4: Your Brand Equity satisfies all the following: You project with a 98% confidence level your Brand Equity will continue to drive these competitive edge benefits at a similar or higher benefit to the firm’s profit margin and/or growth rate for the next 12 months or longer.

Brand Equity score of 6 - SUMMARY: Your Brand Equity almost guarantees your profit margin, growth rate, and participation as a market leader among your direct competitors. Loyalty is so high, continued sales are almost guaranteed. You may charge a premium. Stakeholders tend to evangalize for you. You’ve cracked the code on emotional appeal. You may now count on your brand to drive a significant volume of sales and/or profit margin, or your brand is indirectly driving incredible value by influencing the other Gemstones. However, the brand is less likely to be leverageable for exponential growth into new markets, new companies, etc… Affinity is incredibly high, Awareness is Strong and Easy to Build, Audiences are clearly defined and valuable. EXAMPLES INCLUDE: A historic diner with former celebrity appearances covering the walls and a line out the door, A hotel brand so strong 75% of its hotels are licensing its name to become part of the world’s largest hotel rewards program, owning the world’s most popular soft drink, Owning one of the world’s most popular luxury car brands, a small law firm growing 100% each year after becoming known as the only franchise specialists in a 2M pop metro, a water softener company with more than 75% name recognition across the state, etc…). THE CRITERIA: you must satisfy all the Filters seen below:

Filter #1: Your Brand Equity satisfies the criteria required to score a ‘5’

Filter #2: Your Brand Equity satisfies at least one of the following criteria: (A) Your Brand Equity is responsible for boosting your organization’s profit margin and/or Growth Rate into the top 10% of direct competitors, while both profit margin and growth rate remain above average performance against your direct competitors, and where you project either the Growth Rate or Profit Margin would dip below the top 10% point if your Brand Equity was no longer driving better results than any other competitor. Also, the portion of profit generated by your Brand Equity is considered stable, safe, and the risk of losing this Brand Equity advantage at any point in the next 12 months is projected at less than 2%; (B) Your Brand Equity is directly responsible for driving your company’s valuation to a higher multiplier against revenue, placing your multiplier in the top 10% of all competitors, and where you’re also using that higher valuation to fundraise and/or able to use it to finance sufficient operating capital as required by projections to continue growing at the same rate; (C) Your Brand Equity is utilized by your organization and enables the organization to increase one or more of your other Gemstones to the level of a ‘6’ (ie, your Brand Equity might make it easier to attract and retain a top Team, could improve your Sales & Marketing process, access to capital, sales Channel Relationships, or your Vision/Leadership Process); (D) Your Brand Equity enables your organization to increase 2 or more Gemstones to the level of a ‘5’; (E) Your Brand Equity enables your organization to increase 4 or more Gemstones to the level of a ‘4’.

Filter #3: Your Brand Equity must satisfy 1 or more of the following criteria: (NOTE: Additionally, to score a ‘6’, whether directly as in A above, or indirectly, as in B, C, and D above, your Brand Equity must be responsible for providing strong, steady, and secure profitability to your organization, defined as satisfying one or more of the following criteria: RULE: Once again, please consider Direct Competitors when considering these criteria for giving your organization an Brand Equity score of

‘6’.) (A) Your Brand Equity is directly or indirectly enabling a 50% or more higher profit margin than your average direct competitor may manage and barriers to entry exist so that indirect competitors are unable to reduce the profit enabled by your Brand Equity’s contribution to the organization’s strategy and execution; (B) Your Brand Equity is driving 100% faster revenue growth than your average direct competitors may manage, all while maintaining an above average profit margin when compared against your direct competitors; (C) Your Brand Equity is being leveraged to launch new product lines, divisions, and/or companies that are successfully driving the growth of your overall profit and/or valuation by more than twice the average rate of your direct competitors’ average profit and/or valuation growth; (D) Your Brand Equity is directly enabling you to launch new products, new product lines, and/or new divisions where At least 1 or more of these new launches also satisfies all of the following: (1) Entering the market at a cost (after accounting for R&D, development, marketing, and sales) that is 25% lower than the average cost direct competitors would spend to enter that market spend; (2) Is profitable and has profit margins that are in the top 49% of all direct competitors in that new market; (3) The parent company has above average profit margin against its own direct competitors - the new launches’ profits may be included, (4) The parent company is growing revenue at an above average rate against its direct competitors - the new launches’ revenue may be included; (5) The parent company may maintain the above criteria while absorbing the cost of any unsuccessful launches it has executed into its own PNL OR - if the new launch(s) are new economy company(ies) (where in lieu of profit, budget comes from investors and growth goals are tracked in terms of usage rates), at least 1 or more of these new launches also satisfies all of the following: (a) The new launches are increasing the valuation of the parent company at a rate that is at least as fast as the new launch’s top 20% of direct competitors are capable of; (b) The new launch(s) are projected to generate profit for the company before the company loses its ability to continue investing in the new launch; (c) The parent organization’s valuation is projected to continue increasing next year because of the new launch(s); (d) The parent organization is able to remain profitable at a rate that still puts it in the top 25% of profit margins as compared to its direct competitors - even while using its own profit and/or resources to fund the new launch(s) OR - these new launches satisfies all the following: Is allowing you to increase the company’s valuation by 300% or more over 2 years AND you’re successfully able to use this higher valuation to increase your access to capital at a level necessary to meet your funding targets projected as necessary to meet the company’s operations and growth goals.

Filter #4: Your Brand Equity satisfies all the following: You project with a 98% confidence level that your Brand Equity will continue to drive these competitive edge benefits at a similar or higher benefit to the firm’s profit margin and/or growth rate for the next 12 months or longer.

Brand Equity Score of 5 - SUMMARY: Your Brand Equity sets you apart from most direct competitors. You are well above average as most competitors struggle to keep up and your Brand Equity provides a nice and steady tailwind. But most likely this tailwind is far from guaranteed, your Brand Equity requires much managerial and operational effort in order to maintain its value and the profits and/or benefits it’s generating. You do get a clear and measurable ROI for all time and money invested in building the brand, and you have a plan in place for building brand awareness that you know is working. Affinity is Strong, Awareness is easy to build - you have a strong ROI on brand building efforts, and Audiences are clearly articulated (Suppliers and Community also considered). EXAMPLES INCLUDE: The most popular and very busy new restaurant in town, a law firm whose reputation drives 20% more referrals than most others, an HVAC company whose reputation keeps the phone ringing, a pharmacy with national brand recognition, etc… THE CRITERIA: you must satisfy all the Filters seen below:

Filter #1: Your Brand Equity satisfies all of the requirements of a Brand Equity score of ‘4’

Filter #2: Your Brand Equity satisfies at least one of the following: (A) Your Brand Equity is responsible for boosting your organization’s profit margin and/or Growth Rate into the top 33% of direct competitors, while both profit margin and growth rate remain above average performance against your direct competitors, and where you project either the Growth Rate or Profit Margin would dip below the top 33% point if your Brand Equity was no longer driving better results than any other competitor. Also, the portion of profit generated by your Brand Equity is considered stable, safe, and the risk of losing this Brand Equity advantage at any point in the next 12 months is projected at less than 2%; (B) Your Brand Equity is directly responsible for driving your company’s valuation to a higher multiplier against revenue, placing your multiplier in the top 33% of all competitors, and where you’re also using that higher valuation to fundraise and/or able to use it to finance sufficient operating capital as required by projections to continue growing at the same rate; (C) Your Brand Equity is utilized by your organization and enables the organization to increase one or more of your other Gemstones to the level of a ‘5’; (D) Your Brand Equity enables your organization to increase 2 or more Gemstones to the level of a ‘4’.

Filter #3: Your Brand Equity satisfies all the following: You project with a 95% confidence level that your Brand Equity will continue to drive these competitive edge benefits at a similar or higher benefit to the firm’s profit margin and/or growth rate for the next 12 months or longer.

Brand Equity Score of 4 - SUMMARY: Building Brand Awareness has a plan with clear steps to invest in building with a predictable ROI - focus is on acquiring customers and team members. All of 3 below, but building brand awareness has become somewhat easier. You know what it takes to build awareness for the brand, you get a clear and measurable ROI for all time and money invested in building the brand, and you have a plan in place that you know is working. Affinity is Strong, Awareness may be built with a clear and measurable ROI on your investment, Audience is clearly articulated (might be more focused on benefiting Shareholders, Customers and Team Members). Brand Equity drives profits and revenue growth, and raises you to a level of parity with most direct competitors - You likely have an average level of brand recognition, reputation, and customer loyalty. Other stakeholders likely enjoy you at a level on par with your average direct competitors. You’re now in the middle of the pack running alongside but rarely outpacing most direct competitors. EXAMPLES INCLUDE: A Plumbing Company that has at least average name recognition and brand affinity (loyalty, memorability, client retention, etc…) when compared against its direct competitors, a manufacturer with at least average client retention and client referral rates, etc… THE CRITERIA: you must satisfy all the Filters seen below:

Filter #1 : All of the following: (A) Your Brand is actively managed (ie, you know how to build Affinity for your Brand and Awareness of the Brand) ; (B) Knowing how to build Affinity for your Brand is defined as You knowing the activities required to build awareness of and affinity for your brand [For a small business (less than 100 employees), this knowledge and plan might be in your head. Activity might be based on habits and/or your personality - but the key is, you know what to do and are doing it - proactively building your brand, with effort put in every month over month] [For a mid-market company (100-999 employees), this would typically be defined as a plan that is in writing, with an individual, team, or outside agency managing with a written plan outlining both the strategy and the tactics required for building both brand awareness and affinity + the weekly execution of tasks to get it done.]

Filter #2: These profits also meet one or more of the following criteria: (A) Protected Brand Equity has proven valuable and directly drives your profit margin at least as much as your average direct competitors (ie, your brand is not able to drive profit margin as well as the top 33% of direct competitors’ brands, but your brand is better able than the lowest 33% of direct competitors); Protected Brand Equity is increasing your profit margin by more than 10% above your direct competitors’ average, but indirect competitors are causing your market to shrink, but not by more than 5%/year; (C) Your Brand Equity has increased your valuation to average that of your competition, (D) Your Brand Equity is utilized by your organization and enables the organization to increase one or more of your other Gemstones to the level of a ‘4’ (RULE: Once again, please consider Direct Competitors when considering these criteria for giving your organization an IP score of ‘5’).

FILTER #3: Your Brand Equity satisfies all the following: You project with a 95% confidence level that your Brand Equity will continue to drive these competitive edge benefits at the same or higher benefit to the firm’s profit margin and/or growth rate for the next 12 months or longer.

Brand Equity Score of 3 - SUMMARY: Brand actively managed (ie, you know what needs done and are doing it). You believe there is value in the brand, but the Brand Equity is unproven. Your brand is likely underperforming against your direct competitors, but you don’t have enough quantitative nor qualitative data to confirm value in the brand. OR, you are working to overcome Brand Debt, however you have what you believe is a great plan and are seeing positive early results. You believe your Brand Equity and the activities you’re doing to promote it have potential to drive profit and/or contribute to the growth of other Gemstones, but that potential is not yet proven. While you believe the brand has value, it is doing little beyond perhaps some basic client/customer and/or team member retention. You also lack evidence that your brand equity is driving enough profitability and/or improvements in any of your other Gemstones at a level that would increase their scores for competitive edge.

BRAND DEBT DEFINITION: Brand Debt is something a company may experience if they switch target audiences, try to rebrand to a new brand position, have some particularly bad press, or some other event occurs that forces the company to overcome some negative Brand Equity. BRAND DEBT EXAMPLE: A PBS musician who becomes a corporate consultant and has to dramatically reinvent their reputation, a global automobile company caught cheating on their emissions tests, a consultancy shifting their target market from Small Businesses to Fortune 100 Companies, all the above will likely have to overcome some Brand Debt as they seek to change the Brand Equity they’ve already established. RULE: Value in the brand is primarily residing within those who have already experienced working with your company. Building awareness for your brand requires expenditure of time, effort, and/or money - and your Brand Equity is still below average when compared to your direct competitors. EXAMPLES INCLUDE: A manufacturer who has recently invested in rebranding but hasn’t yet proven the new brand is improving results, A startup iterating their marketing efforts - they believe but still searching for results to demonstrate the brand is working, a small plumbing company without enough data to know if client retention and/or cost of sale are up to par, a new company spun off by a conglomerate with a good plan that is being executed but no proof the brand has value. CRITERIA: you must satisfy all the Filters seen below:

Filter #1: Your Brand meets one of the following: (A) You have a plan for improving the brand - meaning, you know what needs done and you’re doing it. Affinity is strong: Your brand works adequately well to drive client retention, team member retention, and for key stakeholder relationships you’d like to retain. Therefore you have reason to believe the Brand Experience is positive. However, this is based primarily on the experience of working with you. For those who have not experienced working with you, Acquiring new relationships requires you to invest an above average amount of time, effort, and/or money than your average direct competitors; (B) You believe in the Brand you are creating, and are investing time, effort, and/or money to establish your brand and build awareness in the market, but your results are unproven. You don’t have enough data to confirm the Brand Equity is able to build either stronger retention rates or easier acquisition costs. (retention and acquisition costs apply to any relationships you’d like to retain or acquire); (C) You not only have a plan and believe in the brand you are creating, you also DO see positive results and have some data to indicate your brand is working to make acquisition of new stakeholder relationships more efficient. However, you are also experiencing brand debt, which is still requiring you to invest more time, effort, and/or money in your brand than your average direct competitors, (C) Your brand is driving profit and/or growth, but is doing at a level below average - your brand is in the lowest 33% of Brand Equity values when compared against direct competitors.

Brand Equity Score of 2 - SUMMARY: Brand is not actively managed by leadership, it is growing on its own and appears to be working ok, but there is no leadership plan for building the brand, however no problems are apparent. Most Commoditized product manufacturers would go here. Also, it’s very common with small businesses to be built around the personality of the owner/founder/CEO. The CEO’s personality may build a great brand without trying at all. NOTE: If your brand seems to be fine, but you’re not sure how it got that way or how to duplicate and/or scale it, it could be a higher score now, but will likely drop to a 2 as you begin to scale. It could even fall to a score of 1 if the brand creates problems as you grow. We advise studying your brand. Identifying why it works and building a plan to duplicate and/or scale it. EXAMPLES INCLUDE: A manufacturer in a highly commoditized industry, a family owned dairy farm, an accounting firm, a large warehouse rental firm, etc… CRITERIA: Your brand meets one of the following criteria: (A) Brand Equity has not been important to your company’s acquisition and/or maintenance of key stakeholder relationships, including customers. There are no problems with the company’s brand equity, but you also don’t know if there’s any value in it; (B) Your brand equity seems fine, but you do not know how it got that way. You have not considered your Brand Equity a problem so you have no activities nor plan that purposefully manages it. However, you may see no problems being caused by your Brand Equity.

Brand Equity Score of 1 - SUMMARY: Your Brand Equity is not only below average. It’s actually damaging profitability and/or the scores of one or more other GemStones. You likely have some Brand Debt (see above). Due to bad press, a weakened reputation, product fail, rude receptionist, failure to adopt new technologies, or a change in your company’s direction confused customers, etc… EXAMPLES INCLUDE: A clothier known for a type of fashion that has gone out of style, a beer brand associated with white supremacists, a luxury car manufacturer caught lying about their emissions, a once successful tech company that’s losing clients and who’s CEO was just charged with a crime, etc… CRITERIA: You have identified your brand as directly responsible for damaging the scores of one or more other GemStone(s), which GemStone(s) you project have been held back from scores that would have reached 4, 5, 6, or 7 had your Brand Equity not caused the issue.

GemStone #4 – Equipment is typically very easy to acquire. Excavators have bulldozers. Offices have data analysis and ERP systems. Delivery Services own fleets of vans, trucks, and planes. While usually much easier to copy than real-estate, equipment is still expensive and difficult to acquire – especially if your holdings are extremely large or extremely unique (for instance, Delta, United, American, and Southwest Airlines each have so many airplanes, it’s almost impossible for any new airline to compete). Some equipment makes you competent, instead write down any equipment you own that makes you particularly competitive. HINT: Your local competitive landscape may play a huge role. Owning 5 bulldozers on Long Island is unlikely to create much competitive edge. But owning 5 bulldozers in Aspen Colorado, you might have the only 5 bulldozers in town. Take your equipment through the VUE process (it’s rare that equipment would be considered ‘Unmatchable’, but there are some circumstances where your equipment might be particularly rare or difficult to copy). To evaluate this Gemstone, first write a brief synopsis of your Equipment – the synopsis should not only describe the scope of any equipment you have that passes VUE, but also include if it’s able to provide a unique competitive edge. Use the Equipment GemStone Scoring Rules below to find your score:

Equipment Score of 7 - Custom Equipment is Irreplaceably Valuable and able to drive massive exponential growth. With a score of ‘7’, your equipment allows you to dominate the market. Typically, to reach a score of ‘7’ in equipment, you own a valuable and extremely leverageable custom piece of equipment your competitors don’t have or you’ve amassed so much equipment, no one else may compete (for instance the United States Department of Defense). Additionally, to reach a score of 7, your equipment must be not only impossible for competitors to duplicate, but must also drive and/or enable profits and exponential revenue growth for your organization at a level competitors can’t match. The equipment allows you to create and own many partnerships, launch new businesses, create new markets, or own and dominate a profitable marketplace. Or your Equipment is (in a way your direct competitors can’t duplicate) enabling your other Gemstones to do the above. This is typically custom equipment - or an assortment of equipment so large and so efficiently organized no one else may afford or figure out how to duplicate it. It’s Valuable, Unmatchable, and Extensively Leverageable. EXAMPLES INCLUDE: (Owning a space station, custom automation, a small business owning the telephone lines going to every office in town, a mid-market company that owns the primary internet fiber network between Chicago and Denver, the black box algorithms managing internet search engines, Amazon’s distribution network, enough aircraft carriers to maintain control of all 4 oceans, etc…). THE CRITERIA: you must satisfy all the Filters seen below:

Filter #1: Your Equipment satisfies all requirements of an Equipment score of ‘6’ below.

Filter #2: Your Equipment satisfies One or more of the following criteria: (A) Your Equipment is responsible for boosting your organization’s profit margin and/or Growth Rate higher than any other direct competitor, while both profit margin and growth rate remain above average performance against your direct competitors, and where you project either the Growth Rate or Profit Margin would dip below the performance of at least one competitor if your Real Estate was no longer driving better results than any other competitor. Also, the portion of profit generated by your Equipment is considered stable, safe, and the risk of losing this Equipment advantage at any point in the next 12 months is projected at less than 2%; (B) Your Equipment is directly responsible for driving a valuation to a higher multiplier against revenue than any other direct competitor may manage, where you’re also using that higher valuation to fundraise and/or able to use to finance sufficient operating capital as required by projections to continue growing at the same rate; (C) Your Equipment is utilized by your organization and enables the organization to increase one or more of your other Gemstones to the level of a ‘7’ (ie, Your Equipment could drive significant competitive improvements in your Access to Capital, Production Processes, Sales Channel Partners, etc…); (D) Your Equipment enables the organization to increase 2 or more Gemstones to the level of a ‘6’; (E) Your Equipment enables the organization to increase 4 or more Gemstones to the level of a ‘5’.

Filter #3: Your Equipment must satisfy one or more of the following criteria: (NOTE: Additionally, to score a ‘7’, your Equipment must be responsible for the exponential growth of your organization and/or for allowing your organization to dominate and/or monopolize a marketplace. This is defined as satisfying one or more of the following criteria - whether directly as in A above, or indirectly, as in B, C, and D above): (A) Your Equipment must be driving 50% higher profits than ANY direct competitor may manage while maintaining barriers to entry so that indirect competitors are unable to reduce the size of your market nor the size of your marketshare of that market; (B) Your Equipment must be driving 50% faster growth than any direct competitor may manage (while maintaining an above average profit margin when compared against your direct competitors); (C) Having at least twice the marketshare of any competitor and that marketshare is not decreasing); (D) Your Equipment allows you to dominate and/or monopolize a marketplace - defined as owning 50% or more of your target market - and the market(s) your Equipment allows you to dominate is providing at least 50% of your organization’s profits; (E) Your Equipment is being leveraged to diversify by launching new divisions, business models, companies and/or markets that are (when averaged and considered on the whole) helping your company and/or portfolio of companies grow in revenue or in valuation at least 50% faster than your top direct competitor while maintaining an above average margin and marketshare in your core business, wherein <Your Equipment is (directly or indirectly) enabling you to launch divisions, business models, companies and/or enter or create new markets> and <At least 1 or more of these new launches also satisfies all of the following>: (1) Entered the market at a cost (after accounting for R&D, development, marketing, and sales) that is 50% lower than the average cost direct competitors would spend to enter that market; (2) Is profitable and has profit margins that are in the top 25% of all direct competitors in that new market; (3) <Is gaining marketshare at a rate equal to or more than the top 25% of other marketshare gaining competitors and/or is (- either by gaining customers new to the market and/or taking marketshare from established competitors)> or <is building a new market where the company is profitable, currently has no competitors or is in competition with only 2 or 3 others, and is capable of growing the market by 25% or more next year>; (4) Is driving 50% or more of the overall profit growth of your parent company and/or conglomerate; AND may maintain the above criteria while absorbing the cost of any unsuccessful launch attempts into the successful launch’s PNL OR - if the new launch(s) are new economy company(ies) (where in lieu of profit, budget comes from investors and growth goals are tracked in terms of usage rates), at least 1 or more of these new launches also satisfies all of the following: (a) The new launches are gaining marketshare (as scored by number of users in the market where the users are projected to have a profitable lifetime value) either <at a rate equal to or faster than all but 2 competitors> or <at a rate equal to or faster than the top 10% of competitors by rate of marketshare growth>; (b) The new launch(s) projected to generate profit for the company before the company loses its ability to continue investing in the new launch (there is sufficient runway and/or continued capital contribution available to get the launch to self-sustained growth); (c) The new launches are generating either profit and/or an increased valuation for the parent organization that is at least equal to 10% of the parent organization’s total valuation; (d) The parent organization’s valuation is projected to continue increasing next year because of the new launch(s); (e) The parent organization is able to remain profitable at a rate that still puts it in the top 10% of profit margins as compared to its direct competitors - even while using its own profit and/or resources to fund the new launch(s) OR - the new business (or business model) launch is allowing you to increase the company’s valuation by 1,000% or more AND you’re successfully onboarding investment capital at a level necessary to meet your funding targets projected as necessary to meet the company’s operations and growth goals.

Filter #4: Your Equipment satisfies all the following: You project with a 98% confidence level that your Equipment will continue to drive these competitive edge benefits at a similar or higher benefit to the firm’s profit margin and/or growth rate for the next 12 months or longer.

Equipment score of 6 - SUMMARY: Your Equipment almost guarantees your profit margin, growth rate, and participation as a market leader among your direct competitors. Your Equipment enables a profit margin that is far above your direct competitors’ average, but it is not strong enough to allow you to surpass all competitors. For a large company, a score of 6 may often make you part of an Oligarchy. Simultaneously, barriers to entry allow you to project that indirect competitors will not be able to reduce the size of your market nor your marketshare over the next 5 years - The massive amounts of equipment you own, or the unique nature of the equipment, helps create barriers to entry and limit competition. EXAMPLES INCLUDE: Owning the equipment necessary to put satellites into outer space, major airlines owning planes, owning the manufacturing equipment to build computer chips, owning enough inventory to manipulate prices to your advantage in a region or industry, Owning proprietary software that allows your small business to dominate competition or that boosts your profits and reduces theirs because you’re licensing it to those competitors, etc… THE CRITERIA: you must satisfy all the Filters seen below:

Filter #1: Your Equipment satisfies the criteria for an Equipment score of ‘5’

Filter #2: Your Equipment satisfies at least one of the following criteria: (A) Your Equipment is directly responsible for boosting your organization’s profit margin and/or Growth Rate into the top 10% of direct competitors, while neither profit margin nor revenue growth rate dip below the average of your direct competitors, and where you project either the Growth Rate or Profit Margin would dip below the top 10% if your Equipment was only driving results comparable it to your direct competitors’ average Equipment performance. Also, the portion of profit generated by your Equipment is considered stable, safe, and the risk of losing this Real Estate advantage at any point in the next 12 months is projected at less than 2%; (B) Your Equipment is directly responsible for driving your company’s valuation to a higher multiplier against revenue, placing your multiplier in the top 10% of all competitors, and where you’re also using that higher valuation to fundraise and/or able to use it to finance sufficient operating capital as required by projections to continue growing at the same rate: (C) Your Equipment is utilized by your organization to enable the organization to increase one or more of your other Gemstones to the level of a ‘6’ (ie, Your Equipment could drive significant competitive improvements in your Access to Capital, Production Processes, Sales Channel Partners, etc…); (D) Your Equipment enables your organization to increase 2 or more Gemstones to the level of a ‘5’; (E) Your Equipment enables your organization to increase 4 or more Gemstones to the level of a ‘4’.

Filter #3: Your Equipment must satisfy 1 or more of the following criteria: (A) (NOTE: Additionally, to score a ‘6’, whether directly as in A above, or indirectly, as in B, C, and D above, your IP must be responsible for providing strong, steady, and secure profitability to your organization, defined as satisfying one or more of the following criteria): (RULE: Once again, please consider Direct Competitors when considering these criteria for giving your organization an IP score of ‘6’.) Your Equipment drives or enables more than 50% of your organization’s profit, those profits are projected to be at least 95% secure over the next 12 months or more; (B) Equipment is directly or indirectly enabling a 50% or more higher profit margin than your average direct competitors may manage while maintaining barriers to entry so that indirect competitors are unable to reduce the profit enabled by your Equipment’s direct or indirect contribution to the organization’s strategy and execution; (C) 100% faster revenue growth than your average direct competitors may manage (while maintaining an above average profit margin when compared against your direct competitors); (D) Your Equipment is being leveraged to drive new partnerships, divisions, and/or companies that are successfully driving the growth of your overall profit and/or valuation by more than twice the average growth rate of your average direct competition’s profit growth; (E) Your Equipment is being leveraged to drive new partnerships, divisions, and/or companies that are successfully driving the growth of your overall profit and/or valuation by more than twice the average growth rate of your average direct competition’s valuation growth; (F) Your Equipment is directly enabling you to launch new products, new product lines, and/or new divisions that satisfies all of the following: (1) At least one of these launches occurred in the last 36 months; (2) These new launches are Entering the market at a cost (after accounting for R&D, development, marketing, and sales) that is 25% lower than the average cost direct competitors would spend to enter that market; (3) Is profitable and has profit margins that are above average compared to direct competitors in that new market; (4) Is driving 25% or more of the overall profit growth of the parent company; (5) The parent company has above average profit margin against its own direct competitors - the new launches’ profits may be included; (6) The parent company is growing revenue at an above average rate against its direct competitors - the new launches’ revenue may be included; (7) The parent company may maintain the above criteria while absorbing the cost of any unsuccessful launches it has executed into its own PNL OR - if the new launch(es) are new economy company(ies) (where in lieu of profit, budget comes from investors and growth goals are tracked in terms of usage rates), at least 1 or more of these new launches also satisfies all of the following: (a) The new launches are increasing the valuation of the parent company at a rate that is at least as fast as the new launch’s top 20% of direct competitors are capable of; (b) The new launch(s) is projected to generate profit for the company before the company loses its ability to continue investing in the new launch, (c) The new launches are generating either profit and/or an increased valuation for the parent organization that is at least equal to 5% of the parent organization’s total valuation; (d) The parent organization’s valuation is projected to continue increasing next year because of the new launch(s); (e) The parent organization is able to remain profitable at a rate that still puts it in the top 25% of profit margins as compared to its direct competitors - even while using its own profit and/or resources to fund the new launch(s) OR - the new launch satisfies all the following: Is allowing you to increase the parent company’s valuation by 3X or more (at least 3 times the former valuation) and you’re successfully able to use this higher valuation to increase your access to capital at a level necessary to meet your funding targets projected as necessary to meet the company’s operations and growth goals.

Filter #4: Your Equipment satisfies all the following: You project with a 98% confidence level that your Equipment will continue to drive these competitive edge benefits at a similar or higher benefit to the firm’s profit margin and/or growth rate for the next 12 months or longer.

Equipment score of 5 - SUMMARY: Significant Barriers to Entry, and the difficulty of accumulating equipment like yours has thinned the herd, only some competitors may match it, which drives significantly higher than average profit margin and reduces competition. You own valuable equipment that is expensive and/or difficult to acquire. You enjoy barriers to entry high enough that competition is thinned to a point that although you do still have significant competition, you are virtually guaranteed a piece of the pie - Upstart new market entries would require massive capital (or retraining) to catch-up. EXAMPLES INCLUDE: An excavator owning outright more bulldozers than any competitor in a small town or being in the 10% in a large metro, Logistics company with a larger than average fleet of semis, Owning a couple merchant marine ships, etc…. - OR perhaps you have a license to an uncommon software that is difficult to attain, etc…). THE CRITERIA: you must satisfy all the Filters seen below:

Filter #1: Your Equipment satisfies all of the Criteria for an Equipment score of ‘4’ below.

Filter #2: Your Equipment satisfies at least one of the following: (A) Your Equipment is responsible for boosting your organization’s profit margin and/or Growth Rate into the top 33% of direct competitors, while neither profit margin nor growth rate dip into the lowest 33% of your direct competitors, and where you project either the Growth Rate or Profit Margin would dip below the top 33% if your Equipment was only driving results comparable to your direct competitors’ average Equipment performance. Also, the portion of profit generated by your Equipment is considered stable, safe, and the risk of losing this Equipment advantage at any point in the next 12 months projected at less than 2%; (B) Your Equipment is directly responsible for driving your company’s valuation to a higher multiplier against revenue, placing your multiplier in the top 33% of all competitors, and where you’re also using that higher valuation to fundraise and/or able to use it to finance sufficient operating capital which projections require to continue growing at the same rate; (C) Your Equipment is utilized by your organization and enables the organization to increase one or more of your other Gemstones to the level of a ‘5’ (ie, Your Equipment could be driving significant competitive improvements in your Access to Capital, Production Processes, Sales Channel Partners, etc…); (D) Your Equipment enables your organization to increase 2 or more Gemstones to the level of a ‘4’.

Filter #3: Your Equipment satisfies all the following: You project with a 95% confidence level that your Equipment will continue to drive these competitive edge benefits at a similar or higher benefit to the firm’s profit margin and/or growth rate for the next 12 months or longer.

Equipment Score of 4 - SUMMARY: You own Valuable equipment that allows you to drive an average level of profit margin and growth rate, (valuation too) than average (when considering direct competitors). Typically, because the equipment is somewhat limited in supply, or expensive for many direct competitors to acquire - You own valuable equipment that took some effort and planning to put together. Competitors would have to invest at a moderate difficult level to copy you, and many have but many also won’t. This is allowing you to drive a profit margin and growth rate commensurate with your direct competitors’ average. THE CRITERIA: you must satisfy all the Filters below:

Filter #1 : You Equipment satisfies one or more of the following criteria: (A) Your Equipment is critical for directly and/or indirectly enabling your profit margin and growth rate to be higher than the lowest 33% of your direct competitors is managing, but not as good as your best 33% of competitors is doing (you’re in the middle 3rd - if there’s a bell curve, you’re near the middle of it); (B) Your Equipment is directly responsible for driving your company’s valuation to a higher multiple against revenue, placing your multiple above the lowest 33% of direct competitors, but below the highest 33% of all competitors, where you’re also using that higher valuation to fundraise and/or able to use it to finance sufficient operating capital which projections require to continue growing at the same rate; (C) Your Equipment is utilized by your organization and enables the organization to increase one or more of your other Gemstones to the level of a ‘4’ (ie, Your Equipment could be driving significant competitive improvements in your Access to Capital, Production Processes, Sales Channel Partners, etc…).

Filter #2: Your Equipment satisfies all the following: You project with a 95% confidence level that your Equipment will continue to drive these competitive edge benefits at a similar or higher benefit to the firm’s profit margin and/or growth rate for the next 12 months or longer.

Equipment Score of 3 - SUMMARY: Your Equipment is valuable and driving profits, however it is currently able to boost profits only to a below average level of growth rate and/or profit margin. Getting to average will require continued investment of Time, Efficiency, Effort, and/or Capital over and above what your competitors are doing. THE CRITERIA: you must satisfy all the Filters below:

Filter #1: Your Equipment is directly or indirectly key to enabling your organization’s profit margin and/or growth rate. But the majority of competitors are getting more profit margin and/or a higher growth rate out of their equipment than you are gaining from yours. However, you are not dealing with any of the Equipment Debt at the level those with an Equipment Score of 1 are facing. NOTE: The key to improving your Equipment score might lie in being strategic. Sometimes an investment in your Access to Capital may indirectly unlock more opportunity for your Equipment score than taking it head on.

Filter #2: Your Equipment satisfies all the following: You project with a 95% confidence level that your Equipment will continue to drive these competitive edge benefits at a similar or higher benefit to the firm’s profit margin and/or growth rate for the next 12 months or longer.

Equipment Score of 2 - SUMMARY: Your equipment does not drive revenue nor growth. It is purely an operational expense. The equipment might be essential, but is not leverageable to drive profit. It is an operational expense of your company. If your equipment repairs go in COGS, then they are directly driving profit and would score a minimum of a 3. EXAMPLES INCLUDE: A professional services firm owning computers, cubicles and furniture. CRITERIA: satisfies all the following criteria: Equipment does not drive profit margin nor growth rate. This expense does NOTE show up in COGS. Equipment is purely an operational expense. Equipment might be essential to business’s operations, but similar Equipment is essential to your average direct competitors. Your Equipment does not differentiate you from competitors in any significant way, nor does it improve any other GemStone score to a Score of 4 or higher. NOTE: If your equipment repairs do go in COGS, then they are directly driving profit and would have a minimum score of ‘3’.

Equipment Score of 1 - SUMMARY: You have Equipment Debt. Either you lack equipment necessary to compete or your equipment is projected to soon be needing repairs or will be falling out of service. Perhaps it’s becoming obsolete or is needing repairs. EXAMPLES INCLUDE: A startup that needs but does not own computers, a large manufacturer with extremely small margins and outdated equipment, a moving company that has to lease their box trucks when the majority of competition in town has their own, etc… CRITERIA: you must satisfy all the Filters below:

Filter #1: Your Equipment fits one of the following criteria: (A) Equipment repair costs over the next 12 months are expected to reduce profitability by 50% or more; (B) Equipment repair costs over the next 12 months are expected to put you in the red; (C) Required equipment acquisition costs are expected to reduce profitability by 50% or more; (D) Required equipment acquisition costs over the next 12 months are expected to put you in the red; (E) Your equipment leases reduce your profit by 25% or more, and you have projected you cannot rise to an average rate of profitability against direct competitors without putting yourself in the red in order to invest in new equipment.

RELATIONSHIPS: GemStone #5 – Access to Capital and/or Investors (or Donors) HINT: Whether for economic expansion, new technology, investment in people, or simply a safety net in times of need, access to capital may be the critical piece you need when it comes time to take risks and build new markets. Also, profit and sales are not considered part of ‘Access to Capital Relationships’ - All the resources in your VisionCraft work together to drive profitability and growth of that profitability - also sales when needed: Bankers who -Recognize your collateral -Go to bat for you -Are able to help you get loans when needed; Investors who -Have the capital you need, when you need it, and are willing to invest it in you -Or who are willing to introduce you to those who do; Brokers who -Go to bat and actively help you secure the funding you need; A network that Helps you get in front of the investors you need, when you need them. CLARITY RULE: Access to Capital Relationships does not include cash flow, nor customer relationships. When Customers generate steady cash flow by voluntarily returning to your business regularly, the value for that is captured in your ‘Brand Equity’ score. When Customers are “partnering” with you by subscribing or joining a recurring revenue subscription payment, that relationship may drive incredible value for you and contribute to your ‘Channel Partner Relationships’. For the cash flow reliable customers provide, that cash flow is considered a fungible resource which may be used to boost any of your Gemstones. DO INCLUDE cash on hand, and shareholder cash (if they’re willing to contribute it or able to contribute it when required.) As both increase your access to capital. Start this analysis by listing any particularly valuable relationships you might have with any bankers, investors, wealthy relatives, business partners, or any others who might be able to provide a capital infusion when the time is right. Take each of these relationships through the VUE filter. Jot down a brief synopsis of relationships you (or your company) have that truly give you an Edge when it comes to accessing capital. Then use the Access To Capital GemStone Scoring System below:

Access to Capital and/or Investors (or Donors) Score of 7 - SUMMARY: With the strength of these Relationships, you’re able to fund your company to meet aggressive growth goals. You project that your aggressive goals are realistic and also project that when you meet these realistic goals, you will reach sufficient cash flow and/or additional funding in order to continue onward. You have access to a level of funding that exceeds all direct competitors OR you have more funding available than you need or may use. NOTE: ie, if you are a VC, Private Equity, or other type of investment entity), to be a ‘7’, you must have access to a level of funding that allows you to be the lead investor on projects when you choose, is driving profits and/or valuation growth and/or improvements to other resources inside your firm which no competitor may match. All the above, of course, is dependent on your organization maintaining all the other Gemstones upon which the exploitation of this Capital and these relationships rely. Additionally, you could score a ‘7’ in Access to Capital Relationships yet be entirely unable to get any traditional banks and/or SBA loans. EXAMPLES INCLUDE: A startup with angel investors who are not only funding the company’s growth but introducing the company to Venture Funds and other larger revenue sources, an investment banker who has not only provided a massive line of credit but is also helping introduce you to and negotiate with other larger entities, a small tech company that is able to sell a minority stake in its company to a Fortune 100 tech company - bringing in not only massive funding but also operational expertise and distribution networks to massively scale its venture, a small manufacturer with a high margin and high demand product that allows them to grow profits 500% or more each year where all the shareholders reinvest that profit back into the company’s growth (the company owns the relationship with its shareholders and those relationships drive continued access to significant funding. Additionally, Access to Capital is THE KEY competitive edge of VC funds themselves, also private equity. Banks as well, but few banks would score a ‘7’ as they’re competition is strong and their services relatively commoditized. etc… THE CRITERIA: you must satisfy all the Filters seen below:

Filter #1: Your Access to Capital satisfies all the requirements of an Access to Capital Score of ‘6’ below

Filter #2: Your Access to Capital satisfies at least one of the following: (A) Your Access to Capital is utilized by your organization and enables the organization to increase one or more of your other Gemstones to the level of a ‘7’ (ie, your capital does nothing until you use it to improve your resources. This capital might be improving your Equipment, Team, Real Estate, Brand Equity or IP. Additionally, these relationships could be opening doors to Sales Channel Partners, Suppliers, and potential Team members. Additionally, simply the existence of such a strong relationship with capital may increase your Brand Equity. VC firms, for instance, have very strong Brand Equity. Their cost of building Awareness is extremely low and their Affinity with those who know of them is extremely high. This is due primarily because of their access to Capital. Take away that Access to Capital and their Brand Equity score would drop very significantly.); (B) Your Access to Capital enables the organization to increase 2 or more Gemstones to the level of a ‘6’; (C) Your Access to Capital enables the organization to increase 4 or more Gemstones to the level of a ‘5’ or more.

Filter #3: Your Access to Capital Satisfies all the following: (A) Your Access to Capital (relationships) is directly enabling you to fund all necessary operations, marketing, sales, and other expenses required to meet your strategic plan, even if that means operating in the red for multiple months and/or years; (B) Your analysis has determined that both you and the investors providing your capital are approaching this relationship with a win/win mindset. This is defined as high trust: (C) You not only value the relationship, but predict with a 95% confidence level that on a Likert Scale, when asked to score the statement ‘you trust the other party’, both you and your investors would say “strongly agree”; (D) You also predict with a 95% confidence level that on a Likert Scale, when asked to score the statement ‘you want the other party to succeed’, both you and your investors would say “strongly agree”; (E) You project with a 95% confidence level that your Access to Capital will continue to drive these competitive edge benefits at a similar or higher benefit to the firm’s profit margin and/or growth rate for the next 12 months or longer.

Access to Capital and/or Investors (or Donors) Score of 6 - SUMMARY: Your relationships with capital are robust. You have projected your ability to use the capital is not only stable, but could be increased so long as you continue to demonstrate an ability for creating growth and/or a return with it. You have stronger access to capital than 80% of your direct competitors. You project a more than 95% chance your capital access will remain in place for at least the next 36 months. Additionally, your investors are advising you how to use the funds you have and how to receive more. They’re actively engaged in your success and are actively advising you how to improve, how to get more of their money and they have plenty of it - They see you as a solid investment and have communicated their desire to continue working with you. EXAMPLES INCLUDE: a homebuilder in a metro where all competitors are working with banks and they’re funded by a NYC Equity Group with hundreds of millions available to invest. Large international companies that score a ‘6’ may often become part of an oligarchy. Local SMBs may become a ‘6’ if their IP provides a strong and steady tailwind - for instance, a small local HVAC firm could develop new software to better manage their calendars, communications, and other office management tasks >> then begin licensing the software to other HVAC companies, driving strong and steady profits. THE CRITERIA: you must satisfy all 5 Filters seen below:

Filter #1: Your Access to Capital Satisfies all the requirements of a score of ‘5’ below

Filter #2: You project a 95% chance or higher that this access to capital will remain in place for at least the next 12 months, provided you continue to demonstrate the ability to generate growth and/or a return.

Filter #3: Your Access to Capital Relationships satisfy at least one of the following criteria: (A) Your Access to Capital is utilized by your organization and enables the organization to increase one or more of your other Gemstones to the level of a ‘6’ (ie, your capital does nothing until you use it to improve your resources. This capital might be improving your Equipment, Team, Real Estate, Brand Equity or IP. Additionally, these relationships could be opening doors to Sales Channel Partners, Suppliers, and potential Team members. Additionally, simply the existence of such a strong relationship with capital may increase your Brand Equity. VC firms, for instance, have very strong Brand Equity. Their cost of building Awareness is extremely low and their Affinity with those who know of them is extremely high. This is due primarily because of their access to Capital. Take away that Access to Capital and their Brand Equity score would drop very significantly.); (B) Your Access to Capital enables your organization to increase 2 or more Gemstones to the level of a ‘5’; (C) Your Access to Capital enables your organization to increase 4 or more Gemstones to the level of a ‘4’.

Filter #4: Your Access to Capital satisfies all the following: (A) Your relationships provide more Access to Capital than 90% of direct competitors are capable of achieving (ie, you’re in the top 10%); (B) The Capital is available at terms that are favorable for both you and your investors; (C) Your analysis has determined that both you and the other party(ies) providing the capital are approaching this relationship with a win/win mindset. You not only value the relationship, but predict that on a Likert Scale, when asked to score the statement ‘you trust the other party’, you predict at a 95% confidence level that both you and your investors would say “strongly agree”; (D) You also predict with a 95% confidence level that on a Likert Scale, when asked to score the statement ‘you want the other party to succeed’, both you and your investors would say “strongly agree”; (E) You project with a 95% confidence level that your Access to Capital will continue to drive these competitive edge benefits at a similar or higher benefit to the firm’s profit margin and/or growth rate for the next 12 months or longer.

Filter #5: Additionally, to score a ‘6’: Some of your Access to Capital relationships must be capable of providing emergency funds when needed. So if a major client pays late or a macro-economic emergency arises - like the COVID crises or the World Trade Center Attack, you know you may weather a rough ride because if Cash Flow is stifled, working capital is available to keep the organization running even if you lose 50% of gross revenue for up to 24 months.

Access to Capital and/or Investors (or Donors) score of 5 - SUMMARY: Your well above average Access to Capital sets you above average when compared against direct competitors, the majority of whom are struggling to get as much capital (% of organizational revenue) as you. Your Access to Capital not only creates a safety net for the business, with operating capital available if and when a surprise economic downturn puts your organization in the red. THE CRITERIA: you must satisfy all the Filters seen below:

Filter #1: Your Access to Capital satisfies all requirements for an Access to Capital Score of ‘4’ below

Filter #2: Your Access to Capital satisfies all the following: (A) You are 80% confident you may access capital and, if you are frugal, get the capital up to 80% of the capital your projections show you need to optimize growth; (B) You are 95% confident your access to capital is significantly better than most competitors. No more than 30% of competitors have better access to capital than you and no less than 70% have worse access to capital than you. (If you’re a startup with few direct competitors in the marketplace, your direct competitors in this instance are defined as those with whom you’re competing to get capital; (C) Your analysis has determined that both you and the other party(ies) providing the capital are approaching this relationship with a win/win mindset. You not only value the relationship, but predict that on a Likert Scale, when asked to score the statement ‘you trust the other party’, you predict at a 95% confidence level that both you and your investors would say “agree” or “strongly agree”; (D) You also predict with a 95% confidence level that on a Likert Scale, when asked to score the statement ‘you want the other party to succeed’, both you and your investors would say “agree” or “strongly agree”; (E) You project with a 90% confidence level that your Access to Capital will continue to drive these competitive edge benefits at a similar or higher benefit to the firm’s profit margin and/or growth rate for the next 12 months or longer.

Filter #3 Your Access to Capital satisfies at least one of the following: (A) Your Access to Capital is utilized by your organization and enables the organization to increase one or more of your other Gemstones to the level of a ‘5’ (ie, your capital does nothing until you use it to improve your resources. This capital might be improving your Equipment, Team, Real Estate, Brand Equity or IP. Additionally, these relationships could be opening doors to Sales Channel Partners, Suppliers, and potential Team members. Additionally, simply the existence of such a strong relationship with capital may increase your Brand Equity. VC firms, for instance, have very strong Brand Equity. Their cost of building Awareness is extremely low and their Affinity with those who know of them is extremely high. This is due primarily because of their access to Capital. Take away that Access to Capital and their Brand Equity score would drop very significantly.); (B) Your Access to Capital enables your organization to increase 2 or more Gemstones to the level of a ‘4’.

Access to Capital and/or Investors (or Donors) Score of 4 - SUMMARY: You are getting funding from investors, but to optimize growth you need more and are not sure you may get it. It could be Friends & Family, an Angel Investor, or a small venture fund (a single major donor for non-profit). You have a personal relationship and you’ve received some great funding. You’re getting better than average access to capital - many competitors have less, but there are also many with better access. Your relationships are helping fund and advise your success, but as your needs grow they’re becoming unable to give you as much capital or the terms you really need.

Filter #1 (and only): This Access to Capital relationships also meet all the following criteria: (A) You have received some funding from sources that are not traditional banks; (B) You relationships are critical for directly and/or indirectly enabling your access to capital (when figured proportionately against your revenue and/or profit) to be better the lowest 33% of your direct competitors are managing, but not as good as your best 33% of competitors are managing (you’re in the middle 3rd - if there’s a bell curve, you’re near the middle of it); (C) Your Access to Capital is utilized by your organization and enables the organization to increase one or more of your other Gemstones to the level of a ‘4’; (D) You project with a 90% confidence level that your Access to Capital will continue to drive these competitive edge benefits at a similar or higher benefit to the firm’s profit margin and/or growth rate for the next 12 months or longer.

Access to Capital and/or Investors (or Donors) Score of 3 - SUMMARY: Strong Banking relationship Same basic Loans as everybody else, but a special relationship helps you get faster action and better advisement than average. (If non-profit, you have donors who are also operating as strong and helpful advisors) - Have a bank and get the same basic loans as everybody else, but you have a strong relationship advising you and helping you get faster, perhaps even somewhat better access to loans and/or grants. Many businesses haven’t built the same relationships you have, but they certainly could. NOTE: If you have received more funding from investors than you have from banks, and you meet the other criteria required, you should review the scores of ‘4’, ‘5’, and up. CRITERIA: you must satisfy all the Filters seen below:

Filter #1: Your Access to Capital Relationships satisfy all following criteria: (A) Your business is mature enough and large enough to qualify for traditional commercial bank loans, SBA loans, and/or business lines of credit; (B) You work with at least 2 banks. It could be only a checking account at the 2nd bank, but you work with at least 2. (Having credit cards with a 2nd bank does not qualify); (C) At each of those banks you work with, you know at least one commercial banker, which is defined by satisfying all of the following: (1) You know each other by name; (2) You feel comfortable calling your banker with a question about banking; (3) You have been out to coffee, for a drink, or for lunch with them at least once; (4) Your bankers not only execute your requests and answer questions, but they teach you about banking and strategies you may employ to access better funding next year; (5) You also predict with a 95% confidence level that on a Likert Scale, when asked to score the statement ‘you want the other party to succeed’, both you and your banker would say “strongly agree”; (6) You regularly experience priority service from your bank. Your organization gets faster than average underwriting, tech support, cheaper wire transfer fees, and better than average advising some that accelerate your ability to access capital thru the bank’s programs; (D) Your access to Capital with at least one of the two banks you work with is better than average when compared against your direct competitors; (E) You project with a 95% confidence level that your Access to Capital will continue to drive these competitive edge benefits at a similar or higher benefit to the firm’s profit margin and/or growth rate for the next 12 months or longer.

Access to Capital and/or Investors (or Donors) Score of 2 - SUMMARY: You’re Getting traditional banking loans, but there’s no special relationship - getting same stuff they give everybody else - you wait in same line as everybody else (if Non-profit, at this level you have enough donors to keep the organization out of crisis mode - you likely need much much more, but are not in survival mode) - You’re receiving some capital, but you’re not a priority, you’re able to get standard commercial loans, SBA loans and others that any competitor of your size may typically get access to by walking into a branch and applying. EXAMPLES INCLUDE: A services company that has received a line of credit, a manufacturer that applied for and received a traditional commercial loan, a small bootstrapping tech company that received an SBA loan. CRITERIA: you must satisfy all the Filters seen below:

Filter #1 - Your Access to Capital Relationships satisfy all the following criteria: (A) Your business is mature enough and large enough to qualify for traditional commercial bank loans, SBA loans, and/or business lines of credit; (B) You have received business capital from a bank and/or have a line of credit available; (C) To your knowledge, you do not regularly receive special or above average experience. The experience you get is the same experience any other organization of your size and in your industry would receive; (D) You have received no investment from ‘Friends and Family’ over the amount of $250k; (E) You have received no ‘Friends and Family’ investments, nor from any other investor that would enable you to satisfy the requirements of an Access to Capital Score of ‘4’; (F) You project with a 95% confidence level that your Access to Capital will continue to drive these competitive edge benefits at a similar or higher benefit to the firm’s profit margin and/or growth rate for the next 12 months or longer.

Access to Capital and/or Investors (or Donors) Score of 1 - SUMMARY: Credit cards, limited friends & family, Factoring Receivables etc ; they're unable to advise you and offer limited capital, often with high interest, bad terms, or strings attached. CRITERIA: You satisfy all of the following criteria: (A) You have not received a commercial loan, SBA loan, or line of credit from a bank; (B) You are receiving no capital from investors; (C) There is no further family and friends funding available; (D) You would score your confidence at being able to secure investor funding within the next 24 months at less than 10%. NOTE: You may have received capital from a credit card or by factoring your receivables (or from a loan shark!). But because the terms on all these options are considered poor, you remain at a score of ‘1’ if that is all you have access to.

GemStone #6 – Team. Evaluating your team may be tough to do objectively. We all tend to believe in our own Team. We know them well. They’re “On OUR Team” by definition. HINT: When evaluating your team, ask yourself the question – is your top competitor also proud of their team? Or are they jealous of yours? Questions to consider: (1) Is your team particularly strong in a way that is especially beneficial to your company? (2) Particularly capable people who are better than our competitors’ people in at least one of the following ways: Cheaper, Faster, Higher Quality? (3) Is your Team significantly more agile, creative, or innovative than your competitors’? (4) How would your top competitors rate the quality of your team? (5) How would your top competitors rate the quality of their own team? To start this gemstone analysis, briefly write down the defining characteristics of your Team: (1) What makes your team VALUABLE? (2) What makes them unique or UNMATCHABLE (what is your team doing that your competitors’ teams can’t do?). Look at these characteristics of your Team and run them thru the VUE filter. Add an extra question to the filter this time – “How Consistently does your Team perform in such a way that is Valuable, Unmatchable, and Extensively Leverageable?” Is your team truly Valuable, Unmatchable, and Extensively Leverageable? And if so, do they do it all with remarkable consistency? What is it that your Team may do that the competition’s Team Can’t?? Are you able to write a brief Synopsis of your Team?

TEAM GEMSTONE SCORING: Team Score of 7 - SUMMARY: Your Team is directly responsible for driving profit margin and/or revenue growth rate of the organization at such a high level, no competitor may match it. CRITERIA: you must satisfy all the Filters seen below:

Filter #1: You must satisfy all of the criteria below: (A) Your team is driving exponential growth of the organization with profit margin 50% higher and/or growth rate 50% faster than any direct competitors may match; (B) creating or accessing a new market with no competitors where the business may grow either their gross revenue by 100% or more each year and/or valuation by 3X or more each year (and if valuation growth is the metric, the organization’s access to capital is strong enough to convert that increased valuation into cash on hand for sufficient working capital required to meet projected expenses for maintaining that growth next year; (C) Maintaining the organization’s dominance in a market that creates a profit that is positive, is above average against its direct competitors and where the organization is more than twice the size of its largest direct competitor and where it’s marketshare is not shrinking and the market itself is also not shrinking for any reason; (D) You have a 95% confidence level that your Team will continue to drive a combination of profit margins and/or growth rates better than any other competitor may manage for at least the next 12 months.

Team Score of 6 - SUMMARY: Your Team is directly or indirectly driving Profit Margins and/or Revenue Growth Rates that are in the top decile when scored against direct competitors (top 10%), while both profit margin and revenue growth rates are above average against the same, and where both profit margin and revenue growth rates are projected at a 95% confidence level of remaining at this level of competitive edge or higher.

Team Score of 5 - SUMMARY: Directly or indirectly drives your profit margin and/or revenue growth rate into the top 33% of direct competitors while both profit margin and revenue growth rate remain above average. You have a 95% confidence level of remaining at this level for at least the next 12 months.

Team Score of 4 - SUMMARY: Your Team Directly or indirectly drives your profit margin and/or revenue growth rate near average against your direct competitors (higher than the lowest 33% of performers but below the top 33% of performers). If either of those metrics is below average, this is the highest score you may attain.

Team Score of 3 - SUMMARY: At least One of the following is true: (A) This GemStone provides moderate value to the organization but is not key to driving any above average financial performance; (B) This GemStone is projected to have potential to help drive above average financial performance, but other GemStone(s) must be improved before that value may be realized; (C) You project with a 95% confidence level that your Team will continue to drive these competitive edge benefits at a similar or higher benefit to the firm’s profit margin and/or growth rate for the next 12 months or longer.

Team Score of 2 - SUMMARY: Your Team generates minimal value for the organization but also generates very few problems. You project with a 95% confidence level that your Access to Capital will continue to drive these competitive edge benefits at a similar or higher benefit to the firm’s profit margin and/or growth rate for the next 12 months or longer.

Team Score of 1 - SUMMARY: Your Team is actually reducing financial performance - typically by increasing costs, failing to maintain revenue, or causing purposeful and/or accidental harm to one or more of your other GemStones.

GemStone #7 – Sales Channel Relationships. THIS IS NOT A SALES PROCESS - This Gemstone scores the quality of your Relationships - NOT the process you use to get relationships and/or sales. Having a high Sales Channel Relationships score means you have unique relationships driving significant value for your company which your Competitors can’t duplicate. This is any relationship that does any of the following: *places qualified leads into the ‘Yes, I’m interested’ stage of your sales funnel *Moves a qualified lead down your sales funnel to a point at which you may predict their conversion rate, and the projected revenue after discounting that revenue for said conversion rate is predicted to be profitable *Creates a conversion and/or sale for your organization. Keep in mind, if your past clients send you a referral or new customer, that past client has become a Sales Channel Relationship. Also, if you have Returning or repeat Clients/Customers, then your relationship with Customers themselves is a Sales Channel Relationship. Saas companies have more stable and predictable Access to Capital because their technology maintains a relationship with clients/customers and tends to have a not only predictable but very high rate of return revenue each month. A large well known fast food chain (at both the corporate and franchise level) would be able to predict with high reliability the rate of return from past clients, allowing the organization to make investments in other resources at a faster rate. Contrast this with a very popular 12 month old restaurant. HINT: While we might first think of Sales Channel Access as a means of getting new leads and new clients, repeat business is also an example of a Relationship creating Sales Channel Access. For instance, most SaaS companies actually utilize the Sales Channel Access GemStone as their primary Competitive Edge. Their subscription model leverages current relationships with clients/customers to drive future sales. Freemium services are designed to do the same thing. Or, if you own a convenience food location and your drive up workers get to know customers by name, that increase in loyalty and sales is another great example of a Relationship creating Sales Channel Access. To analyze this GemStone, start by making a list of any relationships you (or your company) have that place qualified leads into your sales process (right into the middle of your sales funnel) including: Existing Clients and Customers; Distributors and other Sales Channel Partners; Referral Partners; Market Influencers. Then abbreviate the list to include only Sales Channel Access relationships valuable to you that your competitors can’t access or can’t leverage. Take each relationship thru the VUE filter, determining if you are able to leverage your Sales Channel Relationships in a way your competitors can’t leverage theirs? Write a brief synopsis of your most Valuable, Unmatchable, and Extensively Leverageable sales channel access relationships – be sure to include ‘why’ they’re valuable.

Sales Channel Relationships of 7 - SUMMARY: Your Sales Channel Relationships are Directly or indirectly driving exponential growth of the organization, an exponential increase in profit margin, and/or ability to dominate a market - and doing one of the above in a way in which no competitor may match: (A) driving exponential growth of the organization with profit margin 50% higher and/or growth rate 50% faster than any direct competitors may match; (B) creating or accessing a new market with no competitors where the business may grow either their gross revenue by 100% or more each year and/or valuation by 3X or more each year (and if valuation growth is the metric, the organizations access to capital is strong enough to convert that increased valuation into cash on hand for sufficient working capital required to meet projected expenses for maintaining that growth next year; (C) maintaining the organization’s dominance in a market that creates profit for the organization and where the organization is more than twice the size of its largest direct competitor and where its marketshare is not shrinking and the market itself is also not shrinking for any reason>; so that You have a 95% confidence level both Profit and growth rate will remain at these levels as a result of the Sales Channel for the next 12 months.

Sales Channel Score of 6 - SUMMARY: Your Sales Channel Relationships are Directly or indirectly driving Profits and/or growth rates that in the top decile when scored against direct competitors (top 10%), while both Profit and Growth Rates are above average, and where you have a 95% confidence level both Profit and growth rate will remain at these levels as a result of the Sales Channel for the next 12 months.

Sales Channel Score of 5 - SUMMARY: Directly or indirectly drives your profit and/or growth rate into the top 33% of direct competitors while both profit and growth rate remain above average, and where you have a 95% confidence level both Profit and growth rate will remain at these levels as a result of the Sales Channel for the next 12 months.

Sales Channel Score of 4 - SUMMARY: Directly or indirectly drives your profit margin and/or growth rate near average against your direct competitors (higher than the lowest 33% of performers but below the top 33% of performers ). If either of those metrics is below average, this is the highest score you may attain. Also, for businesses with recurring revenue, if you are profitable and your clients/customers pay on a recurring business model, you automatically achieve a Sales Channel Score of 4.

Sales Channel Score of 3 - SUMMARY: <This Gemstone provides moderate value to the organization but is not key to driving any above average financial performance> and/or <this gemstone is projected to have potential to help drive above average financial performance, but other Gemstone(s) must be improved before that value may be realized>

Sales Channel Score of 2 - SUMMARY: This Gemstone is not a source of value for the organization but also generates very minimal problems.

Sales Channel score of 1 - SUMMARY: Your Sales Channel Relationships are actually reducing financial performance - typically by increasing costs, wasting the time of some person(s) in your company, or failing to generate revenue at a level necessary to cover the costs of acquiring your sales channels.

GemStone #8 – Suppliers, including Distributors, manufacturers, strategic partners, raw and manufactured goods. HINT: Do you have any suppliers that *most competitors can’t get access to? *Have been curated to be particularly valuable or efficient to you? *Go the extra mile in a way that’s particularly valuable and just for you? *Have special modifications to their product, service, or delivery method? * allow you to white-label their products? Is there a supplier who is emotionally or financially invested in your success? For instance, a software Suppliers might trust you as a great Beta tester – willing to give them feedback, so you get extra support and/or early access to new products. DON’T FORGET TEAM MEMBER SUPPLIERS: Do you have a supplier or any special access to acquire new team members? Perhaps a great recruiter? An intern partnership with a University? An alumni network (or other network) that gives you preferential access to talent? In evaluating this Gemstone, determine whether you have any unique supplier relationships that give your company a competitive advantage? Make a list of any supplier relationships you (or your company) have that enable you to do one or more of the following in a way your competitors can’t: *Increase your Speed *Improve your Quality *Reduce your costs. Abbreviate the list to include only Supplier relationships valuable to you that your competitors can’t access or can’t leverage and take each relationship thru the VUE filter. Are you able to leverage your Suppliers to do things your competitors can’t do with theirs? Write a brief synopsis of your most Valuable, Unmatchable, and Extensively Leverageable Supplier relationships – be sure to include ‘why’ they’re valuable, then work thru the scoring system below to identify your score:

Supplier Relationships Score of 7 - SUMMARY: Directly or indirectly driving exponential growth of the organization, an exponential increase in profit margin, and/or ability to dominate a market - and doing one of the above in a way in which no competitor may match: (A) driving exponential growth of the organization with profit margin 50% higher and/or growth rate 50% faster than any direct competitors may match; (B) creating or accessing a new market with no competitors where the business may grow either their gross revenue by 100% or more each year and/or valuation by 3X or more each year (and if valuation growth is the metric, the organization’s access to capital is strong enough to convert that increased valuation into cash on hand for sufficient working capital required to meet projected expenses for maintaining that growth next year.); (C) Maintaining the organization’s dominance in a market that creates profit for the organization and where the organization is more than twice the size of its largest direct competitor and where it’s marketshare is not shrinking and the market itself is also not shrinking for any reason>.

Supplier Relationships Score of 6 - SUMMARY: Your Supplier Relationships Are Directly or indirectly driving Profits and/or growth rates that in the top decile when scored against direct competitors (top 10%), while both Profit and Growth Rates are above average, and where both Profit and growth rate are projected to remain at those levels for the next 12 months with a 95% confidence level.

Supplier Relationships Score of 5 - SUMMARY: Your Supplier Relationships are Directly or indirectly driving your profit and/or growth rate into the top 33% of direct competitors while both profit and growth rate remain above average.

Supplier Relationships Score of 4 - SUMMARY: Your Supplier Relationships are Directly or indirectly drives your profit margin and/or growth rate near average against your direct competitors (higher than the lowest 33% of performers but below the top 33% of performers ). If either of those metrics is below average, this is the highest score you may attain.

Supplier Relationships Score of 3 - SUMMARY: <Your Supplier Relationships provide moderate value to the organization but is not key to driving any above average financial performance> and/or <this gemstone is projected to have potential to help drive above average financial performance, but other Gemstone(s) must be improved before that value may be realized>.

Supplier Relationships Score of 2 - SUMMARY: Your Supplier Relationships are not a source of value for the organization but also generates very minimal problems.

Supplier Relationships Score of 1 - SUMMARY: Your Supplier Relationships are actually reducing financial performance or creating risk or creating risk - typically by increasing costs, costing you more time than they should, or failing to deliver materials and/or resources at the speed, quality, and price needed for your revenue generation.

Gemstone #9: Community Relationships, HINT: Strong scores here tend to drive high value to the brand and big impact to the community and to Stakeholder engagement, especially Team Members and Customers. Before writing a synopsis of your Community, it’s helpful to define your Community by putting on paper, which communities does your organization interact with, care about, and rely upon. For any Communities that hit all 3 above, you should consider including them in your definition of Community. Also, any Communities you ‘rely upon’ should be considered as lack of relationship could negatively impact other GemStones. To flesh out your brainstorming, your community could include any (or all) of the below: The neighborhood around any location/facility; Local or regional politicians; Trade associations of yours; Trade associations of your customers’; Networking and/or advocacy organizations; Families, friends and neighbors of any Stakeholders (Shareholders, Customers, Team Members, Suppliers). Starting analysis of this Gemstone involves writing a brief Synopsis of your Company’s Community and how you impact each other, then work thru the scoring system below to identify your score.

Community Impact Score of 7 - CRITERIA: Your Community Impact and resulting community relationships are responsible for raising the scores of one or more other Gemstones to the level of ‘7’.

Community Impact Score of 6 - CRITERIA: Your Community Impact and resulting community relationships satisfy at least one of the following: (A) Responsible for raising the score of at least one other Gemstone to a score of ‘6’, (B) Responsible for raising at least 2 other Gemstones to a score of ‘5 or higher’; (C) Responsible for raising at least 4 other Gemstones to a score of ‘4 or higher’.

Community Impact Score of 5 - CRITERIA: Your Community Impact and resulting community relationships satisfy at least one of the following: (A) Responsible for raising the score of at least one other Gemstone to a score of ‘5’; (B) Responsible for raising at least 2 other Gemstones to a score of ‘4 or higher’.

Community Impact Score of 4 - CRITERIA: Your Community Impact and resulting community relationships satisfy at least one of the following: (A) Responsible for raising the score of at least one other Gemstone to a score of ‘4’; (B) Responsible for raising at least 4 other Gemstones to a score of ‘3’; (C) Responsible for raising at least 1 other Gemstone from a score of ‘1’ to a score of ‘2 or higher’.

Community Impact Score of 3 - CRITERIA: Your Community Impact and resulting community relationships satisfy at least one of the following: Responsible for raising at least 2 other Gemstones from a score of ‘2’ to a score of ‘3’.

Community Impact Score of 2 - CRITERIA: All the following are true: (A) You have some activities generating Impact for the community (B)you give and/or volunteer to create Community Impact largely because you’re asked – there is no Leadership Plan, nor strategic direction - which is defined as a plan for determining which Community Impact activities you will and won’t based on how those activities will improve (or not improve) the scores and grades of your other GemStones. (C) There are no scorecards used to measure how any one activity will or won’t improve the Company and/or any of the Company’s gemStones. (D) To reach a Score of ‘2’, you must be doing more than providing jobs for the team and/or products for the customers. (ie - sponsoring your kids’ pta or soccer team, giving to a cause because someone asked, or because you got invited to an event.)

Community Impact Score of 1 - CRITERIA: All the following are true: (A) The Company currently participates in no activities specifically designed to drive Community Impact. (B) You may create impact which consists primarily in creating jobs for your Team Members and creating great products/services for your customers. ( C) there are no activities in which the company purposefully participates with the intent of creating a positive impact on any communities outside those two stakeholders.PROCESSES, HINT: Your Processes are critical for maintaining both the Value and the Leverageability of your TEAM. Weak processes require more time and effort from your TEAM - and may reduce morale over the long-haul.

GemStone #10 – Production Processes. HINT: We know of one company whose owner thought the business was worth $7M, but the investment banker they worked with was able to increase that valuation and sell the company for $22M – all because the business had 5 years earlier made a commitment to go paperless, and the changes put in place to enable paperless created massive efficiencies. If any of your processes are patented (or patentable), they should be moved to the ‘Intellectual Property’ category. Processes are easy to copy. But if you are consistently known to be implementing improvement processes faster than the other guys, you will over time build strength in your other GemStones as well (especially Brand Equity). Start this GemStone analysis with listing any particularly valuable processes you might have created or be able to manage that your competitors aren’t able to emulate, especially processes that allow you to do one or more of the following: Improve production either Faster, Better, or Cheaper; Improve the work environment to reduce turnover and making onboarding easier and more effective; Creating a more environmentally friendly process by Lower carbon emission fees (in some states/countries), making Happier workers (in some cases), creating Marketing or PR opportunity; creating a process that drives innovation and makes your company more agile than competitors when facing hurdles the future may bring; or any other process that in any way improves the company. Take each of these processes through the VUE filter, jotting down a brief synopsis of the process (or combination of processes) that create your sharpest competitive edge, then work through the scoring steps below to identify your score.

Production Processes Score of 7 - SUMMARY: Your Production Processes are Directly or indirectly driving exponential growth of the organization, an exponential increase in profit margin, and/or ability to dominate a market - and doing one of the above in a way in which no competitor may match, wherein driving exponential growth of the organization with profit margin 50% higher and/or growth rate 50% faster than any direct competitors may match; creating or accessing a new market with no competitors where the business may grow either their gross revenue by 100% or more each year and/or valuation by 3X or more each year (and if valuation growth is the metric, the organizations access to capital is strong enough to convert that increased valuation into cash on hand for sufficient working capital required to meet projected expenses for maintaining that growth next year; maintaining the organization’s dominance in a market that creates profit for the organization and where the organization is more than twice the size of its largest direct competitor and where its marketshare is not shrinking and the market itself is also not shrinking for any reason.

Production Processes Score of 6 - SUMMARY: Production Processes are Directly or indirectly driving Profit Margins and/or revenue growth rates in the top decile when scored against direct competitors (top 10%), while both Profit Margins and revenue Growth Rates are above average.

Production Processes Score of 5 - SUMMARY: Production Processes are Directly or indirectly driving your profit and/or growth rate into the top 33% of direct competitors while both profit and growth rate remain above average.

Production Processes Score of 4 - SUMMARY: Production Processes are Directly or indirectly driving your profit margin and/or growth rate near average against your direct competitors (higher than the lowest 33% of performers but below the top 33% of performers). If either of those metrics is below average, this is the highest score you may attain.

Production Processes Score of 3 - SUMMARY: <Production Processes provide moderate value to the organization but is not key to driving any above average financial performance> and/or <Production Processes appear to have potential to help drive above average financial performance, but other Gemstone(s) must be improved before that value may be realized>

Production Processes Score of 2 - SUMMARY: Production Processes are not a source of value for the organization but also generate very minimal problems.

Production Processes Score of 1 - SUMMARY: Production Processes are either <are generating no direct or indirect impact on profit and/or growth at all> or <are actually reducing financial performance or creating risk or creating risk - typically by increasing costs or failing to maintain revenue>.

GemStone #11 – Customer Service, HINT: Ask yourself - Is there anything about your customer service that makes the customer experience dramatically better than your competitors may provide? If your top competitors were aware of the true scope and quality of your Customer Service Processes and Capabilities, how envious would they be? Start this GemStone analysis by listing any particularly valuable Customer Service Processes that you, your team, your customers, or your community might find particularly rave-worthy. Take each of these Customer Service Processes thru the VUE filter, jotting down a brief synopsis of the processes you (or your company) have that truly give you an Edge in Customer Service to score the entire Process - NOT just results (ie, your customers’ satisfaction ratings).

Customer Service Processes Score of 7 - SUMMARY: Your Customer Service Processes are driving upselling, referrals, or are in some other way directly or indirectly driving exponential growth of the organization, an exponential increase in profit margin, and/or ability to dominate a market - and doing one of the above in a way in which no competitor may match, driving exponential growth of the organization with profit margin 50% higher and/or growth rate 50% faster than any direct competitors may match, creating or accessing a new market with no competitors where the business may grow either their gross revenue by 100% or more each year and/or valuation by 3X or more each year (and if valuation growth is the metric, the organizations access to capital is strong enough to convert that increased valuation into cash on hand for sufficient working capital required to meet projected expenses for maintaining that growth next year, maintaining the organization’s dominance in a market that creates profit for the organization and where the organization is more than twice the size of its largest direct competitor and where it’s marketshare is not shrinking and the market itself is also not shrinking for any reason.

Customer Service Processes Score of 6 - SUMMARY: Your Customer Service Processes are driving upselling, referrals, or are in some other way directly or indirectly driving Profits and/or growth rates that in the top decile when scored against direct competitors (top 10%), while both Profit and Growth Rates are above average, and where both Profit and growth rate are projected to remain at those levels for the next 12 months with a 95% confidence level.

Customer Service Processes Score of 5 - SUMMARY: Your Customer Service Processes are driving upselling, referrals, or are in some other way directly or indirectly driving your profit and/or growth rate into the top 33% of direct competitors while both profit and growth rate remain above average.

Customer Service Processes Score of 4 - SUMMARY: Your Customer Service Processes are driving upselling, referrals, or are in some other way directly or indirectly driving your profit margin and/or growth rate near average against your direct competitors (higher than the lowest 33% of performers but below the top 33% of performers ). If either of those metrics is below average, this is the highest score you may attain.

Customer Service Processes Score of 3 - SUMMARY: Your Customer Service Processes either <provide moderate value to the organization but are not key to driving any above average financial performance> and/or <are projected to have potential to help drive above average financial performance, but other Gemstone(s) must be improved before that value may be realized>.

Customer Service Processes Score of 2 - SUMMARY: Your Customer Service Processes are not a source of value for the organization but also generates very minimal problems - (ie, all sales are final, or complaints never occur for some reason, etc…)

Customer Service Processes Score of 1 - SUMMARY: Your Customer Service Processes are either <are generating no direct or indirect impact on profit and/or growth at all> or <are actually reducing financial performance or creating risk - typically by increasing costs or failing to maintain revenue>

CATEGORY #12 – Sales & Marketing, NOTE: it’s common for your Sales Channel Relationships and Sales and Marketing Processes to work together, but they are separate things. A process you use to build Sales Channel Relationships would be scored here. If you have a process you use to get value out of your relationships, list it here. Once you have the relationships, the relationships themselves would be scored in the ‘Sales Channel Relationships GemStone’. So, if you’re a Private Wealth Advisor and you have a process for building relationships with NFL Quarterbacks, that process would be listed here. The Quarterbacks you already know would be listed under ‘Sales Channel Relationships’. Do you have sales processes in place that make you particularly strong at any (or all) of the following aspects of sales (if yes, please write them down): *Prospecting – finding qualified leads and/or potential customers/clients *Outreach – making initial contact with these leads *Credibility – crafting trust and/or credibility with these leads *Interest – Making these leads interested in seriously considering your products/services *Signing – Is there anything in your process that ‘greases the skids’ when it comes to the final stages of conversion and contract signing *Anything else particularly valuable about your sales process? For example, do you have any particularly strong marketing processes: *Planning and executing trade shows? *Utilizing digital marketing? *Leveraging social media? *Benefiting from print, radio, or other traditional media? *Driving word of mouth referrals? *Are you able to leverage some new technology or strategy to reach your target market that your competitors haven’t been able to emulate? Take each of these Sales and Marketing Processes thru the VUE filter, jotting down a brief synopsis of your greatest strength in this area, something that truly gives you an Edge over your competition. Thinking through your sales and marketing processes vs. those of your top competitors, do yours consistently outpace theirs, allowing you to capture marketshare while increasing margin faster than others are capable of? IF YES, BE SURE TO INCLUDE THAT IN THE SYNOPSIS.

Sales and Marketing Processes Score of 7 - SUMMARY: Your Sales and Marketing Processes are directly or indirectly driving exponential growth of the organization, an exponential increase in profit margin, and/or ability to dominate a market - and doing one of the above in a way in which no competitor may match, driving exponential growth of the organization with profit margin 50% higher and/or growth rate 50% faster than any direct competitors may match, creating or accessing a new market with no competitors where the business may grow either their gross revenue by 100% or more each year and/or valuation by 3X or more each year (and if valuation growth is the metric, the organizations access to capital is strong enough to convert that increased valuation into cash on hand for sufficient working capital required to meet projected expenses for maintaining that growth next year, maintaining the organization’s dominance in a market that creates profit for the organization and where the organization is more than twice the size of its largest direct competitor and where it’s marketshare is not shrinking and the market itself is also not shrinking for any reason.

Sales and Marketing Processes Score of 6 - SUMMARY: Your Sales and Marketing Processes are directly or indirectly driving average Profit margin and/or revenue growth rates that in the top decile when scored against direct competitors (top 10%), while both Profit and Growth Rates are above average, and where both Profit and growth rate are projected to remain at those levels for the next 12 months with a 95% confidence level.

Sales and Marketing Processes Score of 5 - SUMMARY: Your Sales and Marketing Processes are directly or indirectly driving your profit and/or growth rate into the top 33% of direct competitors while both profit and growth rate remain above average.

Sales and Marketing Processes Score of 4 - SUMMARY: Your Sales and Marketing Processes are directly or indirectly driving your profit margin and/or growth rate near average against your direct competitors (higher than the lowest 33% of performers but below the top 33% of performers). If either of those metrics is below average, this is the highest score you may attain.

Sales and Marketing Processes Score of 3 - SUMMARY: Your Sales and Marketing Processes are <This Gemstone provides moderate value to the organization but is not key to driving any above average financial performance> and/or <this gemstone is projected to have potential to help drive above average financial performance, but other Gemstone(s) must be improved before that value may be realized>.

Sales and Marketing Processes Score of 2 - SUMMARY: Your Sales and Marketing Processes are not a source of value for the organization but also generates very minimal problems.

Sales and Marketing Processes Score of 1 - SUMMARY: Your Sales and Marketing Processes either <are generating no direct or indirect impact on profit and/or growth at all> or <are actually reducing financial performance or creating risk and or causing risk - typically by failing to maintain revenue, causing operational strain, or costly complaints of some type>.

GemStone #13 - Innovation Processes, HINT: Your Innovation Processes include all the things you do to continue improving, including but not limited to: R&D; Training; Hiring Creative Talent; Creating Freedom to Innovate and New initiative and/or products/services goal setting.

Innovation Processes Score of 7 - SUMMARY: Innovation Processes are directly or indirectly driving exponential growth of the organization, an exponential increase in profit margin, and/or ability to dominate a market - and doing one of the above in a way in which no competitor may match, driving exponential growth of the organization with profit margin 50% higher and/or growth rate 50% faster than any direct competitors may match, creating or accessing a new market with no competitors where the business may grow either their gross revenue by 100% or more each year and/or valuation by 3X or more each year (and if valuation growth is the metric, the organizations access to capital is strong enough to convert that increased valuation into cash on hand for sufficient working capital required to meet projected expenses for maintaining that growth next year, maintaining the organization’s dominance in a market that creates profit for the organization and where the organization is more than twice the size of its largest direct competitor and where its marketshare is not shrinking and the market itself is also not shrinking for any reason>.

Innovation Processes Score of 6 - SUMMARY: Innovation Processes are directly or indirectly driving Profits and/or growth rates that in the top decile when scored against direct competitors (top 10%), while both Profit and Growth Rates are above average, and where both Profit and growth rate are projected to remain at those levels for the next 12 months with a 95% confidence level.

Innovation Processes Score of 5 - SUMMARY: Innovation Processes are directly or indirectly driving your profit and/or growth rate into the top 33% of direct competitors while both profit and growth rate remain above average.

Innovation Processes Score of 4 - SUMMARY: Innovation Processes are directly or indirectly driving your profit margin and/or growth rate near average against your direct competitors (higher than the lowest 33% of performers but below the top 33% of performers ). If either of those metrics is below average, this is the highest score you may attain.

Innovation Processes Score of 3 - SUMMARY: Innovation Processes provide moderate value to the organization but is not key to driving any above average financial performance> and/or <this gemstone is projected to have potential to help drive above average financial performance, but other Gemstone(s) must be improved before that value may be realized>.

Innovation Processes Score of 2 - SUMMARY: Innovation Processes are not a source of value for the organization but also generates very minimal problems - or may be altogether non-existent.

Innovation Processes Score of 1 - SUMMARY: Innovation Processes either <are generating no direct or indirect impact on profit and/or growth at all> or <are actually reducing financial performance - typically by increasing costs or failing to maintain revenue>.

GemStone #14 – Vision/Leadership, HINT: Your Vision/Leadership processes the following aspects: *Clarity of Vision; *Is the company’s Vision clearly written down on paper; *Is it Clearly Communicated to the team; *Is it simple enough that Team Members remember and are able to repeat it? *Aligning Leadership’s actions to the Vision; *Do you have a process in place for ensuring leadership’s decisions and actions are always aligned with the Vision? *Do the actions leadership takes create increase the Team’s feelings of personal ownership of the Vision? *Do you have a feedback loop in place to make sure Team Members believe in and feel ownership of the vision? *Do your feedback loops have a method of alerting Leadership when and if they accidentally make a decision that does NOT align with the Vision? Managing conflict is also a key step in aligning Everybody’s actions to the Vision: *Does leadership have a process for managing conflict and using it to create better understanding and camaraderie among the Team? *Is the process working? *What is the Cadence of Communication? *Do you have a process in place to continually re-instill the Vision among Team Members at every level of the organization? *Is Leadership disciplined in keeping up with the cadence?

Using these aspects, write the briefest possible synopsis of your Vision. HINT: The Scoring rules below include mention of your ‘Stakeholder Groups’ - remember, your Stakeholder Groups include: Shareholders, Customers, Team Members, Suppliers, and Community.

Vision/Leadership Process Score of 7 - SUMMARY: Your vision and leadership processes are not only vibrant, engaging, and inspiring, they are directly or indirectly responsible for raising the score of 2 or more other Gemstones’ scores to a ‘7’. Typically at this level you’ll find all Stakeholders not only know and find the Vision compelling, it's perceived as so unique your organization is the only source they have available to fulfill that Vision! - it’s perceived as uniquely valuable, unmatchable, and extensively leverageable - the Vision compels stakeholders to TAKE ACTION! And you are collecting quantifiable data, typically confirming all the below is happening: (A) Satisfies all of ‘6’ below; (B) Multiple groups of stakeholders (ie. customers, team members, and community members) are telling others about it, building your brand with their passion; (C) The vision drives considerable value for all Stakeholders; (D) Stakeholders feel ownership in the company’s success; (E) Stakeholders not only feel ownership, but are taking action to help the company meet its goals; (D) Stakeholders are not only extremely engaged, but are successfully recruiting other Stakeholders to the organization. Additionally, You are still collecting, monitoring, and responding to measurable data confirming all the above. NOTE: Your Vision/Leadership Processes exist to strengthen the value of your other GemStones. These processes cannot in and of themselves directly generate profit and/or growth. Additionally, your Vision/Leadership Process exists to clarify your company’s Vision, strategy, goals, etc, along with creating clear processes to insure it’s implemented regularly. So the scoring system is a little different. Your Vision/Leadership Process is responsible for raising the scores of at least 2 other Gemstones to a level of ‘7’.

Vision/Leadership Process Score of 6 - CRITERIA: Your Vision/Leadership Processes satisfy at least one of the following: (A) Responsible for raising the score of at least one other Gemstone to a score of ‘7’; (B) Responsible for raising at least 2 other Gemstones to a score of ‘6’.

Vision/Leadership Process Score of 5 - CRITERIA: Your Vision/Leadership Process satisfy at least one of the following: (A) Responsible for raising the score of at least one other Gemstone to a score of ‘6’; (B) Responsible for raising at least 2 other Gemstones to a score of ‘5’.

Vision/Leadership Process Score of 4 - CRITERIA: Your Vision/Leadership Process satisfy at least one of the following: (A); Responsible for raising the score of at least one other Gemstone to a score of ‘5’; (B) Responsible for raising at least 2 other Gemstones to a score of ‘4’.

Vision/Leadership Process Score of 3 - CRITERIA: Your Vision/Leadership Process satisfy at least one of the following: (A) Responsible for raising the score of at least one other Gemstone to a score of ‘4’; (B) Responsible for raising at least 2 other Gemstones to a score of ‘3’.

Vision/Leadership Process Score of 2 - (must pass two filters) CRITERIA:

Filter #1: Your Vision/Leadership Process (or lack thereof) is not causing any problems for the organization.

Filter #2: Your Vision/Leadership Process satisfies at least one of the following: (A) While you might have the Vision clear in your mind, if you do not have the Vision for your company written clearly on paper, you are a ‘2’; (B) If you have the Vision written on paper but did not communicate it to your Team over the past 6 months, your score is a ‘2’.

Vision/Leadership Process Score of 1 - Your Vision/Leadership Process (or lack thereof is causing one or more of the following: (A) Is reducing the score of 1 or more of your other Gemstones to a score of ‘1’; (B) Is reducing any other Gemstone by a net negative score (NOTE: if your Vision/Leadership Process is generating value for some Gemstones and reducing the score for others, that value is weighted against how high that score is. For example, moving a Gemstone from 6 to 7 generates much more value for the organization than moving a Gemstone from 2 to 3. Conversation, moving from 3 to 2 causes less harm than moving a gemstone from 7 to 6. The only exception is moving a Gemstone from 2 to a 1 (where that Gemstone actually begins to reduce profitability - so with the exception of Gemstones moving from a ‘2’ to a ‘1’ - all others are weighted by the score from which they are moving. Moving a Gemstone from a ‘7’ to a ‘6’ is a -7 points. Moving a Gemstone from a ‘6’ to a ‘5’ is a ‘-6’ points, etc… So if your Vision/Leadership Process is reducing one Gemstone from a 6 to a 5 but is raising 3 others from a 4 to a 5, this is a net positive change, etc… - additionally, if the reduction of a gemstone indirectly reduces several others, you must account for their scores as well - for instance, a Vision/Leadership process that damages the brand could reduce the scores for several Gemstones at once). Common problems include: *High Turnover among employees - or low motivation - or confusion as to goals/activities to pursue *Unsatisfactory customer service *Brand (reputation) damage *Damaged Core Values, etc…

GemStone #15 – REGULATIONS. NOTE: This is the only GemStone that may have a ‘negative’ score. HINT: Are there any regulations and/or public policy initiatives that tend to favor your company over competitors? Are there any regulations in place that create barriers to entry in your market (thereby limiting the competitive pool)? Are there any Special government funding or grants available which give you an edge over competitors (or which reduce the number of competitors)? In considering this GemStone, identify any regulations and/or policies (at Local, State, Federal, or some other level) that impact your business (positive or negative). Evaluate how jealous would other CEOs be if they understood the true scope of the regulations and/or policies benefiting your business? Lastly, adjust these synopsis so it is as brief as possible.

Regulations Score of 7 - SUMMARY: Policy Makers drive your profits by actively protecting and promoting your business’s interests. You have a strong public affairs team and legislators are keenly interested in protecting your company and industry. Multiple policies have been created and/or altered in order to benefit your business. CRITERIA: Your Regulations satisfies all the following:

Filter #1: Your organization satisfies both the following: (A) With a very small investment on your part, equaling less than 1% of your company’s net profits, Politicians, bureaucrats and/or others who create and guide public policy seek your advice and/or input before crafting policy; (B) Once created, these policies improve your profit margin and/or decrease the profit margin of some direct or indirect competitors at least 75% of the time.

Filter #2: You are unaware of any policy makers actively campaigning to undermine your company and/or your industry and/or any of your key profit centers - you also have a confidence rating of at least 95% that the other Criteria will remain in place for the next 60 months or more.

Filter #3: Your Public Policies Gemstone satisfies one or more of the following: (A) Public Policies exist which create a profitable monopoly for your business; (B) Public Policies exist which limit competition to less than 10 direct competitors and your marketshare among those 10 direct competitors is profitable and you have a 95% confidence that marketshare will remain in place for the next 60 months or more.

Regulations Score of 6 - SUMMARY: Strong influence on policy, but you work continually to maintain it. You have a strong public affairs team with strong influence, but you have to continue investing effort and money to keep legislators interested in benefiting your business. You are successful at keeping policy tilted in your favor. CRITERIA: Satisfies all the filters below:

Filter #1: You satisfy both the following: (A) Whether funded by your organization or by you personally on behalf of your organization, you spend an amount equal to or greater than 1% of your organization’s net profit in order to maintain influence among public policy makers and enforcers who may and do impact your business; (B) Once created, these policies improve your profit margin and/or decrease the profit margin of some direct or indirect competitors at least 75% of the time.

Filter #2: You satisfy both the following: (A) You are unaware of any policy makers actively campaigning to undermine your company and/or your industry and/or any of your key profit centers - you also have a confidence rating of at least 95% that the other Criteria will remain in place for the next 12 months or more; (B) Public Policies exist which limit some direct or indirect competitors and you have a 95% confidence your marketshare which is enabled by these policies will remain yours for the next 12 months or more.

Regulations Score of 5 - SUMMARY: A policy massively benefits your business and limits competition. There is a policy in place that massively benefits your business, but you have little control over the creation of, or changes to, that policy. The policy tends to reduce competition. CRITERIA: You satisfy at least one of the following:

Filter #1: You satisfy all the following: (A) There is a policy in place which has enabled your organization to grow your profits and/or revenue growth and/or access to operating capital by 100% or more over the past 36 months; (B) Some direct and/or indirect competitors have been unable to take advantage of this policy - thereby limiting your competition and making your efforts at gaining marketshare more effective than those competitors; (C) Your profits have remained at or above average when compared against your direct competitors over the past 36 months

Filter #2: You satisfy all the following: (A) Regardless of when the trend began, there is a public policy in place which has directly enabled 25% or more of your organization’s profit; (B) Some direct and/or indirect competitors are unable to compete effectively with you in this policy protected space.

Regulations Score of 4 - SUMMARY: Policy strongly benefits your industry, and while most direct competitors may or could access the same, this policy still strongly benefits your organization. There is a policy in place that strongly benefits your industry, but your average direct competitor would be able to do (or is doing) the same. CRITERIA: You satisfy the following: (A) There is a public policy in place which has directly enabled 10% or more of your organization’s profit and/or equity growth; (B) Your analysis indicates this policy is largely benefiting your industry and limiting indirect competitors; (C) You have an 80% or higher confidence rating the 10% profit enabled by this policy will remain in place over at least the next 12 months (because of the policy limiting indirect and/or direct competition).

Regulations Score of 3 - SUMMARY: Existing policy creates a slight but steady tailwind. There is a policy in place that has created a slight, but steady tailwind for your business and few competitors are able or willing to jump through the hoops to acquire the benefits, giving you a slight edge. CRITERIA: You satisfy all the following: (A) There is a public policy in place which has directly enabled 5% or more of your organization’s profit and/or increased one or more of your Gemstone scores to the score of ‘4’; (B) This was not a one time policy benefit (ie, receiving an SBA loan), but is a policy that benefits your organization in an ongoing manner, projected to increase profits and/or growth over the course of 36 months or more; (C) You have an 80% or higher confidence rating the benefits enabled for your organization by this policy will remain in place over the next 12 months (typically because of the policy limiting indirect and/or direct competition)

Regulations Score of 2 - SUMMARY: You’re ‘In the Know!’ As new policies come out, you consistently tend to be “In the Know” and may take advantage of them before most competitors. CRITERIA: You satisfy all the following: (A) There is a public policy, or several, in place which you have accessed which directly enabled 5% or more of your organization’s profit and/or directly enabled you to increase your organizations equity by 20%; (B) At least twice over the past 60 months, you have been able to take advantage of a policy in the first quartile of all direct competitors, meaning you received the benefit faster than 66% of your direct competitors, if they received the benefit at all; (C) You have an 80% or higher confidence rating the 5% profit enabled by this policy will remain in place over the next 12 months (typically because of the policy limiting indirect and/or direct competition).

Regulations Score of 1 - SUMMARY: Policies help, but on average, most direct competitors have access to the same and are receiving the same benefit as rapidly as you. There are policies in place that would benefit your business but you tend to learn about them late, if ever. Some competitors also tend not to take advantage of them. CRITERIA: (A) Public policies tend to help more than harm your business’s growth and/or profit margin, but on average, most competitors are able to receive the same benefits at the same speed as you; (B) at least 33% of your direct competitors receive access to these benefits more slowly than you (or not at all), but you are not a top performer - 33% or more of your direct competitors are either receiving more of these benefits than you or are receiving them before you; (C) This slight advantage over your average competitors generates no clear advantage in your ability to gain marketshare and/or grow the size of your market.

Regulations Score of 0 - SUMMARY: Unaware of any policies either benefiting or harming your business - You don’t know if there are or are not policies that could benefit you or your competitors’ businesses. CRITERIA: You are unaware of any policies either benefiting or harming your business.

Regulations Score of ‘-1’ - SUMMARY: Competitors get there before you. Policies are in place, which you do receive, but your competitors more often than not are taking advantage of them faster than you’re able to. CRITERIA: satisfy all the below: (A) Public policies tend to harm more than help your business’s growth and/or profit margin, because on average, most competitors are able to receive the same benefits as you but are able to access them before you are able to access them. Or you are failing to access some benefits which your average direct competition is able to receive; (B) at least 33% of your direct competitors receive access to these benefits faster than you; (C) These policies generate no clear disadvantage for your ability to generate profit and/or growth and/or to capture marketshare and/or grow your market.

Regulations Score of ‘-2’ - SUMMARY: Competitors are accessing Policies which you could access, but you are failing to do so. CRITERIA: you satisfy all the following: (A) Your direct competitors are gaining access to policies which increase their profits and/or growth and/or equity in a way you’re unable to emulate; (B) You also qualify for these same benefits; (C) You are failing to take advantage of these policies.

Regulations Score of ‘-3’ - SUMMARY: Policy creates a slight but steady headwind for your business but not for some competitors. There is a policy in place that has created a slight, but steady headwind for your business and while your direct competitors have the same headwind, many indirect competitors do not. CRITERIA: satisfies all of the following: (A) There is a policy in place that is benefiting some of your direct or indirect competitors but not you, (B) You are unable to take advantage of these policies, (C) More than 1 of your direct and/or indirect competitors are accessing at least 5% more profit and/or at least 10% faster growth than you are able because of the policies.

Regulations Score of ‘-4’ - SUMMARY: Policy massively benefits your competitors, but you’re unable to take advantage of it. There is a policy in place that massively benefits some of your competitors, and you are unable to take advantage of it. CRITERIA: (A) There is a policy in place that is benefiting some of your direct or indirect competitors but not you; (B) You are unable to take advantage of these policies; (C) More than 1 of your direct and/or indirect competitors are accessing at least 10% more profit and/or at least 50% faster growth than you are able because of these policies.

Regulations Score of ‘-5’ - SUMMARY: Direct Competitors with stronger public affairs teams continually outmaneuver you. A direct competitor(s) has a strong public affairs team with strong influence that you seem unable to duplicate, but those competitors have to continue investing effort and money to keep legislators interested in benefiting their business, so you may have a chance of changing future policies, if you improve your influence. CRITERIA: (A) There is a policy in place that is benefiting some of your direct or indirect competitors but not you; (B) You are unable to take advantage of these policies; (C) More than 1 of your direct and/or indirect competitors are accessing at least 10% more profit and/or at least 50% faster growth than you are able because of these policies; (D) Your Direct Competitors are investing 50% more cash into initiatives designed to influence public policy to their advantage and your disadvantage.

Regulations Score of ‘-6’ - SUMMARY: Legislators actively protecting and promoting your competitor(s), but not you - Your competitors have strong public affairs teams and legislators are keenly interested in protecting their company over your own. Most policies are crafted to benefit their business, which makes it increasingly difficult for you to compete. CRITERIA: (A) There is a policy in place that is responsible for reducing your profitability, growth rate, and/or equity; (B) You have direct or indirect competitors who are benefiting from your disadvantage. As you lose profit/growth/equity, they are gaining some or all of the above; (C) You project a less than 25% chance of getting these policies changed anytime over the next 12 months.

Regulations Score of ‘-7’ - SUMMARY: Policies are being put in place with the goal of destroying your company and/or industry. CRITERIA: all the following: (A) <A policy is now in place that makes a portion of your current business operation illegal and that portion is responsible for 75% or more of your organization’s profit> OR <a policy exists which routes 75% or more of your revenue away from you and toward your direct or indirect competitors>; (B) You project that you will be unable to change this policy at any point over the next 60 months (NOTE: It is allowable that this policy may not be affecting you yet. It could be a new policy that has not yet been enforced, or that is being enforced slowly - or that your direct/indirect competitors have not yet figured out how to utilize, but you project they will do so within the next 36 months).

CATEGORY #16 – CORE VALUES. Think of Values like ‘Priorities’. When you have to make tough decisions, how do you choose your priorities? And part of choosing your Core Values is not only choosing what to prioritize, but what to deprioritize. If a company Values both ‘Rapid Response’ and ‘Work/Life Balance’, which is the employee supposed to prioritize when they receive an email or a text from a client at 7pm Saturday evening? The best Core Values also clarify how to subordinate the Values when they come into conflict. Strong Core Values guide everyone in the organization in choosing the organization’s Relationships - Strong Core Values will tend to decrease your options but increase your affinity: *Who should invest *Shareholders *Board members *Team Members *Suppliers *Customers *Community. Core Values make it clear: WHO the organization should be working with (who is a good fit or not); HOW they should behave (setting clear expectations); WHY the organization cares (clarify the core philosophy of the organization). Here are some data points to consider before Scoring your Core Values against those of your direct Competitors’: Do your Core Values help Stakeholders make decisions and resolve conflict? Are Team Members able to articulate when the Core Values are more important than profit? Do stakeholders know the organization’s Core Values - are they able to repeat them, or at least paraphrase them from memory? Do Team Members refer to the organization’s core values when making decisions? Are Team Members able to identify tough decisions the company has had to make and describe how that decision demonstrates the Core Values? Do Team Members believe in the Core Values, or do they ‘roll their eyes’ when they hear Leadership tout them? Are Team Members able to describe decisions they’ve seen the company make that go against the stated Core Values? Are you able to articulate how the Core Values align with company growth goals - do Values help drive the long-term P&L and Balance Sheet? Do you have examples where the Values were prioritized OVER the PNL? Are your Core Values incorporated into your target marketing - do they guide how your Organization chooses customers? Are your Core Values referred to when choosing vendors? Or Suppliers? Or Distributors? Or Consultants?

Core Values Score of 7 - CRITERIA: Your Core Values are responsible for raising the scores of one or more other Gemstones to the level of ‘7’.

Core Values Score of 6 - CRITERIA: Your Core Values satisfy at least one of the following: (A) Responsible for raising the score of at least one other Gemstone to a score of ‘6’, (B) Responsible for raising at least 2 other Gemstones to a score of ‘5 or higher’; (C) Responsible for raising at least 4 other Gemstones to a score of ‘4 or higher’.

Core Values Score of 5 - CRITERIA: Your Core Values satisfy at least one of the following: (A) Responsible for raising the score of at least one other Gemstone to a score of ‘5’; (B) Responsible for raising at least 2 other Gemstones to a score of ‘4 or higher’.

Core Values Score of 4 - CRITERIA: Your Core Values satisfy at least one of the following: (A) Responsible for raising the score of at least one other Gemstone to a score of ‘4’; (B) Responsible for raising at least 4 other Gemstones to a score of ‘3’; (C) Responsible for raising at least 1 other Gemstone from a score of ‘1’ to a score of ‘2 or higher’.

Core Values Score of 3 - CRITERIA: Your Core Values satisfy at least one of the following: Responsible for raising at least 2 other Gemstones from a score of ‘2’ to a score of ‘3’.

Core Values Score of 2 - CRITERIA: You must satisfy all of the following: (A) Your Core Values (or lack thereof) are not causing any problems for the organization; at least one of the following: (1) While you might have the Core Values clear in your mind, if you do not have the Core Values for your company written clearly on paper, you are a ‘2’; or (2) If you have the Core Values written on paper but your Team Members do not know how to review them without asking where they are or how to access them, your score is a ‘2’.

Core Values Score of 1 - CRITERIA: Your Core Values (or lack thereof) are causing one or more of the following: (A) Are reducing the score of 1 or more of your other Gemstones to a score of ‘1’; (B) Are reducing any other Gemstone by a net negative score (NOTE: if your Core Values are generating value for some Gemstones and reducing the score for others, that value is weighted against how high that score is. For example, moving a Gemstone from 6 to 7 generates much more value for the organization than moving a Gemstone from 2 to 3. Conversely, moving from 3 to 2 causes less harm than moving a gemstone from 7 to 6. The only exception is moving a Gemstone from 2 to a 1 (where that Gemstone actually begins to reduce profitability - so with the exception of Gemstones moving from a ‘2’ to a ‘1’ - all others are weighted by the score from which they are moving. Moving a Gemstone from a ‘7’ to a ‘6’ is a -7 points. Moving a Gemstone from a ‘6’ to a ‘5’ is a ‘-6’ points, etc… So if your Vision/Leadership Process is reducing one Gemstone from a 6 to a 5 but is raising 3 others from a 4 to a 5, this is a net positive change, etc… - additionally, if the reduction of a gemstone indirectly reduces several others, you must account for their scores as well - for instance, a Vision/Leadership process that damages the brand could reduce the scores for several Gemstones at once). Common problems caused by weak Core Values include: *High Turnover among employees - or low motivation - or confusion as to goals/activities to pursue *Brand (reputation) damage *Unresolvable conflicts (ie, sales and operations lack a common set of Core Values) *Compensation packages that do not match the Core Values, etc…

After completing one’s first pass thru the scoring rules above, review the scores for grading the scores. Examples of the grading of scores in this GemStone embodiment are described below for a subset of the GemStones initially evaluated in the foregoing description.

The Scores are competitive. Gemstones are scored in relation to the competition. How much are these Gemstones contributing to your competitive edge, enabling you to get more growth and/or profit than your competitors.

The Grades are internal grades of the organization’s current level of planning and execution. GemStones are graded based on how well the organization is organized to both improve and exploit the GemStone, and the organizational resources it represents. Note that for the purposes of differentiation, in the VisionCraft embodiment, GemStone scores are rated numerically, on a 1 to 7 scale. Whereas the Grading system GemStone Grades are graded alphabetically, like school grades, with F being the lowest, then up to D, to C, to B, to A, to AA, and to AAA, with AAA being the highest and F being the lowest.

### GRADING EXAMPLE GemStone #3 – Brand Equity

AAA - You not only collect quantifiable data from all stakeholder groups to measure how much passion (affinity) they have for your brand, you are able to use that data to constantly improve your brand equity. CRITERIA: All requirements for a grade of ‘AA’ below are satisfied. You have quantifiable data confirming how strong the affinity Brand among all your Stakeholder Groups. This data is being used to improve your plan to build brand awareness. You have quantifiable data confirming these improvements are working to accelerate brand awareness. You have quantifiable data on affinity various stakeholders have for your brand. You have quantifiable data allowing you to know what % of customers are evangelizing for you (same for team members, suppliers, and other stakeholder groups). You have data that allows you to calculate the premium you’re able to charge as a result of your brand equity. You see evidence for the accuracy of the above quantifiable data reflected in the sales data.

AA. Your Brand has a plan for appealing to ALL stakeholder groups, including any Communities who’s opinions and/or actions are important to maintaining your plan, not only for building your brand equity, but also for growing profit margins and revenue growth. Additionally, you have multiple types of quantifiable metrics in place to monitor your Brand Equity among each Stakeholder Group. CRITERIA: All requirements for a grade of ‘A’ below are satisfied. You have quantifiable data confirming how much of each target market for your various stakeholder groups have awareness for your Brand. This data is being used to improve your plan to build brand awareness. You have quantifiable data confirming these improvements are working to accelerate brand awareness. You have quantifiable data allowing you to know what % of customers are evangelizing for you (same for team members, suppliers, and other stakeholder groups). You have data that allows you to calculate the premium you’re able to charge as a result of your brand equity. You see evidence for the accuracy of the above quantifiable data reflected in the sales data.

A. There is a clear plan for investing in building your Brand Equity that includes a predictable ROI. (Pre-profit Startups that lack necessary capital to remain in business must also be focused on building Brand Equity with investors at this level). The brand plan also incorporates methods for increasing Brand Equity among most Stakeholder Groups (Shareholders, potential investors, customers, team members, suppliers). CRITERIA: All the following are true: (A) All requirements for a grade of ‘B’ (below) are satisfied; (B) You not only have a plan, you know what activities are required to build AFFINITY and AWARENESS for the brand within clear AUDIENCE(s) profiles (target markets); (C) You have a clear budget in terms of time and/or capital utilized to run the plan for building Brand Equity; (D) You have measurable KPIs to hold designated individual(s) accountable for maintaining activities required to maintain and grow brand equity; (E) You have a predictable ROI, so you know what the return on investment will be for the time and/or money your organization is investing into Brand Equity; (F) Your plan includes building brand equity not only among customers and team members, but also among shareholders, potential investors, and suppliers.

B - Brand actively managed with a clear plan in writing AND that Brand Equity management is NOT reliant on any specific individuals). CRITERIA: You satisfy all the following: (A) You satisfy all the requirements of a grade of ‘C’ below; (B) Your organization is not reliant on any specific individual(s) to continue to maintain the plan (ie, if as many as the top 3 individual(s) responsible for spearheading your Brand Equity plan were hit by a bus and gone tomorrow, the organization could still be back on track with its current plan for building and maintaining Brand Equity within 60 days).

C - Brand actively managed, and there is a clear plan in writing for maintaining and improving your Brand Equity. CRITERIA: All the following are true:
(A) On a Likert Scale, when presented with the statement ‘Our brand is causing significant hurdles for the organization’ you would answer ‘Strongly Disagree’, ‘Disagree’ or ‘Neither agree nor disagree’;
(B) You have a clear plan in writing that includes the following:
   (1) Who are your AUDIENCES - at a minimum, clearly articulating your ideal customers, clients, and team members (and for startups, investors),
   (2) Who are they demographically and psychographically,
   (3) What problem(s) do they have that your organization may solve and/or what preference(s) do they have that you may satisfy,
   (4) How does your brand gain AWARENESS in each Audience above, which includes knowing how to accomplish the following at a level necessary to meet your organizations profit margin and revenue growth goals:
      (a) getting a sufficient portion of this Audience’s attention;
      (b) creating a sufficiently valuable first impression;
      (c) remaining in the memory afterward of a sufficient portion of that Audience for a sufficient amount of time;
      (d) Why will each Audience have an AFFINITY for your brand,
      (e) What makes your first impression memorable?
      (f)What expectations are you trying to create in each Audience’s mind when they receive that first impression?
      (g) How does your Brand create the proper first impression?
      (h) What mistakes could be made in any of the above and how may the organization avoid them?
      (i) The person or Team in your organization responsible for managing the brand knows how to access for review and/or to share the written plan with others - and are you able to accomplish it within 5 mins after entering the organization’s filing system;
      (j) On a Likert Scale, when presented with the statement ‘We know who on the team is responsible for the brand and that person or persons are doing a great job managing our brand equity’ you would answer ‘Strongly Agree’ or ‘Agree’;
      (k) When presented with: ‘I believe the Brand Affinity is creating a net positive value (meaning that even though the brand might be the source of some hurdles, it is also the source of some value generation, and that value generated has greater value than any problems created are causing harm) you would answer ‘Strongly Agree’ or ‘Agree’.

D - Brand is unmanaged, but seems to be working, or at least not known to be causing any problem, Affinity is most likely good - Awareness is acceptable - Audience might be unclear. CRITERIA: All of the following are true: (A) All the criteria for a ‘Brand Equity’ rating of ‘F’ (below) are false; (B) On a Likert Scale, when presented with the statement ‘Our brand is not causing any significant hurdles for the organization’ you would answer ‘Strongly Agree’ or ‘Agree’ or ‘Neither agree nor disagree’; (C) You would answer ‘Strongly disagree’ or ‘Disagree’ or ‘neither agree nor disagree’ to the following statement: “There is no documentation in writing describing how the brand works.”. NOTE: to improve your score, a good plan should include clarity on: *Who are your AUDIENCES - at a minimum, clearly articulating your ideal customers, clients, and team members (and for startups, investors) *Who are they demographically and psychographically *What problem(s) do they have that your organization may solve and/or what preference(s) do they have that you may satisfy? *How does your brand gain AWARENESS in each Audience above, which includes knowing how to accomplish the following at a level necessary to meet your organizations profit margin and revenue growth goals: --getting a sufficient portion of this Audience’s attention --creating a sufficiently valuable first impression --remaining in the memory afterward of a sufficient portion of that Audience for a sufficient amount of time. Why will each Audience have an AFFINITY for your brand? What makes your first impression memorable? What expectations are you trying to create in each Audience’s mind when they receive that first impression? How does your Brand create the proper first impression? What mistakes could be made in any of the above and how may the organization avoid them?

F - Brand Equity is a problem. (At Least One of the following is true): (A) On a Likert Scale, when presented with the statement ‘Your Brand Equity is suffering from Brand Debt - meaning your Brand is creating hurdles which must be overcome by the sales and marketing team and/or the talent recruiting team’ - you would answer ‘Strongly Agree’ or ‘Agree’; (B) When presented with the following statements, you would answer ‘Strongly Agree’ or ‘Agree’ for both: “Our business is considered too small and/or too inexperienced by 50% or more of our ideal Target Market” and “We are failing to meet reasonable sales goals and/or failing to meet reasonable employee recruiting goals”; (C) When presented with the following statements you would answer ‘Strongly Agree’ or ‘Agree’ for both: “We believe our business is considered too small and/or too lacking in reputation to attract the talent (employees and/or subcontractors) we need” and “We are failing to meet reasonable recruiting goals for our employees and/or subcontractors”; (D) When presented with the following statements you would answer ‘Strongly disagree’ or ‘Disagree’ to both: “We know our ideal target market (for customers) well enough to describe who they are, the problem(s) we solve for them, and how we solve the problem(s)” and “We are bringing in enough revenue to at least meet our minimum viable revenue goals” (NOTE: Minimum viable growth goal is the revenue you need to maintain your company without downsizing personnel - if you are a pre-profit startup, the minimum viable growth goal is the minimum viable growth you must maintain in order to continue operating the business for at least the next 6 months).

### GRADING EXAMPLE GemStone #8 – Suppliers

AAA - Not only are all the below criteria satisfied, but you have exclusivity with one or more key suppliers. CRITERIA: Satisfies all criteria of a grade of ‘AA’ below, and: (A) You have exclusivity with a key supplier; (B) On a Likert Scale, to the statement ‘This exclusivity is enabling you and your supplier to work together to increase each other’s profit margin, market share, and/or revenue growth.’ you would respond ‘Strongly Agree’ or ‘Agree’.

AA - Cooperative Trust and Profitability, plus a clear plan for innovating and improving together. CRITERIA: Satisfies all criteria of a grade of ‘A’ below, and on a Likert Scale, the statement ‘We have a clear plan, which we have discussed and which is implemented to enable us to share knowledge and/or resources in order to drive cooperative innovation and improvements together.’

A - Cooperative Trust and Profitability are the result of some stellar supplier relationships - and they have reached a level most competitors are unable to access. CRITERIA: All the following are true: (A) On a Likert Scale, the statement ‘all our suppliers provide at least satisfactory quality, service, price and speed.’ you would respond ‘Strongly agree’ or ‘Agree’; (B) On a Likert Scale, the statement ‘We receive a level of service from some key suppliers which we consider above and beyond. They regularly impress us with the quality, service, price and/or speed which they offer’ you would answer ‘Strongly agree’ or ‘Agree’; (C) In reference to these key suppliers who are considered as going above and beyond on a Likert Scale, the statement ‘We have a high level of trust in all these suppliers to continue serving as at the same level of satisfaction as now or better’ you would respond ‘Strongly agree’ or ‘Agree’; (D) On a Likert Scale, the statement ‘These suppliers value their relationship with us and trust us at a high level.’ you would respond ‘Strongly agree’ or ‘Agree’; (E) On a Likert Scale, the statement ‘These suppliers engage in conversations and take actions demonstrating they care about our profitability’ you would respond ‘Strongly agree’ or ‘Agree’; (F) On a Likert Scale, the statement ‘By working together with these key suppliers, we are creating a mutually beneficial relationships that prioritizes profitability for both parties.’ you would respond ‘Strongly agree’ or ‘Agree’; (G) On a Likert Scale, the statement ‘Because of our supplier relationships, we receive better service than most of our competitors, and these relationships are of a type that the majority of our competitors would be unable to access similar relationships’ you would respond ‘Strongly agree’ or ‘Agree’.

B - You receive some above and beyond service. Strong Trust has formed. Your suppliers have your back and help drive profitability. CRITERIA: all the following are true: (A) On a Likert Scale, the statement ‘all our suppliers provide at least satisfactory quality, service, price and speed.’ you would respond ‘Strongly agree’ or ‘Agree’; (B) On a Likert Scale, the statement ‘We receive a level of service from some key suppliers which we consider above and beyond. They regularly impress us with the quality, service, price and/or speed which they offer’ you would answer ‘Strongly agree’ or ‘Agree’; (C) On a Likert Scale, the statement ‘We have a high level of trust in all our suppliers to continue serving as at the same level of satisfaction as now or better’ you would respond ‘Strongly agree’ or ‘Agree’; (D) On a Likert Scale, the statement ‘Our suppliers value their relationship with us and trust us at a high level.’ you would respond ‘Strongly agree’ or ‘Agree’; (E) On a Likert Scale, the statement ‘Our suppliers engage in conversations and take actions demonstrating they care about our profitability’ you would respond ‘Strongly agree’ or ‘Agree’; (F) On a Likert Scale, the statement ‘Because of our supplier relationships, we receive better service than most of our competitors. Those competitors likely could receive service of similar quality from their suppliers if they only knew how and were willing to invest effort in building such relationships.’ you would respond ‘Strongly agree’ or ‘Agree’.

C - Acceptable supplier(s) with a basic and satisfactory level of quality, service and support. CRITERIA: the following are all true:
(A) On a Likert Scale, the statement ‘While occasional mistakes may happen and occasional favors may be granted, our suppliers generally provide a basic and satisfactory level of support’, you would respond ‘Strongly agree’ or ‘Agree’;
(B) On a Likert Scale, the statement ‘We expect nothing special of our suppliers. We offer them nothing special. They also don’t offer us any special treatment.’ you would respond ‘Strongly agree’, ‘Agree’, or ‘Neither agree nor disagree’.

D - Your suppliers might be a problem, but your competitors are receiving similarly unsatisfactory service. CRITERIA: all the following are true: (A) On a Likert Scale, for the statement ‘All our key suppliers provide supplies and service at a level satisfactory enough to allow us to operate our business property’ you would state ‘Strongly disagree’ or ‘disagree’; (B) On a Likert Scale, for the statement ‘when considering these unsatisfactory supplier(s), some competitors are regularly receiving better supplies and/or service from them than we are’ you would answer ‘Strongly disagree’, ‘disagree’, or ‘neither agree nor disagree’.

F - Your suppliers might be a problem. At least one key supplier is providing unsatisfactory service, and many competitors are receiving better service than you. CRITERIA: all the following are true: (A) On a Likert Scale, for the statement ‘All our key suppliers provide supplies and service at a level satisfactory enough to allow us to operate our business property’ you would state ‘Strongly disagree’ or ‘disagree’; (B) On a Likert Scale, for the statement ‘when considering these unsatisfactory supplier(s), some competitors are regularly receiving better supplies and/or service from them than we are’ you would answer ‘Strongly agree’ or ‘Agree’.

### GRADING EXAMPLE GemStone #10 – Production Processes

AAA - You have best in class production processes. CRITERIA: All the following are true: (A) All criteria for a score of ‘AA’ below have been satisfied; (B) On a Likert Scale, for the following statement, ‘When considering price, speed, and quality, your production processes are above average on all 3 counts and for 1 of those 3, you are best in class. You are able to produce at a price, at a level of quality, or at a speed which no competitor may match’, you would answer ‘Strongly agree’.

AA - Strong processes are doing everything below + your processes are scalable, allowing you to grow rapidly without overwhelming operations + you have reached a level of production process which few competitors may match for price, efficiency, and quality. CRITERIA: All the following are true: (A) All criteria for a score of ‘A’ below have been satisfied; (B) On a Likert Scale, for the following statement, ‘Your production processes have allowed the leadership team to create and begin executing a plan to scale the organization’s production processes, and the output they create, at a rate that allows it to double output of your most popular product line(s) every 12 months for at least 36 months, assuming sales and marketing may drive the growth.’, you would answer ‘Strongly agree’ or ‘Agree’; (C) On a Likert Scale, for the following statement, ‘When it comes to speed, cost, and quality, our production processes are among the best in class. It would be difficult to prove any other competitors processes are better than ours’ you would answer ‘Strongly agree’ or ‘Agree’.

A - All the below + Processes are constantly improved + there’s also a clear process for integrating operational capacity with sales and marketing. CRITERIA: All the following are true: (A) All the criteria for a score of ‘B’ below have been satisfied; (B) Additionally, production processes have been documented for 95% or more of all daily tasks of production team; (C) KPIs and Scorecards, or a similar tool, are used to monitor effectiveness of at least 99% of the documented processes; (D) On a Likert Scale, for the statement, ‘There is a clear process in place to assess and improve all processes, based on monitoring results, with necessary improvements made within 24 hrs of identifying a process which needs improved’, you would answer ‘Strongly agree’ or ‘Agree’; (E) On a Likert Scale, for the statement ‘There is a process in place to monitor operational capacity and use it to throttle, accelerate, and/or alter sales and marketing processes as needed to ensure operating capacity is never exceeded in a way that would impact client expectations’, you would answer ‘Strongly agree’ or ‘Agree’; (F) On a Likert Scale, for the statement ‘There is a process in place to monitor the sales and marketing pipeline, and use it to keep Operations aware of upcoming capacity needed to ensure client expectations are met.’, you would answer ‘Strongly agree’ or ‘Agree’.

B - All the below + Processes are Monitored and Team is Trained - you also have measurable KPIs and there’s a process for using the KPIs and Scorecards to improve the efficiency, cost and quality of the processes - they’re creating the desired output and Quality Control is high. CRITERIA: All the following are true: (A) All the Criteria for a Grade of ‘C’ below are satisfied; (B) KPIs and Scorecards, or a similar tool, are used to monitor usage of all production processes; (C) KPIs and Scorecards, or a similar tool, are used to monitor effectiveness of at least 75% of the processes; (D) There is a clear process in place to assess and improve the processes at least every 90 days based on the results of these KPIs and Scorecards; (E) On a Likert Scale, for the statement ‘Clear rules and accountability is in place to increase team members’ compliance to use the processes as intended - also clear consequences for any non-compliance exist and are enforced regularly’ you would answer ‘Strongly agree’ or ‘Agree’.

C - Processes are documented and referred to regularly, but the processes do not have measurable KPIs and/or scorecards which may be used to monitor them for compliance. CRITERIA: All the following are true:
(A) On a Likert Scale, for the statement, ‘Our organization has most of the production processes necessary to doing our work documented in writing and/or video, and employees refer to them regularly’ you would answer ‘Strongly agree’ or ‘Agree’;
(B) On a Likert Scale, for the statement, ‘For the Team Members who produce your products and/or provide our services, when asked to retrieve the written and/or video documentation of the processes necessary to complete their job, 50% or more of them would be able to complete the task within 10 minutes without needing to ask anyone for help’, you would answer ‘Strongly agree’ or ‘Agree’;
(C) A review of all documented processes has occurred at least once in the last 6 months, to identify any processes which have not been documented, and to put a plan in place, which includes a deadline, to create and file that missing documentation;
(D) When new Team Members are hired and trained to work in production of your products and/or services, they are provided written and/or video documentation explaining how to do 75% or more of the daily tasks they will be asked to execute in their first 30 days or more.

D - Written and/or video documentation of at least some of your production processes exist, but are rarely or never referred to: While some processes are documented in writing, when training new employees, the documents are referred to rarely. New communicated via word of mouth, but nothing written down. Or perhaps your processes were written down once and stuck in a drawer, but there is no process for actually making sure they are used. CRITERIA: The organization does have at least some production processes documented in writing. At least one of the following is true: (A) When training a Team Member in the processes documentation of the processes is provided to the new Team Member only 9 out of 10 times (90% of the time) or less; (B) For the Team Members who produce your products and/or provide your services, when asked to retrieve the written and/or video documentation of the processes necessary to complete their job, less than 50% of them would be able to complete the task within 10 minutes without asking anyone else for help; (C) At least one of the following is NOT occurring: (1) A review of all documented processes has occurred at least once in the last 6 months, to identify any processes which have not been documented, and to put a plan in writing or in video documentation, which includes a deadline to create and file those missing documents; (2) When new Team Members are hired and trained to work in production of your products and/or services, they are provided written and/or video documentation explaining how to do 75% or more of the daily tasks they will be asked to execute in their first 30 days or more.

F - No consistent processes are documented in writing. CRITERIA: All the following are true: (A) When it comes to training new team members, your organization has no documented processes in place; (B) Any onboarding training and/or new product training is verbal, based on institutional knowledge. Training Requires an experienced Team Member showing a new Team Member how to do their job.

HOW THE GEMSTONE SCORING AND GRADING SYSTEMS INTERACT TO DRIVE INSIGHT: In this embodiment of VisionCraft, each Gemstone is rated in 2 ways: A Gemstone’s Score is a rating of the Gemstone’s performance in its external environment, against the Company’s competitors; AND A Gemstone’s Grade is a rating of the Gemstone in its internal environment, as a resource inside the organization, grading how strong the resource is in its internal supports. If a Gemstone’s Grade is high but its Score is low, this is an indication that the Resource is underperforming, most likely because it is either being mismanaged, or another Gemstone in the firm is too weak to properly support it. Either way, a Gemstone with a high grade and low score is being held back by the organization. EXAMPLE: A small coaching firm with two owners who are the firm’s only employees could have an extremely low ‘Production Processes’ score of ‘2’, because those processes might not yet be a source of value for the organization when there are only two owners and they both know how to do everything at an exemplary level. However, they could have spent the necessary time to build robust, constantly improved processes which allow them to make almost instant use of new and inexperienced Team Members when they make their first hire, and every subsequent hire as well. This would give them a Production Processes grade of ‘A’. ‘2A’ - a low score + high grade would indicate the score will rise rapidly as the organization grows in revenue and headcount. If a Gemstone’s Score is high but the Grade is low, this is a sign that as the organization continues to grow, this Gemstone’s resource category is likely to become strained. Without focused improvement, it will not be able to keep up over the long term. EXAMPLE: A small architecture firm with two equity partners, both co-founders of the firm, and two additional employees (four total) might have an extremely high Brand Equity score of ‘6’ (if their personal reputations are driving a lot of value in the competitive environment, allowing them to grow faster than competitors), but a very low Brand Equity Grade of ‘D’ (because there very well could be no active management of that Brand Equity). ‘6D’ - A high score + low grade indicates that as the firm grows, that lack of plan will make it very difficult for the firm to onboard team members, suppliers, and customers who understand how to build the brand. As a result, the Brand Equity is projected grows weaker each time the firm adds a new Team Member (or other stakeholder).

In this variation, after scoring and grading your GemStones, they are arranged in a hierarchy with the highest scores along the top and lowest scores along the bottom, etc… FIG. 5A shows an exemplary initial hierarchy in the examples given above. FIG. 5B is a depiction of the future state that will be created if Leadership (CEO) of the Company does not realocate resources and/or make new investements internally to improve the Grade of any one GemStone.

Additionally, each GemStone’s Score will have projections that are determined by that GemStone’s Grade. This projection projects the future score of that GemStone at a time 36 months from now, and this projection is dependent on Leadership doing no further interventions to change the trajectory of that GemStone’s Score. This is to help Leadership determine where the use investments to intervene in future trends for each GemStone. In some cases, Leadership might intervene with investments in order to increase a GemStone’s Score. In other cases Leadership might needs intervene with investments in order to maintain a GemStone’s Score, which means to keep that Score from naturally decreasing as the Company grows. And in other cases Leadership might choose to deprioritize investments in some GemStones if and when they’re determined to be on a sufficiently acceptable path for supporting the Company’s needs. FIG. 5A and FIG. 5B, demonstrate this. FIG. 5A includes a graphic set of GemStones both Scored and Graded in a Company’s present state. FIG. 5B is a graphic set of the same GemStones, for the same Company projecting that Company’s GemStone Scores and Grades 36 months in the future if no intervention is made to increase or decrease current investment levels in each GemStone. If a projection shows a GemStone Score will decrease based on that GemStone’s Grade, Leadership may let the Score decrease, or may choose to intervene with increased investment of time, money, and/or other resources available to the Company in order to not allow the Score to decrease, and a higher level of investment may even be used to cause that GemStone’s Score to actually increase over the next 36 months. If a GemStone’s Grade indicates the Score will increase over the next 3 years, Leadership may choose to deprioritize investment into this GemStone and yet still project that GemStone’s Score going up over those 36 months. If a GemStone’s Grade indicates that without intervention, the Score will remain the same, Leadership may decide if that Score is adequate to the Company’s needs, in which case Leadership may deprioritize investment into that GemStone. If Leadership determines that GemStone’s Score should be increased, Leadership will know they may choose to intervene and invest toward increasing both that GemStone’s Grade and Score.

Step #2 - “sanity check” – an optional step where one may question if these numbers look appropriate? Are your “6’s” truly more important to the organization’s competitive edge than your “5’s”, etc…? If you see a problem, or a score that doesn’t appear to be correct, then based on your knowledge as part of the leadership team you have 3 options: It doesn’t look right, but you can’t prove it’s wrong - ask the question, “Are you able to collect more data to verify my hunch (ie, an employee survey, competitive analysis, SWOT, etc…)? You know it’s wrong, one Gemstone wound up scored a “5” but you have data demonstrating it is more valuable to your organization’s strategy than some GemStone(s) which scored a “6”. If necessary, you may switch their scores. This is after all your organization’s strategy and your judgement matters in how it should be driven. You have no data but feel a need to change the number in order to match your strategy - you may do so. We recommend connecting with a mentor, coach, etc… to get some self-reflection before doing so.

Step #3 - Begin arranging the GemStones below in your Rocket (see FIG. 5C). Your highest scores goes at the top, Your lowest scores go at the bottom, and if you have too many equal scores to match the rocket shape (ie, you have 2 or more GemStones tied for highest score, or you have 3 GemStones tied for 2nd place, but only room for 2 GemStones in the rocket graph, then you must: Ask the question of yourself, “If your organization had to suffer a downgrade in the next 30 days of all but one of these Gemstones, which would you NOT downgrade?” Then do the same for each level down throughout your placement of GemStones into the Rocket (some levels might require you downgrade all GemStones but 2, or all but 3. The top level requires you downgrade all but 1.)

We recommend asking the question of several others on your leadership team. If you all agree which GemStones should and which shouldn’t be downgraded, consider the strategy solid and move forward. If your other leaders disagree which GemStones should and shouldn’t be downgraded to accommodate the Rocket’s hierarchy requirements, the CEO must choose between two options: Make the decision which GemStones are more and less important to the organization’s strategic focus - AND incorporate that decision into the Vision/Leadership Process. Be prepared to communicate your rationale, and inspire them with a Vision of the future this strategy will help you all create together (ie, a VC firm might downgrade the strategic importance of their ‘Access to Capital’ in order to prioritize their ‘Team’ as the most valuable resource available to their future growth - because it’s the Team that may both create the fantastic access to Capital AND drive an ROI with that Capital. And the CEO may cast a Vision of the future where the team continues to grow stronger over time, attracting even more Capital and getting even better at generating an ROI with that Capital, etc…) Allow everyone to vote and follow the strategy that wins the most votes. (This process might be required in the legal structure of a non-profit. Or if you’re a for profit CEO and your shareholders and/or board might need convincing before you move in a new strategic direction).

Step #4 - Your Vision/Leadership process should ideally, but not necessarily, wind up in the 8 ball position of your Rocket, directly below the Leading Edge Gemstone. If your Vision/Leadership GemStone’s scores are too low to qualify for that position in the graphic, it’s recommended you consider investing in improvements to your Vision/Leadership Process. Conversely, if your Vision/Leadership Process has the highest score of any GemStone, you may be creating an existential issue for your Vision/Leadership process. The job of the Vision/Leadership process is to better articulate how and why you’re driving your Leading Edge forward. If your Vision/Leadership process currently has the highest score of any GemStone, in order to make your Rocket work as a strategy tool, you must prioritize investing in at least one other resource GemStone, to increase it’s score up to be at least equal with your Vision/Leadership Score.

SPECIAL NOTE: Ideal Strategy requires the Vision/Leadership process not BE the Leading Edge of your Rocket. The role of your Vision/Leadership process is to communicate the Leading Edge to all stakeholders of the Company. If your Vision/Leadership process communicates the Vision/Leadership is the most important resource your company has to bring to bear in the market, It’s like saying “Our greatest strength is our ability to communicate that our greatest strength is our ability to communicate that our greatest strength is our ability to…” your strategy risks becoming circular, illogical, and nonsensical.

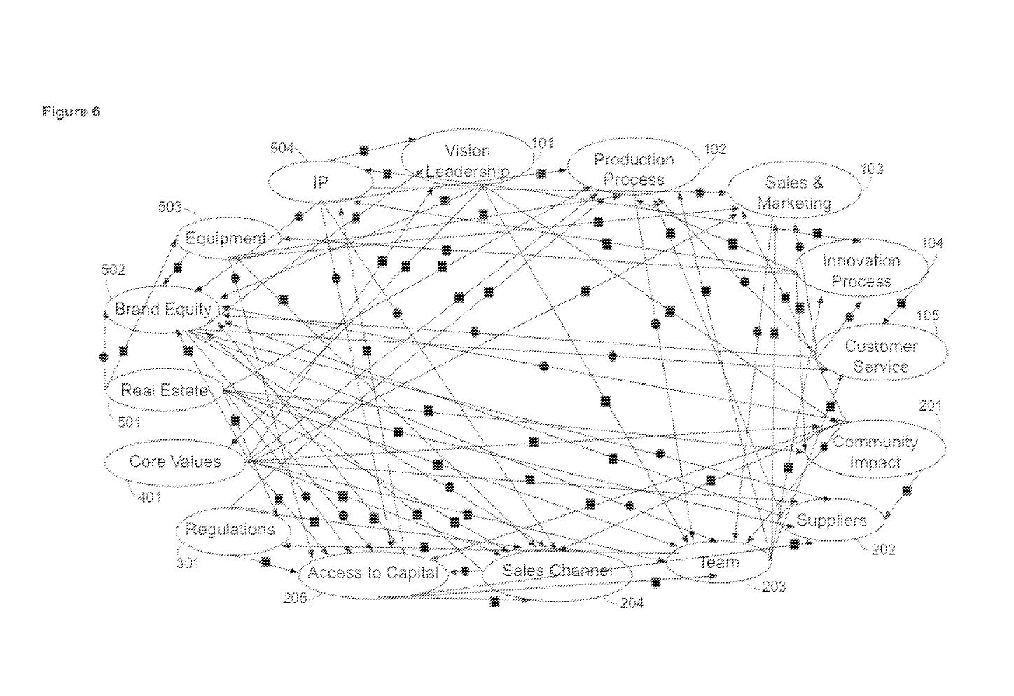

Step #5 - Once your ‘Rocket’ is built, your next step is to articulate forecasts and goals for each of your 16 GemStones. This is a step beyond the GemStone ‘Grades’, and helps to map the implications of the forecasts created by those Grades. First, Are any of the GemStone scores forecast to go up or down over the next 36 months? Second, which other GemStone Scores will be affected by that change. Please refer to FIG. 6 to see which GemStones support which other GemStones. For instance, as your production processes score falls, due to a low score, that may put strain on your TEAM simultaneously, an increase in your Sales Channel Relationships could boost the impact of your Sales/Marketing Processes, so you might project that score rising over the next 12 months. This indicator is designed to help Leadership create better informed goals, forecasts, and projections.

After forecasting what is likely to change based on already changing dynamics, it is now time to set goals. For each of the 16 GemStones, it is time to set a goal. What would you like to set as a goal for the score of each Gemstone in 36 months? For those GemStones forecast to trend downward on their own, you might set a goal of maintaining their score. For those GemStones forecast to remain where they are, you may set goals for driving those scores higher. Keep in mind, some GemStones may not be particularly important to your strategy. (ie, A fast growing tech company may be able to meet all their goals with a very low Real Estate and/or Equipment score.) This is an opportunity to deprioritize some GemStones as well. If a GemStone is now projected to be less important to growing the company’s profit margin and/or revenue, then time, money, and other fungible resources may be pulled away from that lesser important GemStone, allowing more time and/or money being made available to support those GemStones the VisionCraft has indicated more important to driving the organizations competitive edge, for the benefit of higher future profit margins and/or gross revenues.

In either embodiment of the invention, the data mapping of FIG. 6 may be used to automate the evaluation process and generate automated depictions of the executive focusing of the invention. In addition, the data model of FIG. 6 may be used to coordinate both newly acquired enterprise information and historical enterprise information in a machine learning environment. This allows for using current data in conjunction with historical data to project possible results, including the use of Monte Carlo simulations to provide guidance and risk analysis for executive decisions.

FIG. 6 illustrates the inter-relationship of the various items of data encompassing the VisionCraft analysis. Vision Leadership 101 has connections to and from various data connections, as do Production Process 102, Sales & Marketing 103, Innovation Process 104, and Customer Service 106 in the Process Gemstones. Similarly, Community Impact 201, Suppliers 202, Team 203, Sales Channel 204, and Access to Captial 205 represent the Relationships GemStones. Regulations 301 and Core Values 401 represent the miscellaneous GemStones, while the Property Gemstones of Real Estate 501, Brand Equity 502, Equipment 503, and Intellectual Property 504 complete the depiction of data sources. Inter-relations of the various data sources are represented by arrows having either a square or circle representing how the data source being pointed from impacts the data source being pointed to. The square arrow relationship indicates it's controlled by humans - it could be more or less based on how the system is set up and executed. whereas the circle arrow relationship indicates that it's a positive influence, more of A means more of B. In some embodiments, the various data sources are coupled with independent data validation sources, which may be various third parties that either accumulate industry data and/or specific data about the companies themselves and their competitors. One advantage of the embodiments of the present invention is that the executive focus may be both modified by domain experts and their analysis and independent data sources with no bias or other motivation. Similar to medical procedures such as scanning electrical measurement, wherein physicians use objective data points to evaluate and make individual diagnoses, embodiments of the invention provide systems and methods for integrating business process expertise to objective data sources to evaluate and provide appropriate areas of businesses for executive focus, in effect diagnosing problems or potential problems of businesses and providing decision assistance for improving the health and wellbeing of the business. Additional other data sources may be used as inputs in further embodiments of this invention. For instance, employee surveys, reviews, turnover rates, Customer surveys, traffic patterns, purchase habits, etc. may be used to update evaluation criteria and thus update the executive focus.

Portions of this disclosure and embodiments of the invention disclosed herein may also be covered by copyright law, and copying of those components in the context of reproducing the disclosure of the patent document and understanding such disclosure is permitted by the copyright owner, no other uses of such copyright protected material is granted unless specifically authorized hereunder.

While one or more embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A computer for providing executive decision support, said computer comprising:
a processor and memory, the memory including a database of company information relating to company resources;
a display;
and software for generating a plurality of markers, presenting the markers on the display in a first marker arrangement representing the company resources in a hierarchy, and presenting the markers on the display in a second marker arrangement different from the first marker arrangement representing the company resources based on a change to the hierarchy.

2. A method of using a computer to provide executive decision support with an executive focus roadmap display, said method comprising the steps of:
identifying the components of each category of resource and listed/commented upon by one or more individuals in the company;
rating each resource for its competitive importance;
displaying the resources with ratings and comments on a plurality of markers, the markers arranged in a hierarchy to provide a graphical display of markers to facilitate executive focus on key resources.

3. The method of claim 2, wherein the plurality of individual review and revise each marker to more closely reflect the consensus view, occasionally altering the hierarchy.

4. A method of evaluating a company resource comprising:
determining the resource’s ability to generate value for the Company;
determining the scarcity of the resource; and
determining the Company’s ability to repeatedly use the resource.

5. The method of claim 4 further including using a plurality of items representing each resource, and a plurality of numerical values associated with each of the determining steps is provided on each item.

6. The method of claim 5 wherein rules are used to arrange the items according to the numerical values.
